(19) United States
(12) Patent Application Publication
(10) Pub. No.: US 2024/0228770 A1
(43) Pub. Date: Jul. 11, 2024

(54) RESIN PARTICLES, METHOD FOR PRODUCING RESIN PARTICLES, TONER, DEVELOPER, TONER STORAGE, AND IMAGE FORMING APPARATUS

(71) Applicants: Akinori Saitoh, Shizuoka (JP); Junichi Watanabe, Shizuoka (JP); Yuka Mizoguchi, Shizuoka (JP); Masahiro Yukikawa, Kanagawa (JP)

(72) Inventors: Akinori Saitoh, Shizuoka (JP); Junichi Watanabe, Shizuoka (JP); Yuka Mizoguchi, Shizuoka (JP); Masahiro Yukikawa, Kanagawa (JP)

(73) Assignee: Ricoh Company, Ltd., Tokyo (JP)

(21) Appl. No.: 18/402,929

(22) Filed: Jan. 3, 2024

(30) Foreign Application Priority Data
Jan. 11, 2023 (JP) 2023-002436

(51) Int. Cl. C08L 67/02; C08G 63/672; G03G 9/087

(52) U.S. Cl. CPC C08L 67/025; C08G 63/672; G03G 9/08755; C08L 2205/025; C08L 2205/03; C08L 2207/53; G03G 2215/0604

(57) ABSTRACT

Resin particles, each include amorphous polyester resins, a crystalline polyester resin, and a release agent. The amorphous polyester resins include (i) an amorphous polyester resin including a sulfonic acid salt group-containing polyester resin and (ii) an amorphous polyester resin different from the amorphous polyester resin including the sulfonic acid salt group-containing polyester resin. The sulfonic acid salt group-containing polyester resin has a solubility parameter of from 10 to 13. Each of the resin particles has a core-shell structure including a core layer and a shell layer. The shell layer includes the (i) amorphous polyester resin including the sulfonic acid salt group-containing polyester resin.

### CROSS-REFERENCE TO RELATED APPLICATION

The present application claims priority under 35 U.S.C. § 119 to Japanese Patent Application No. 2023-002436, filed Jan. 11, 2023, the contents of which are incorporated herein by reference in their entirety.

### BACKGROUND OF THE INVENTION

### 1. Field of the Invention

The disclosures herein generally relate to resin particles, a method for producing resin particles, a toner, a developer, a toner storage, and an image forming apparatus.

### 2. Description of the Related Art

Currently, there is a growing demand for toners having small particle diameters to achieve high quality image outputs, low-temperature fixability to achieve energy saving, and heat-resistant storage stability to endure high temperatures and high humidity during storage or transportation after production. Among the above-mentioned characteristics, improvement in low-temperature fixability is particularly important because the energy consumption during fixing occupies the majority of the energy consumption for an image forming process.

Toners produced by a kneading and pulverization method have been used. However, the toners produced by the kneading and pulverization method have the following problems. It is difficult to produce toner particles having small diameters, and the produced toner particles generally have irregular particle shapes and a broad particle size distribution. Therefore, desired quality of output images cannot be achieved, and a large amount of energy is used for fixing. In a case where wax (a release agent) is added to produce a toner by the kneading and pulverization method, moreover, a large amount of the wax tends to be present at a surface of each toner particle, as the bulks of the kneaded product are cracked at an interface with the wax during pulverization. While a release effect is exhibited owing to the wax, the wax present at the surfaces of the toner particles also tends to cause toner deposition (filming) on a carrier, a photoconductor, and a blade. Therefore, the toner produced by the melt-kneading method does not achieve satisfactory characteristics as a whole.

In order to overcome the above-described problems associated with the kneading and pulverization method, a production method for a toner using a polymerization method has been proposed. According to the polymerization method, toner particles having small diameters are easily produced. The toner particles produced by the polymerization method have the narrower particle size distribution compared to a toner produced by a pulverization method. Moreover, a release agent can be encapsulated in each toner particle. As a production method for a toner using a polymerization method, the following methods have been proposed. Proposed is a method where an elongation reaction product of a urethane-modified polyester is used as a toner binder to produce a toner for improving low-temperature fixability and hot offset resistance (see, for example, Japanese Unexamined Patent Application Publication No. 11-133665). Moreover, proposed is a method for producing a toner having excellent heat-resistant storage stability, low-temperature fixability, and hot offset resistance, as well as excellent flowability and transferring properties of particles of the toner when the particles of the toner have small dimeters (see, for example, Japanese Unexamined Patent Application Publication Nos. 2002-287400 and 2002-351143). Furthermore, proposed is a production method for a toner, where a toner binder having a desired molecular weight distribution is produced, and a maturing process is provided to achieve both low-temperature fixability and hot offset resistance (see, for example, Japanese Patent No. 2579150 and Japanese Unexamined Patent Application Publication No. 2001-158819). However, the proposed methods did not satisfactorily achieve a high level of low-temperature fixability desired in recent years.

To achieve a high level of low-temperature fixability, therefore, the following toners have been proposed. The proposed toner includes a resin and a release agent, where the resin includes a crystalline polyester resin, so that the resin and the wax are incompatible to each other to form a phase separation structure including a major phase and minor phases dispersed in the major phase (see, for example, Japanese Unexamined Patent Application Publication No. 2004-46095). Moreover, a toner including a crystalline polyester resin, a release agent, and a graft polymer has been proposed (see, for example, Japanese Unexamined Patent Application Publication No. 2007-271789).

The proposed toners can achieve low-temperature fixing because the crystalline polyester resin rapidly melts in comparison with the amorphous polyester resin. However, even if the crystalline polyester resin constituting the minor phases of the phase separation structure is melted, the amorphous polyester resin constituting the major phase is not melted. Since the toner is not fixed unless both the crystalline polyester resin and the amorphous polyester resin are melted to a certain degree, the proposed toners do not achieve the high level of low-temperature fixability desired in recent years.

In addition, toners having excellent low-temperature fixability have various problems. One of the problems is the trade-off nature of low-temperature fixability with heat-resistant storage stability. When further improvement in low-temperature fixability is desired, it is also desired to provide a method for achieving heat-resistant storage stability, which is a contradicting characteristic to the low-temperature fixability. A method for covering surfaces of toner base particles with a resin to secure heat resistance has been proposed, but problems still remain, such as trade off with low-temperature fixability and reduction in charging characteristics (see for example, Japanese Patent Nos. 6024276 and 4873734).

The second problem is to achieve desired charging characteristics. The above-described toners do not fundamentally improve softness owing to crystalline segments so that problems associated with mechanical durability of the toners cannot be solved. Therefore, a capability of retaining triboelectric charge is low due to the softness of the toner, which may cause toner scattering or background deposition.

To improve charging characteristics, proposed are (1) adding a fluorosurfactant having a polarity opposite to a polarity of a surfactant used in pulverization, after emulsification dispersion, desolventization, washing, and re-dispersion to water (see, for example, Japanese Patent No. 3793920), (2) adding a layered inorganic mineral modified with organic ions to achieve desired fixability, cleaning ability, and charging characteristics (see, for example, Japanese Patent No. 5008129), and (3) using a sulfonic acid group-containing surfactant to assure stability during production of a toner, and using a carboxyl group-containing surfactant to inhibit penetration of the sulfonic acid group-containing surfactant into aggregated particles in a dispersion liquid mixture during the production to assure desired charging characteristics of the aggregated particles (see, for example, Japanese Unexamined Patent Application Publication No. 2008-076519). However, any of the proposed methods does not provide a toner that achieves all of excellent low-temperature fixability, excellent charging characteristics, and excellent heat-resistant storage stability.

Accordingly, there is currently a demand for resin particles that excel in all of low-temperature fixability, adhesion, charging characteristics, and heat-resistant storage stability.

### SUMMARY OF THE INVENTION

In one embodiment, resin particles each include amorphous polyester resins, a crystalline polyester resin, and a release agent. The amorphous polyester resins include (i) an amorphous polyester resin including a sulfonic acid salt group-containing polyester resin and (ii) an amorphous polyester resin different from the amorphous polyester resin including the sulfonic acid salt group-containing polyester resin. The sulfonic acid salt group-containing polyester resin has a solubility parameter of from 10 to 13. Each of the resin particles has a core-shell structure including a core layer and a shell layer. The shell layer includes the (i) amorphous polyester resin including the sulfonic acid salt group-containing polyester resin.

### BRIEF DESCRIPTION OF THE DRAWINGS

FIG. 1 is a schematic view illustrating an example of the image forming apparatus of the present disclosure;

FIG. 2 is a schematic view illustrating another example of the image forming apparatus of the present disclosure;

FIG. 3 is a schematic view illustrating yet another example of the image forming apparatus of the present disclosure;

FIG. 4 is an enlarged partial view of FIG. 3; and

FIG. 5 is a schematic view illustrating an example of a process cartridge serving as the toner storage of the present disclosure.

### DESCRIPTION OF THE PREFERRED EMBODIMENTS

In the following, embodiments of the present invention will be described with reference to the accompanying drawings.

Further, the present invention is not limited to these embodiments, but various variations and modifications may be made without departing from the scope of the present invention.

Specifically, the present disclosure is not limited to the embodiments described hereinafter. These embodiments may be modified by replacing with another embodiment, adding, altering, or omitting within the spirit of the present disclosure, which are included within the scope of the present disclosure, provided that functions and effects of the present disclosure are exhibited.

An object of the present disclosure is to provide resin particles that excel in all of low-temperature fixability, adhesion, charging characteristics, and heat-resistant storage stability.

According to the present disclosure, resin particles that excel in all of low-temperature fixability, adhesion, charging characteristics, and heat-resistant storage stability can be provided.

### (Resin Particles)

The resin particles of the present disclosure are resin particles each including amorphous polyester resins, a crystalline polyester resin, and a release agent. The amorphous polyester resins include an amorphous polyester resin that includes a polyester resin including a sulfonic acid salt group (may be referred to as a “sulfonic acid salt group-containing polyester resin” hereinafter) and another amorphous polyester resin that is different from the amorphous polyester resin including the sulfonic acid salt group-containing polyester resin. Each of the resin particles has a core-shell structure including a core layer and a shell layer. The shell layer includes the amorphous polyester resin including the sulfonic acid salt group-containing polyester resin. The sulfonic acid salt group-containing polyester resin has a solubility parameter (SP) of from 10 to 13.

The resin particles of the present disclosure excel in all of low-temperature fixability, adhesion, charging characteristics, and heat-resistant storage stability, and are suitably used for a toner. Accordingly, “toner resin particles” that are resin particles used for a toner are included within the scope of the resin particles of the present disclosure.

In addition to the amorphous polyester resins, the crystalline polyester resin, and the release agent, the resin particles may further include other components, as necessary.

### [Core-Shell Structure]

Each of the resin particles has a core-shell structure. Since each of the resin particles has a core-shell structure, desirable heat-resistant storage stability is achieved. Since the shell layer includes at least the sulfonic acid salt group-containing polyester resin, highly desirable charging characteristics can be obtained owing to a sulfonic acid salt group that has an effect of imparting a negative charge. Moreover, the core layer preferably includes the (ii) amorphous polyester resin different from the amorphous polyester resin including the sulfonic acid salt group-containing polyester resin, the crystalline polyester resin, and the release agent.

In the present specification, the term “a core-shell structure” encompasses a structure including a core layer and a shell layer, where the “shell layer” is a layer formed on a region of the outermost layer of each resin particle, and the “core layer” is a region within the resin particle excluding the shell layer.

The core layer and the shell layer are not completely compatible to each other and are not homogeneously distributed.

As a preferred embodiment of the core-shell structure, the core-shell structure has a structure where a surface of the core layer is covered with the shell layer.

In the core-shell structure, the surface of the core layer may be completely covered with the shell layer, or may not be completely covered with the shell layer. Examples of the embodiment where the surface of the core layer is not completely covered with the shell layer include: an embodiment where a core layer is covered with a net-like shell layer; and an embodiment where a core layer is partially exposed from a shell layer. Among the above-listed examples, the surface of the core layer is preferably completely covered with the shell layer in view of low-temperature fixability, adhesion, and heat-resistant storage stability.

A shell resin constituting the shell layer includes at least the amorphous polyester resin including the sulfonic acid salt group-containing polyester resin, and may further include other resins, as necessary.

A method for confirming the presence of the sulfonic acid salt group-containing polyester resin in the shell layer is not particularly limited, and may be appropriately selected according to the intended purpose. Examples of the method include a method where a composition analysis of a surface layer (a shell layer) of each particle is performed by nanoIR (my be also referred to as “AMF-IR”) to conform the presence of the sulfonic acid salt group-containing polyester resin.

An IR spectrum of the surface layer (the shell layer) of each of the resin particles is obtained according to an analysis method using a combination of an atomic force microscope (AFM) of nanoIR and IR to achieve nanoscale resolution. A composition structure of the surface layer can be determined from the obtained IR spectrum.

Specifically, the composition analysis may be performed in the following manner. The resin particles are embedded in an epoxy resin (S-31, available from DEVCON), and the epoxy resin is cured. The cured epoxy resin is cut with a knife to expose cross-sections of the resin particles, and the resulting epoxy resin is sliced into a thickness of 60 nm by an ultrasonic ultramicrotome (Leica EM UC7, available from Leica Microsystems) to prepare an ultra-thin cut piece of the resin particles. The prepared ultra-thin cut piece of the resin particles is collected on a substrate (ZnS), and a measuring point (the shell layer) is measured by a nanoscale infrared spectrometer (e.g., nanoIR2, available from Anasys Instruments Corp.) according to AFM-IR. A measuring range is set in the range of 1,900 cm⁻¹ to 910 cm⁻¹, and resolution is set at 2 cm⁻¹. From the obtained AFM-IR absorption spectrum, a chemical structure of the measuring point (the shell layer) is determined. As a result of the above-described analysis, the presence of the sulfonic acid salt group-containing polyester resin in the surface layer (the shell layer) can be detected.

Moreover, a chemical structure of the core layer may be also determined by setting the core layer as the measuring point.

An average thickness of the shell layer is not particularly limited, and may be appropriately selected according to the intended purpose. The average thickness is preferably from 50 nm to 500 nm, more preferably from 100 nm to 200 nm. When the average thickness of the shell layer is 50 nm or greater, the core layer inside each of the resin particles is sufficiently protected, improving mechanical strength of resulting resin particles. When the average thickness of the shell layer is 500 nm or less, adequate mechanical strength is obtained without impairing low-temperature fixability.

In the present specification, the “average thickness of the shell layer” is an average thickness of the shell layer determined in the following manner. Among the resin particles having diameters within a range of a weight average particle diameter of the resin particles ±2.0 μm, 50 resin particles are randomly selected. A thickness of a shell layer of each of the selected 50 resin particles is measured in the manner described later. The arithmetic mean of the thickness values measured from the 50 resin particles is determined as the average thickness of the shell layer.

A coverage rate of the surface of the core layer with the shell layer is not particularly limited, and may be appropriately selected according to the intended purpose. The coverage rate is preferably from 50% to 100%, more preferably from 80% to 100%. The coverage rate being 100% means that the entire surface of the core layer of each of the resin particles is covered with the shell layer.

The coverage rate (%) of the surface of the core layer with the shell layer may be calculated according to Equation (1) below.

$$Coverage rate ( \% ) = ( area of covered region ) \text{} / ( entire surface area of resin particle ) \times 100 \qquad Equation ( 1 )$$

In Equation (1), the “entire surface area of resin particle” means a sum of the area of the covered region and an area of a region where the core layer is exposed; the “area of covered region” means an area of a region or regions of the core layer covered with the shell layer; the “area of a region where the core layer is exposed” is an area of a region or regions where the core layer is not covered with the shell layer.

A method for confirming the presence of the core-shell structure of the resin particles is not particularly limited, and may be appropriately selected according to the intended purpose. For example, the core-shell structure of the resin particles may be confirmed in the following manner. The resin particles are embedded in an epoxy resin (S-31, available from DEVCON), and the epoxy resin is cured. The cured epoxy resin is cut with a knife to expose cross-sections of the resin particles, and the resulting epoxy resin is sliced into a thickness of 60 nm by an ultrasonic ultramicrotome (Leica EM UC7, available from Leica Microsystems) to prepare an ultra-thin cut piece of the resin particles. The prepared ultra-thin cut piece of the resin particles is exposed to a ruthenium tetroxide (RuO₄) gas to dye the resin particles to identify shell layers and core layers. The gas exposure time may be appropriately adjusted according to a desired contrast for observation. Then, the cross-sectional image of the resin particles is observed under a transmission electron microscope (H-7500, available from Hitachi High-Tech Corporation) at acceleration voltage of 120 kV to confirm the presence of the core-shell structure.

On the TEM image observed in the above-described method, the covered region of the core layer at a surface of each of the resin particles (a region of the core layer covered with the shell layer within the resin particle), and the exposed region of the core layer (a region of the core layer without being covered with the shell layer within the resin particle) may be distinguished according to a difference in brightness. Therefore, the TEM image observed in the above-described method is binarized using image processing software, and a shell layer is identified with a contrast in the binarized image to measure a thickness of the shell layer.

As the image processing software, Image-J may be used. A calculation method of an average thickness of the shell layer using Image-J is as described below.
(1) A scale is traced using a “Straight Line” function to draw a straight line. An actual length and unit of the straight line are set using a “Set Scale” function on an “Analyze” window.
(2) A periphery of one resin particle is traced with the “Freehand-sections” function on a cross-sectional image of the one resin particle to set “Region 1.”
(3) A periphery of a region of the cross-sectional image of the one resin particle excluding the shell layer (a boundary between the shell layer and the core layer) is traced with the “Freehand-sections” function to set “Region 2.”
(4) A center of gravity of the “Region 1” is determined with an “Analyze” function.
(5) Using the originally developed plug-in, straight lines are drawn from coordinates towards the center of gravity of the resin particle determined in (4). The coordinates are created by evenly dividing the line tracing the periphery of the “Region 1”, i.e., the periphery of the resin particle in (2), into 100.
(6) On each of the 100 straight lines drawn in (5), a length obtained by subtracting the length of the straight line passing through “Region 2” from the length of the straight line passing through “Region 1” is calculated using the straight line created by tracing the scale in (1). An average length of the calculated lengths from the 100 straight lines is determined as a thickness of the shell layer of the resin particle.
(7) The processes of (2) to (6) are carried out on 50 resin particles, and an arithmetic mean of the thicknesses of the shell layers of the 50 resin particles is calculated. The calculated mean is determined as an average thickness of the shell layer in the resin particles of the present disclosure. Moreover, a method for calculating the coverage rate with the shell layer using Image-J is as follows.
(1) A section of a periphery of one resin particle covered with a shell layer on a cross-sectional image of the one resin particle is traced with a “Freehand Line” function, and a length of the traced line is measured by an “Analyze” function. The measured length is determined as “Length 1.”
(2) The periphery of the resin particle on the cross-sectional image of the resin particle is traced with the “Freehand Line” function, and a length of the traced line is measured by the “Analyze” function. The measured length is determined as “Length 2.”
(3) A value of Length 1/Length 2×100 is calculated. The calculated value is determined as a coverage rate of the resin particle with the shell layer.
(4) The processes of (1) to (3) are carried out on 50 resin particles, and an arithmetic mean of the coverage rates of the 50 resin particles with the shell layers. The arithmetic mean is determined as a coverage rate with the shell layer in the resin particles of the present disclosure.

### <Amorphous Polyester Resins>

The resin particles each include the amorphous polyester resins. The amorphous polyester resins include (i) an amorphous polyester resin including a sulfonic acid salt group-containing polyester resin and (ii) another amorphous polyester resin that is different from the amorphous polyester resin including the sulfonic acid salt group-containing polyester resin. The term “amorphous polyester resin including the sulfonic acid salt group-containing polyester resin” encompasses an amorphous polyester resin that includes a sulfonic acid salt group-containing polyester resin alone or in combination with one or more polyester resins. The resin particles may further include other amorphous polyester resins, as necessary.

### «Sulfonic Acid Salt Group-Containing Polyester Resin»

The sulfonic acid salt group-containing polyester resin is synthesized by polycondensation between a monomer including a sulfonic acid salt group (may be referred to as a “sulfonic acid salt group-containing monomer”), an alcohol, and a carboxylic acid.

The sulfonic acid salt group-containing monomer, alcohol, and carboxylic acid used for synthesis of the sulfonic acid salt group-containing polyester resin are not particularly limited, and may be appropriately selected depending on the intended purpose. The above-mentioned constituent components are as follows.

### —Sulfonic Acid Salt Group-Containing Monomer—

A sulfonic acid salt group-containing monomer is used for synthesis of the sulfonic acid salt group-containing polyester resin. The sulfonic acid salt group-containing monomer is not particularly limited, and may be appropriately selected depending on the intended purpose. Examples of the sulfonic acid salt group-containing monomer include aromatic sulfonic acid salt group-containing monomers and aliphatic sulfonic acid salt group-containing monomers. The above-listed examples may be used alone or in combination. Among the above-listed examples, the sulfonic acid salt group-containing monomer is preferably an aromatic sulfonic acid salt group-containing monomer including a divalent or higher carboxylic acid as a constitutional unit.

Examples of the aromatic sulfonic acid salt group-containing monomer including a dicarboxylic acid as a constitutional unit include 5-sulfoisophthalic acid, 2-sulfoisophthalic acid, 4-sulfoisophthalic acid, 4-sulfo-2, 6-napthalenedicarboxylic acid, and sulfonic acid salts of ester forming derivatives [e.g., lower (C1-C4) alkyl esters (methyl esters, ethyl esters, etc.), and acid anhydrides] of the foregoing monomers.

Examples of the aliphatic sulfonic acid salt group-containing monomer including a dicarboxylic acid as a constitutional unit include sulfosuccinic acid and sulfonic acid salts of ester forming derivatives [e.g., lower (C1-C4) alkyl esters (methyl esters, ethyl esters, etc.), and acid anhydrides] of the foregoing monomer.

Examples of the sulfonic acid salts include alkali metal salts, alkaline earth metal salts, ammonium salts, amine salts of C2-C4 hydroxyalkyl group-containing mono-, di-, or triamines, quaternary ammonium salts of the foregoing amines, and a mixture of the foregoing salts.

Examples of the alkali metal salts include lithium salts, sodium salts, and potassium salts. Examples of the alkaline earth metal salts include magnesium salts and calcium salts.

Examples of the C2-C4 hydroxyalkyl group-containing mono-, di-, or triamine include organic amine salts, such as monoethylamine, diethylamine, triethylamine, monoethanolamine, diethanolamine, triethanolamine, and diethylethanolamine.

The above-listed sulfonic acid salts may be used alone or in combination. Among the above-listed examples, the sulfonic acid salt is preferably a 5-sulfoisophthalic acid salt, and particularly preferably a 5-sulfoisophthalic acid sodium salt or a 5-sulfoisophthalic acid potassium salt.

### —Alcohol—

The alcohol used as a constituent component of the sulfonic acid salt group-containing polyester resin is not particularly limited, and may be appropriately selected depending on the intended purpose. Examples of the alcohol include diols, trivalent or higher alcohols, and mixtures of a diol and a trivalent or higher alcohol. The above-listed examples may be used alone or in combination.

The diols are not particularly limited, and may be appropriately selected depending on the intended purpose. Examples of the diols include aliphatic diols, oxyalkylene group-containing diols, alicyclic diols, alkylene oxide adducts of alicyclic diols, bisphenols, and alkylene oxide adducts of bisphenols. The above-listed examples may be used alone or in combination.

Examples of the aliphatic diols include ethylene glycol, 1,2-propyleneglycol, 1, 3-propyleneglycol, 1, 4-butanediol, 3-methyl-1, 5-pentanediol, 1, 6-hexanediol, 1,8-octanediol, 1,10-decanediol, and 1, 12-dodecanediol.

Examples of the oxyalkylene group-containing diols include diethylene glycol, triethylene glycol, dipropylene glycol, polyethylene glycol, polypropylene glycol, and polytetramethylene glycol.

Examples of the alicyclic diols include 1, 4-cyclohexanedimethanol and hydrogenated bisphenol A.

Examples of the alkylene oxide adducts of the alicyclic diols include the alicyclic diols to each of which an alkylene oxide (e.g., ethylene oxide, propylene oxide, and butylene oxide) is added.

Examples of the bisphenols include bisphenol A, bisphenol F, and bisphenol S.

Examples of the alkylene oxide adducts of the bisphenols include the bisphenols to each of which an alkylene oxide (e.g., ethylene oxide, propylene oxide, and butylene oxide) is added.

Among the above-listed examples, the diol is preferably C4-C12 aliphatic diol.

The trivalent or higher alcohols are not particularly limited, and may be appropriately selected depending on the intended purpose. Examples of the trivalent or higher alcohols include trivalent or higher aliphatic alcohols.

Examples of the trivalent or higher aliphatic alcohols include glycerin, trimethylol ethane, trimethylolpropane (TMP), pentaerythritol, sorbitol, and dipentaerythritol. The above-listed examples may be used alone or in combination.

### —Carboxylic Acid—

The carboxylic acid used as a constituent component of the sulfonic acid salt group-containing polyester resin is not particularly limited, and may be appropriately selected depending on the intended purpose. Examples of the carboxylic acid include dicarboxylic acids, trivalent or higher carboxylic acids, and mixtures of a dicarboxylic acid and a trivalent or higher carboxylic acid. The above-listed examples may be used alone or in combination.

The dicarboxylic acids are not particularly limited, and may be appropriately selected depending on the intended purpose. Examples of the dicarboxylic acids include aliphatic dicarboxylic acids, aromatic dicarboxylic acids, anhydrides of the foregoing dicarboxylic acids, lower (C1-C3) alkyl esters of the foregoing dicarboxylic acids, and halogenated products of the foregoing dicarboxylic acids. The above-listed examples may be used alone or in combination.

The aliphatic dicarboxylic acids are not particularly limited, and may be appropriately selected depending on the intended purpose. Examples of the aliphatic dicarboxylic acids include succinic acid, adipic acid, sebacic acid, dodecanedioic acid, maleic acid, and fumaric acid.

The aromatic dicarboxylic acids are not particularly limited, and may be appropriately selected depending on the intended purpose. Examples of the aromatic dicarboxylic acids include phthalic acids, isophthalic acids, terephthalic acids, and naphthalene dicarboxylic acid.

The trivalent or higher carboxylic acids are not particularly limited, and may be appropriately selected depending on the intended purpose. Examples of the trivalent or higher carboxylic acids include trimellitic acid (TMA), pyromellitic acid, and anhydrides of any of the trivalent or higher carboxylic acids. The above-listed examples may be used alone or in combination.

Among the above-listed examples, the carboxylic acid used as a constituent component of the sulfonic acid salt group-containing polyester resin is preferably a C4-C12 aliphatic dicarboxylic acid.

When the sulfonic acid salt group-containing polyester resin is synthesized, a catalyst is preferably added. The catalyst is not particularly limited, and may be appropriately selected depending on the intended purpose. Examples of the catalyst include tetrabutyl orthotitanate, titanium bis (triethanolaminate) diisopropoxide, and dibutyl tin oxide. The above-listed examples may be used alone or in combination.

### [Solubility Parameter (SP)]

The solubility parameter (SP) of the sulfonic acid salt group-containing polyester resin included in the shell layer is in the range of 10 to 13. When the SP of the sulfonic acid salt group-containing polyester resin is from 10 to 13, a shell layer can be desirably formed on each core particle constituting the core layer. When the SP of the sulfonic acid salt group-containing polyester resin is less than 10, the sulfonic acid salt group-containing polyester resin has high hydrophobicity so that formation of shell layers on core particles is not easily carried out. When the SP of the sulfonic acid salt group-containing polyester resin is greater than 13, conversely, hydrophilicity of the sulfonic acid salt group-containing polyester resin is very high so that heteroaggregation of particles of the sulfonic acid salt group-containing polyester resin onto the core particles do not occur during formation of shell layers. As a result, the particles of the shell resin are likely to aggregate through homoaggregation to cause defective formation of shell layers.

The SP of the sulfonic acid salt group-containing polyester resin is calculated from amounts of monomers used for the production of the sulfonic acid salt group-containing polyester resin according to the Fedors' method.

### [Molar Ratio of Sulfonic Acid Salt Group-Containing Monomer Unit]

A molar ratio of the sulfonic acid salt group-containing monomer unit in the sulfonic acid salt group-containing polyester resin is not particularly limited, and may be appropriately selected depending on the intended purpose. The molar ratio of the sulfonic acid salt group-containing monomer unit is preferably from 2 mol % to 10 mol %, more preferably from 4 mol % to 8 mol %, relative to a total amount of the carboxylic acid monomers used to synthesize the sulfonic acid salt group-containing polyester resin. When the molar ratio of the sulfonic acid salt group-containing monomer unit in the sulfonic acid salt group-containing polyester resin is 2 mol % or greater, desired negative charge owing to the sulfonic acid salt group is obtained. When the molar ratio of the sulfonic acid salt group-containing monomer unit in the sulfonic acid salt group-containing polyester resin is 10 mol % or less, the hygroscopic nature of the sulfonic acid salt group is not strongly exhibited, desired charging characteristics are achieved, and desired heat-resistant storage stability is achieved.

The molar ratio of the sulfonic acid salt group-containing monomer unit in the sulfonic acid salt group-containing polyester resin can be calculated by inserting an area derived from the sulfonic acid salt group-containing monomer in the chromatogram obtained by pyrolysis gas chromatography (py-GC) into a calibration curve equation of the sulfonic acid salt group-containing monomer.

### [Acid Value]

An acid value of the sulfonic acid salt group-containing polyester resin is not particularly limited, and may be appropriately selected depending on the intended purpose. The acid value is preferably from 1 mgKOH/g to 50 mgKOH/g, more preferably from 5 mgKOH/g to 30 mgKOH/g. When the acid value of the sulfonic acid salt group-containing polyester resin is 1 mgKOH/g or greater, a toner including the resin particles is likely to have a negative charge so that affinity between a recording medium, such as paper, and the toner, is improved, when the toner is fixed onto the recording medium, improving low-temperature fixability. When the acid value of the sulfonic acid salt group-containing polyester resin is 50 mgKOH/g or less, desired charging stability, especially charging stability against fluctuations in the environmental conditions, can be achieved.

The acid value of the sulfonic acid salt group-containing polyester resin can be measured according to the measuring method specified in JIS K0070-1992.

An amount of the sulfonic acid salt group-containing polyester resin in the resin particles is not particularly limited, and may be appropriately selected depending on the intended purpose. The amount of the sulfonic acid salt group-containing polyester resin is preferably from 5% by mass to 40% by mass, more preferably from 10% by mass to 40% by mass, relative to a total mass of the resin particles. When the amount of the sulfonic acid salt group-containing polyester resin is 5% by mass or greater, desired charging characteristics and heat-resistant storage stability are achieved. When the amount of the sulfonic acid salt group-containing polyester resin is 40% by mass or less, desired low-temperature fixability is achieved.

The presence of the sulfonic acid salt group-containing polyester resin in each of the resin particles can be confirmed, for example, by a method where sulfur (S) intensity is measured by trace element analysis according to X-ray fluorescence analysis; a method where a sulfonic acid salt group-containing monomer is quantified by gas chromatography mass spectrometry (GC/MS); or a method where a sulfonic acid salt group at the outermost surface of the resin particle is determined by time-of-flight secondary ion mass spectrometry (TOF-SIMS) to determine the resin structure of the outermost surface of the resin particle.

«Another amorphous polyester resin (Amorphous polyester resin A)»

In the present disclosure, the term “another amorphous polyester resin,” “amorphous polyester resin different from the amorphous polyester resin including a sulfonic acid salt group-containing polyester resin,” or “amorphous polyester resin A” encompasses an amorphous polyester resin that does not include a sulfonic acid salt group.

When the resin particles are used as a toner for developing electrostatic latent images, use of a resin having a polyester skeleton can achieve excellent fixability.

Examples of the resin having a polyester skeleton include polyester resins, and block polymers between a polyester and a resin having another skeleton. Use of the polyester resin is preferred as highly homogeneous resin particles are obtained.

The amorphous polyester resin A is not particularly limited, and may be appropriately selected depending on the intended purpose. Examples of the amorphous polyester resin A include ring-opening polymerization products of lactones, condensation polymers of hydroxycarboxylic acids, and polycondensation products between a polyol and a polycarboxylic acid. The above-listed examples may be used alone or in combination. Among the above-listed examples, the amorphous polyester resin A is preferably a polycondensation product between a polyol and a polycarboxylic acid in view of easiness in material designing.

### —Polyol—

The polyol (1) is not particularly limited, and may be appropriately selected depending on the intended purpose. Examples of the polyol (1) include diols (1-1), trivalent or higher polyols (1-2), and mixtures of a diol (1-1) and a small amount of a trivalent or higher polyol (1-2). The above-listed examples may be used alone or in combination.

The diols (1-1) are not particularly limited, and may be appropriately selected depending on the intended purpose. Examples of the diols (1-1) include aliphatic diols, alicyclic diols, alkylene oxide adducts of alicyclic diols, bisphenols, alkylene oxide adducts of bisphenols, 4,4′-dihydroxybiphenyls, bis (hydroxyphenyl) alkanes, and bis (4-hydroxyphenyl) ethers. The above-listed examples may be used alone or in combination.

Examples of the aliphatic diols include alkylene glycol (e.g., ethylene glycol, 1, 2-propylene glycol, 1, 3-propylene glycol, 1, 4-butanediol, and 1, 6-hexanediol), diethylene glycol, triethylene glycol, dipropylene glycol, polyethylene glycol, polypropylene glycol, and alkylene ether glycol (e.g., polytetramethylene ether glycol).

Examples of the alicyclic diols include 1, 4-cyclohexane dimethanol and hydrogenated bisphenol A.

Examples of the alkylene oxide adducts of the alicyclic diols include the alicyclic diols to each of which alkylene oxide (e.g., ethylene oxide, propylene oxide, and butylene oxide) is added.

Examples of the bisphenols include bisphenol A, bisphenol F, and bisphenol S.

Examples of the alkylene oxide adducts of the bisphenols include the bisphenols to each of which alkylene oxide (e.g., ethylene oxide, propylene oxide, and butylene oxide) is added.

Examples of the 4, 4′-dihydroxybiphenyls include 3, 3′-difluoro-4, 4′-dihydroxybiphenyl.

Examples of the bis (hydroxyphenyl) alkanes include bis (3-fluoro-4-hydroxyphenyl) methane, 1-phenyl-1, 1-bis (3-fluoro-4-hydroxyphenyl) ethane, 2, 2-bis (3-fluoro-4-hydroxyphenyl) propane, 2, 2-bis (3, 5-difluoro-4-hydroxyphenyl) propane (synonym: tetrafluorobisphenol A), and 2, 2-bis (3-hydroxyphenyl)-1, 1, 1, 3, 3, 3-hexafluoropropane.

Examples of the bis (4-hydroxyphenyl) ethers include bis (3-fluoro-4-hydroxyphenyl) ethers. The trivalent or higher polyols (1-2) are not particularly limited, and may be appropriately selected depending on the intended purpose. Examples of the trivalent or higher polyols (1-2) include trivalent or octavalent, or higher multivalent aliphatic alcohols, trivalent or higher phenols, and trivalent or higher polyphenol alkylene oxide adducts.

Examples of the multivalent aliphatic alcohols include glycerin, trimethylol ethane, trimethylol propane, pentaerythritol, and sorbitol.

Examples of the trivalent or higher phenols include trisphenol PA (4 (4 (1, 1-bis (p-hydroxyphenyl) ethyl)-α, α-dimethylbenzyl) phenol), phenol novolac, and cresol novolac.

Examples of the alkylene oxide adducts of the trivalent or higher polyphenols include the trivalent or higher polyphenols to each of which alkylene oxide (e.g., ethylene oxide, propylene oxide, and butylene oxide) is added.

Among the above-listed examples, the polyol (1) is preferably C2-C12 alkylene glycol or a bisphenol alkylene oxide adduct, more preferably a combination of C2-C12 alkylene glycol and a bisphenol alkylene oxide adduct.

### —Polycarboxylic Acid—

The polycarboxylic acid (2) is not particularly limited, and may be appropriately selected depending on the intended purpose. Examples of the polycarboxylic acid (2) include dicarboxylic acids (2-1), trivalent or higher polycarboxylic acids (2-2), and mixtures of a dicarboxylic acid (2-1) and a small amount of a trivalent or higher polycarboxylic acid (2-2). The above-listed examples may be used alone or in combination.

The dicarboxylic acids (2-1) are not particularly limited, and may be appropriately selected depending on the intended purpose. Examples of the dicarboxylic acids (2-1) include alkylene dicarboxylic acids (e.g., succinic acid, adipic acid, and sebacic acid), alkenylene dicarboxylic acids (e.g., maleic acid and fumaric acid), aromatic dicarboxylic acids (e.g., phthalic acid, isophthalic acid, terephthalic acid, and naphthalene dicarboxylic acid), 3-fluoroisophthalic acid, 2-fluoroisophthalic acid, 2-fluoroterephthalic acid, 2, 4, 5, 6-tetrafluoroisophthalic acid, 2, 3, 5, 6-tetrafluoroterephthalic acid, 5-(trifluoromethyl) isophthalic acid, 2, 2-bis (4-carboxyphenyl) hexafluoropropane, 2, 2-bis (3-carboxyphenyl) hexafluoropropane, 2, 2′-bis (trifluoromethyl)-4, 4′-biphenyl dicarboxylic acid, 3, 3′-bis (trifluoromethyl)-4, 4′-biphenyl dicarboxylic acid, 2,2′-bis (trifluoromethyl)-3, 3′-biphenyl dicarboxylic acid, and hexafluoroisopropylidene diphthalic anhydride. The above-listed examples may be used alone or in combination.

The trivalent or higher polycarboxylic acids (2-2) are not particularly limited, and may be appropriately selected depending on the intended purpose. Examples of the trivalent or higher polycarboxylic acids (2-2) include C9-C20 aromatic polycarboxylic acids (e.g., trimellitic acid and pyromellitic acid).

An acid anhydride or lower alkyl ester (e.g., methyl ester, ethyl ester, and isopropyl ester) of any of the foregoing the polycarboxylic acids (2) may be used as the polycarboxylic acid (2) to react with the polyol (1).

Among the above-listed examples, the polycarboxylic acid (2) is preferably a C4-C20 alkenylene dicarboxylic acid or a C8-C20 aromatic dicarboxylic acid.

A ratio between the polyol (1) and the polycarboxylic acid (2) is not particularly limited, and may be appropriately selected depending on the intended purpose. An equivalent ratio [OH]/[COOH] of a hydroxyl group [OH] to a carboxyl group [COOH] is preferably from 2/1 to ½, more preferably from 1.5/1 to 1/1.5, and yet more preferably from 1.3/1 to 1/1.3.

When the amorphous polyester resin A is synthesized, a catalyst is preferably added. The catalyst is not particularly limited, and may be appropriately selected depending on the intended purpose. Examples of the catalyst include tetrabutyl orthotitanate, titanium bis (triethanolaminate) diisopropoxide, and dibutyl tin oxide. The above-listed examples may be used alone or in combination.

### [Weight Average Molecular Weight (Mw)]

A weight average molecular weight (Mw) of the amorphous polyester resin A is not particularly limited, and may be appropriately selected depending on the intended purpose. The weight average molecular weight (Mw) as measured by gel permeation chromatography (GPC) is preferably from 3,000 to 30,000, more preferably from 4,000 to 25,000, and yet more preferably from 5,000 to 20, 000. When the weight average molecular weight (Mw) of the above-mentioned amorphous polyester resin A is 3,000 or greater, desired heat-resistant storage stability is achieved. When the weight average molecular weight (Mw) of the above-mentioned amorphous polyester resin A is 30,000 or less, desired low-temperature fixability is achieved.

### [Glass Transition Temperature (Tg)]

A glass transition temperature (Tg) of the amorphous polyester resin A is not particularly limited, and may be appropriately selected depending on the intended purpose. The glass transition temperature is preferably from 40° C. to 90° C., more preferably from 45° C. to 85° C., and yet more preferably from 50° C. to 80° C. When the glass transition temperature (Tg) of the above-mentioned amorphous polyester resin A is 40° C. or higher, obtained resin particles are not deformed or do not stick to each other when the resin particles are stored in a high temperature environment, such as during summer, so that resin particles can desirably function as particles. When the glass transition temperature (Tg) of the above-mentioned amorphous polyester resin A is 90° C. or lower, fixability of the resin particles is improved in the case where the resin particles are used as a toner for developing electrostatic latent images.

For example, the glass transition temperature (Tg) of the amorphous polyester resin A can be measured by a differential scanning calorimetry (DSC) system (Q-200, available from TA Instruments Japan Inc.).

Specifically, the glass transition temperature (Tg) of a sample (the amorphous polyester resin A) can be measured in the following manner.

First, approximately 5.0 mg of a sample is placed in a sample container formed of aluminum, the sample container is placed on a holder unit, and the holder unit is set in an electric furnace. Subsequently, the sample is heated from −80° C. to 150° C. in a nitrogen atmosphere at a heating rate of 10° C./min (first heating). Then, the sample is cooled from 150° C. to −80° C. at a cooling rate of 10° C./min, followed by heating up to 150° C. at a heating rate of 10° C./min (second heating). DSC curves of the first heating and the second heating are each measured by a differential scanning calorimeter (Q-200, available from TA Instruments Japan Inc.).

The DSC curve of the first heating is selected from the obtained DSC curves, and a glass transition temperature of the sample from the first heating may be determined using an analysis program installed in the Q-200 system. Similarly, the DSC curve of the second heating is selected from the obtained DSC curves, and a glass transition temperature of the sample from the second heating may be determined using the analysis program installed in the Q-200 system.

In the present disclosure, the glass transition temperature of the amorphous polyester resin A is Tg from the second heating, unless otherwise stated.

### [Acid Value]

An acid value of the amorphous polyester resin A may be appropriately selected, and is preferably from 1 mgKOH/g to 50 mgKOH/g, more preferably from 5 mgKOH/g to 30 mgKOH/g. When the acid value of the amorphous polyester resin A is 1 mgKOH/g or greater, a toner including the resin particles tends to be negatively charged to improve affinity between the toner and a recording medium, such as paper, during fixing to the recording medium, so that low-temperature fixability is improved. When the acid value of the amorphous polyester resin A is 50 mgKOH/g or less, charging stability, especially charging stability against fluctuations of environmental conditions, can be assured.

The acid value of the amorphous polyester resin A can be measured according to the measuring method specified in JIS K0070-1992.

An amount of the amorphous polyester resin A in the resin particles is not particularly limited, and may be appropriately selected depending on the intended purpose. When the amount of the amorphous polyester resin A is preferably from 5% by mass to 40% by mass, more preferably from 10% by mass to 40% by mass, relative to a total mass of the resin particles. When the amount of the amorphous polyester resin A is 5% by mass or greater, a sufficient effect of improving charging characteristics and heat-resistant storage stability can be obtained. When the amount of the amorphous polyester resin A is 40% by mass or less, desired low-temperature fixability is achieved.

The molecular structure of the sulfonic acid salt group-containing polyester resin and the molecular structure of the amorphous polyester resin A can be each determined by solution or solid nuclear magnetic resonance spectroscopy (NMR), X-ray diffraction spectroscopy, gas chromatography-mass spectrometry (GC-MS), liquid chromatography-mass spectrometry (LC-MS), infrared (IR) spectroscopy, or pyrolysis gas chromatography (py-GC). Among the above-listed methods, a preferred simple method is a method where the structure is determined from chromatograms of monomers derived from the sulfonic acid salt group-containing polyester resin or the amorphous polyester resin A obtained by pyrolysis gas chromatography (py-GC).

### <Crystalline Polyester Resin>

The crystalline polyester resin is not particularly limited, except that the crystalline polyester resin is a polyester resin having crystallinity. The crystalline polyester resin be appropriately selected depending on the intended purpose. Examples of the crystalline polyester resin include polyester resins each synthesized from a multivalent alcohol and a multivalent carboxylic acid or a derivative of the multivalent carboxylic acid.

In the present specification, the “crystalline polyester resin” encompasses a resin synthesized from the multivalent alcohol and the multivalent carboxylic acid or the derivative of the multivalent carboxylic acid, as described above. Therefore, a modified polyester resin, such as a prepolymer, and a resin obtained through at least any of a cross-linking reaction and an elongation reaction of the prepolymer, is not classified as the crystalline polyester resin.

### —Multivalent Alcohol—

The multivalent alcohol is not particularly limited, and may be appropriately selected depending on the intended purpose. Examples of the multivalent alcohol include diols, trivalent or higher alcohols, and a mixture of a diol and a trivalent or higher alcohol. The above-listed examples may be used alone or in combination.

The diols are not particularly limited, and may be appropriately selected depending on the intended purpose. Examples of the diols include saturated aliphatic diols.

Examples of the saturated aliphatic diols include straight-chain saturated aliphatic diols and branched-chain saturated aliphatic diols. Among the above-listed examples, the saturated aliphatic diols are preferably straight-chain saturated aliphatic diols, more preferably C2-C12 straight-chain saturated aliphatic diols. If the saturated aliphatic diol is a branched saturated aliphatic diol, a resulting crystalline polyester resin may have low crystallinity and a low melting point. When the number of carbon atoms of the saturated aliphatic diol is greater than 12, it is difficult to practically source such a saturated aliphatic diol.

Examples of the saturated aliphatic diols include ethylene glycol, 1, 3-propanediol, 1, 4-butanediol, 1, 5-pentanediol, 1, 6-hexanediol, 1, 7-heptanediol, 1, 8-octanediol, 1, 9-nonanediol, 1, 10-decanediol, 1, 11-undecanediol, 1, 12-dodecanediol, 1, 13-tridecanediol, 1, 14-tetradecanediol, 1, 18-octadecanediol, and 1, 14-eicosanedecanediol. The above-listed examples may be used alone or in combination. Among the above-listed examples, ethylene glycol, 1, 4-butanediol, 1, 6-hexanediol, 1,8-octanediol, 1, 9-nonanediol, 1, 10-decanediol, and 1, 12-dodecanediol are preferred in view of high crystallinity and excellent sharp melting properties imparted to a resulting crystalline polyester resin

Examples of the trivalent or higher alcohols include glycerin, trimethylolethane, trimethylolpropane, and pentaerythritol. The above-listed examples may be used alone or in combination.

### —Multivalent Carboxylic Acid and Derivative of Multivalent Carboxylic Acid—

The multivalent carboxylic acids are not particularly limited, and may be appropriately selected depending on the intended purpose. Examples of the multivalent carboxylic acids include dicarboxylic acids, trivalent or higher carboxylic acids, and mixtures of a dicarboxylic acid and a trivalent or higher carboxylic acid. The above-listed examples may be used alone or in combination.

Examples of the derivatives of the multivalent carboxylic acids include anhydrides of any of the above-listed multivalent carboxylic acids, and esters of any of the above-listed multivalent carboxylic acids.

Examples of the dicarboxylic acids and derivatives of the dicarboxylic acids include unsaturated aliphatic dicarboxylic acids, aromatic dicarboxylic acids, anhydrides of the foregoing dicarboxylic acids, and lower (C1-C10) alkyl esters of the foregoing dicarboxylic acids. The above-listed examples may be used alone or in combination.

Examples of the saturated aliphatic dicarboxylic acids include oxalic acid, succinic acid, glutaric acid, adipic acid, suberic acid, azelaic acid, sebacic acid, 1, 9-nonanedicarboxylic acid, 1, 10-decanedicarboxylic acid, 1, 12-dodecanedicarboxylic acid, 1,14-tetradecanedicarboxylic acid, and 1,18-octadecanedicarboxylic acid.

Examples of the aromatic dicarboxylic acids include phthalic acid, isophthalic acid, terephthalic acid, naphthalene-2, 6-dicarboxylic acid, malonic acid, and mesaconic acid.

Examples of the trivalent or higher carboxylic acids and the derivatives of the trivalent or higher carboxylic acids include 1,2, 4-benzenetricarboxylic acid, 1, 2, 5-benzenetricarboxylic acid, 1, 2, 4-naphthalenetricarboxylic acid, anhydrides of the foregoing trivalent or higher carboxylic acids, and lower (C1-C3) alkyl esters of the foregoing trivalent or higher carboxylic acids. The above-listed examples may be used alone or in combination.

Among the above-listed examples, the crystalline polyester resin is preferably synthesized from a C4-C12 straight chain saturated aliphatic dicarboxylic acid and a C2-C12 straight-chain saturated aliphatic diol. The above-described crystalline polyester resin has high crystallinity and excellent sharp melting properties, thus resulting resin particles have excellent low-temperature fixability.

A method for controlling crystallinity and a softening point of the crystalline polyester resin is, for example, a method where a non-linear polyester is designed and used by adding a trivalent or higher multivalent alcohol (e.g., glycerin) to an alcohol component, or adding a trivalent or higher multivalent carboxylic acid (e.g., trimellitic anhydride) to an acid component for synthesis of the polyester to perform a condensation polymerization.

A molecular weight of the crystalline polyester resin is not particularly limited, and may be appropriately selected depending on the intended purpose. Since the crystalline polyester resin having a sharp molecular weight distribution and a low molecular weight imparts excellent low-temperature fixability and a large amount of a low-molecular weight component in the crystalline polyester resin improves heat-resistant storage stability, a peak preferably appears in the region of 3.5 to 4.0 in a molecular weight distribution curve of an o-dichlorobenzene-soluble component of the crystalline polyester resin as measured by gel permeation chromatography (GPC), where a horizontal axis represents log (M) and a vertical axis represents % by mass, the half value width of the peak is preferably 1.5 or less, and the weight average molecular weight (Mw), number average molecular weight (Mn), and molecular weight ratio (Mw/Mn) are preferably within the following ranges.

The weight average molecular weight (Mw) of the crystalline polyester resin is preferably from 3,000 to 30,000, more preferably from 5,000 to 15,000.

The number average molecular weight (Mn) of the crystalline polyester resin is preferably from 1,000 to 10,000, more preferably from 2,000 to 10,000.

The ratio (Mw/Mn) of the molecular weights of the crystalline polyester resin is preferably from 1 to 10, more preferably from 1 to 5.

An acid value of the crystalline polyester resin is not particularly limited, and may be appropriately selected depending on the intended purpose. The lower limit of the acid value is preferably 5 mgKOH/g or greater in view of affinity between a recording medium and the resin particles to achieve the desired low-temperature fixability. The lower limit of the acid value is more preferably 7 mgKOH/g or greater in view of production of the resin particles by phase inversion emulsification. The upper limit of the acid value of the crystalline polyester resin is preferably 45 mgKOH/g or less for improvement in hot offset resistance.

The acid value of the crystalline polyester resin can be measured according to the measuring method specified in JIS K0070-1992.

A hydroxyl value of the crystalline polyester resin is not particularly limited, and may be appropriately selected depending on the intended purpose. The hydroxyl value of the crystalline polyester resin is preferably from 0 mgKOH/g to 50 mgKOH/g, more preferably from 5 mgKOH/g to 10 mgKOH/g to achieve desired low-temperature fixability and excellent charging characteristics.

The hydroxyl value of the crystalline polyester resin can be measured according to the measuring method specified in JIS K0070-1992.

The molecular structure of the crystalline polyester resin can be determined by solution or solid nuclear magnetic resonance spectroscopy (NMR), X-ray diffraction spectroscopy, gas chromatography-mass spectrometry (GC-MS), liquid chromatography-mass spectrometry (LC-MS), or infrared (IR) spectroscopy. Among the above-listed examples, a simple method is method where a compound having absorption, which is based on OCH (out of plane bending vibrations) of an olefin, at 965+10 cm⁻¹ and 990+10 cm⁻¹ on an infrared absorption spectrum of the compound as measured by IR spectroscopy is detected as the crystalline polyester resin.

An amount of the crystalline polyester resin in the resin particles is not particularly limited, and may be appropriately selected depending on the intended purpose. The amount of the crystalline polyester resin is preferably from 3% by mass to 20% by mass, more preferably from 5% by mass to 15% by mass, relative to a total mass of the resin particles. When the amount of the crystalline polyester resin in the resin particles is 3% by mass or greater, sharp melting properties of the resin particles can be improved owing to the crystalline polyester resin, and low-temperature fixability of the resin particles is improved. When the amount of the crystalline polyester resin in the resin particles is 20% by mass or less, desirable heat-resistant storage stability of resulting resin particles is achieved, and occurrences of image fogging are minimized. The more preferred range of the amount of the crystalline polyester resin in the resin particles is advantageous in view of high image quality and excellent low-temperature fixability.

### <Release Agent>

The release agent is not particularly limited, and may be appropriately selected depending on the intended purpose. The release agent is preferably a low-melting point release agent having a melting point of from 50° C. to 120° C. When the resin particles are used as a toner, as the low-melting point release agent is dispersed together with the amorphous polyester resin A, the release agent effectively functions at interfaces each between a fixing roller and resin particles serving as a toner. As a result, excellent hot offset resistance is achieved in an oil-less system (where an oil-like release agent is not applied onto the fixing roller).

The release agent is not particularly limited and may be appropriately selected from release agents available in the related art. Examples of the release agent include wax, fatty acid amides, homopolymers or copolymers of polyacrylate, and crystalline polymers each including a long alkyl group at a side chain. The above-listed examples may be used alone or in combination.

Examples of the wax include natural wax, synthetic hydrocarbon wax, and synthetic wax.

Examples of the natural wax include vegetable wax, animal wax, mineral wax, and petroleum wax.

Examples of the vegetable wax include carnauba wax, cotton wax, and Japan wax.

Examples of the animal wax include beeswax and lanoline wax.

Examples of the mineral wax include ozokerite and ceresin.

Examples of the petroleum wax include paraffin wax, microcrystalline wax, and petrolatum wax.

Examples of the synthetic hydrocarbon wax include Fischer-Tropsch wax and polyethylene wax.

Examples of the synthetic wax include ester wax, ketone wax, and ether wax.

Examples of the fatty acid amides include 12-hydroxystearic acid amide, stearic acid amide, phthalimide anhydride, and chlorinated hydrocarbon.

Examples of the polyacrylate include low-molecular-weight crystalline polymer resins, such as poly-n-stearyl methacrylate and poly-n-lauryl methacrylate.

Examples of the homopolymers or copolymers of the polyacrylate include a n-stearyl acrylate-ethyl methacrylate copolymer.

A melting point of the release agent is not particularly limited, and may be appropriately selected depending on the intended purpose. The melting point of the release agent is preferably from 50° C. to 120° C., more preferably from 60° C. to 90° C. When the melting point of the release agent is 50° C. or higher, the release agent does not adversely affect heat-resistant storage stability of resulting resin particles. When the melting point of the release agent is 120° C. or lower, occurrences of cold offset during fixing at low temperatures can be minimized.

A melt viscosity of the release agent is not particularly limited, and may be appropriately selected depending on the intended purpose. The melt viscosity of the release agent measured at a temperature higher than the melting point of the release agent by 20° C. is preferably from 5 cps to 1,000 cps, more preferably from 10 cps to 100 cps. When the melt viscosity of the release agent is 5 cps or greater, desired release properties are achieved. When the melt viscosity of the release agent is 1,000 cps or less, desired hot offset resistance and low-temperature fixability are achieved.

An amount of the release agent is not particularly limited, and may be appropriately selected depending on the intended purpose. The amount of the release agent is preferably from 0% by mass to 40% by mass, more preferably from 3% by mass to 30% by mass, relative to a total mass of the resin particles. When the amount of the release agent is 40% by mass or less, desired flowability of the resin particles is achieved.

### <Other Components>

The above-mentioned other components in the resin particles are not particularly limited, and may be appropriately selected according to the intended purpose. Examples of the above-mentioned other components include colorants, charge control agents, flowability improvers, cleaning improvers, and magnetic materials. The above-listed examples may be used alone or in combination.

### «Colorant»

The colorant is not particularly limited, and any of dyes and pigments available in the related art may be used as the colorant.

Examples of the colorant include carbon black, nigrosine dyes, iron black, Naphthol yellow S, Hansa yellow (10G, 5G, and G), cadmium yellow, yellow iron oxide, yellow ocher, yellow lead, titanium yellow, polyazo yellow, oil yellow, Hansa yellow (GR, A, RN, and R), Pigment Yellow L, Benzidine Yellow (G and GR), Permanent Yellow (NCG), Vulcan Fast Yellow (5G and R), tartrazine lake, quinoline yellow lake, anthracene yellow BGL, isoindolinon yellow, red iron oxide, red lead, lead vermilion, cadmium red, cadmium mercury red, antimony vermilion, Permanent Red 4R, parared, fire red, p-chloro-o-nitroaniline red, Lithol Fast Scarlet G, brilliant fast scarlet, Brilliant Carmine BS, Permanent Red (F2R, F4R, FRL, FRLL, and F4RH), Fast Scarlet VD, Vulcan Fast Rubin B, Brilliant Scarlet G, Lithol Rubin GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, eosin lake, Rhodamine B Lake, Rhodamine Y Lake, alizarin lake, Thioindigo Red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, Indanthrene Blue (RS and BC), indigo, ultramarine, iron blue, anthraquinone blue, Fast Violet B, methyl violet lake, cobalt purple, manganese violet, dioxane violet, anthraquinone violet, chrome green, zinc green, chromium oxide, viridian, emerald green, Pigment Green B, Naphthol Green B, green gold, acid green lake, malachite green lake, phthalocyanine green, anthraquinone green, titanium oxide, zinc flower, and lithopone. The above-listed examples may be used alone or in combination.

An amount of the colorant in the resin particles is not particularly limited, and may be appropriately selected depending on the intended purpose. The amount of the colorant is preferably from 1% by mass to 15% by mass, more preferably from 3% by mass to 10% by mass, relative to a total mass of the resin particles.

In the case where the resin particles do not include the colorant, the resin particles can be suitably used as a clear toner.

The colorant may be used as master batch in which the colorant forms a composite with a resin.

The resin used for production of the master batch or the resin kneaded together with the master batch is not particularly limited, and may be appropriately selected according to the intended purpose. Examples of the resin include, as well as the amorphous polyester resin, polymers of styrene or substituted styrene, styrene-based copolymers, polymethyl methacrylate, polybutyl methacrylate, polyvinyl chloride, polyvinyl acetate, polyethylene, polypropylene, polyester, epoxy resins, epoxypolyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin, and paraffin wax. The above-listed examples may be used alone or in combination.

Examples of the polymers of styrene or substituted styrene include polystyrene, poly-p-chlorostyrene, and polyvinyl toluene.

Examples of the styrene-based copolymers include styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl-α-chloromethacrylate copolymers, styrene-acrylonitrile copolymers, styrene-methyl vinyl ketone copolymers, styrene-butadiene copolymers, styrene-isoprene copolymers, styrene-acrylonitrile-indene copolymers, styrene-maleic acid copolymers, and styrene-maleic acid ester copolymers.

A method for producing the master batch is not particularly limited, and may be appropriately selected according to the intended purpose. Examples of the method include a method where a high shearing force is applied to mix and knead the resin for the master batch and the colorant. During the mixing and kneading, an organic solvent may be used to enhance interaction between the colorant and the resin. Moreover, a flashing method is preferably used. The flashing method is a method where an aqueous paste including a colorant and water is mixed and kneaded with a resin and an organic solvent to transfer the colorant to the side of the resin, followed by removing the water and the organic solvent. According to the flashing method, a wet cake of the colorant can be used as the master batch so that it is not necessary to dry the colorant. A high-shearing disperser, such as a three-roll mill, is preferably used for the mixing and kneading.

### «Charge Control Agent»

The resin particles of the present disclosure have a negative charge owing to the sulfonic acid salt group in the shell layer. However, the charge of the resin particles can be controlled with a charge control agent.

The charge control agent is not particularly limited, and may be appropriately selected according to the intended purpose. Examples of the charge control agent include nigrosine-based dyes, triphenylmethane-based dyes, chrome-containing metal complex dyes, molybdic acid chelate pigments, rhodamine-based dyes, alkoxy-based amines, quaternary ammonium salts (including fluorine-modified quaternary ammonium salts), alkylamides, phosphorus or phosphorus compounds, fluorine-based active agents, metal salts of salicylic acid, metal salts of salicylic acid derivatives, oxynaphthoic acid metal salts, phenol-based condensates, azo-pigments, boron complexes, and functional group (e.g., a sulfonic acid group, a carboxyl group, and a quaternary ammonium salt)-containing polymer-based compounds. The above-listed examples may be used alone or in combination.

Specific examples of the charge control agent include: a nigrosine-based dye BONTRON 03, a quaternary ammonium salt BONTRON P-51, a metal-containing azo dye BONTRON S-34, an oxynaphthoic acid-based metal complex E-82, a salicylic acid-based metal complex E-84, and a phenol-based condensate E-89 (all available from ORIENT CHEMICAL INDUSTRIES CO., LTD.); a quaternary ammonium salt molybdenum complex TP-302 and TP-415 (both available from Hodogaya Chemical Co., Ltd.); a quaternary ammonium salt Copy Charge PSY VP2038, a triphenylmethane derivative Copy Blue PR, a quaternary ammonium salt Copy Charge NEG VP2036, and Copy Charge NX VP434 (all available from Hoechst); LRA-901 and a boron complex LR-147 (available from Japan Carlit Co., Ltd.); copper phthalocyanine; perylene; quinacridone; and azo-pigments.

An amount of the charge control agent is not particularly limited, provided that an effect obtainable by the charge control agent is adequately exhibited and fixability of resulting resin particles is not adversely affected. The amount of the charge control agent may be appropriately selected depending on the intended purpose. The amount of the charge control agent is preferably from 0.5% by mass to 5% by mass, more preferably from 0.8% by mass to 3% by mass, relative to a total mass of the resin particles.

The charge control agent may be melt-kneaded with a master batch, the amorphous polyester resin, or the crystalline polyester resin, followed by dissolving and dispersing the mixture in a solvent. Alternatively, the charge control agent is directly added to an organic solvent when constituent components are dissolved and dispersed in the organic solvent. The charge control agent may be fixed on surfaces of the resin particles after production of the resin particles.

### «Flowability Improver»

The flowability improver is not particularly limited, except that the flowability improver is capable of increasing hydrophobicity to prevent degradation of flowability and charging characteristics in high humidity conditions. The flowability improver may be appropriately selected according to the intended purpose. Examples of the flowability improver include silane coupling agents, silylating agents, fluoroalkyl group-containing silane coupling agents, organic titanate-based coupling agents, aluminum-based coupling agents, silicone oil, and modified silicone oil. The above-listed examples may be used alone or in combination.

An amount of the flowability improver is not particularly limited, and may be appropriately selected depending on the intended purpose. The amount of the flowability improver is preferably 0.01 parts by mass or greater and 5.00 parts by mass or less, more preferably 0.10 parts by mass or greater and 2.00 parts by mass or less, relative to a total mass of the resin particles.

### «Cleaning Improver»

The cleaning improver is an agent to aid removal of a developer remaining on a photoconductor or a primary transferring member after transferring.

The cleaning improver is not particularly limited, and may be appropriately selected according to the intended purpose. Examples of the cleaning improver include fatty acid metal salts and polymer particles. The above-listed examples may be used alone or in combination.

Examples of the fatty acid metal salts include zinc stearate, calcium stearate, and other metal salts of stearic acid.

The polymer particles are preferably polymer particles produced by soap-free emulsion polymerization. Examples of the polymer particles include polymethyl methacrylate particles and polystyrene particles.

A volume average particle diameter of the polymer particles is not particularly limited, and may be appropriately selected according to the intended purpose. The polymer particles preferably have a relatively narrow particle size distribution. The polymer particles having the volume average particle diameter of from 0.01 μm to 1 μm are preferred.

An amount of the cleaning improver is not particularly limited, and may be appropriately selected depending on the intended purpose. The amount of the cleaning improver is preferably 0.01 parts by mass or greater and 5.00 parts by mass or less, more preferably 0.10 parts by mass or greater and 2.00 parts by mass or less, relative to a total mass of the resin particles.

### «Magnetic Material»

The magnetic material is not particularly limited, and may be appropriately selected according to the intended purpose. Examples of the magnetic material include iron powder, magnetite, and ferrite. The above-listed examples may be used alone or in combination. Among the above-listed examples, the magnetic material is preferably a white magnetic material in view of color tone.

An amount of the magnetic material is not particularly limited, and may be appropriately selected depending on the intended purpose. The amount of the magnetic material is preferably 20 parts by mass or greater and 200 parts by mass or less, more preferably 40 parts by mass or greater and 150 parts by mass or less, relative to a total mass of the resin particles.

### [Volume Average Particle Diameter]

A volume average particle diameter (Dv) of the resin particles is not particularly limited, and may be appropriately selected depending on the intended purpose. The volume average particle diameter (Dv) of the resin particles is preferably 3 μm or greater and 7 μm or less.

A ratio (Dv/Dn) of the volume average particle diameter (Dv) to a number average particle diameter (Dn) of the resin particles is not particularly limited, and may be appropriately selected depending on the intended purpose. The ratio (Dv/Dn) is preferably 1.2 or less.

Moreover, the resin particles include the population of the resin particles having the volume average particle diameter (Dv) of 2 μm or less in an amount of 1% by number or greater and 10% by number or less.

The volume average particle diameter (Dv) and number average particle diameter (Dn) of the resin particles may be determined, for example, by measuring the resin particles by a particle size analyzer (Multisizer III, available from Beckman Coulter, Inc.) using a 100 μm-aperture as an aperture, and analyzing with an analysis software (Beckman Coulter Multisizer 3 Version 3.51) under the following conditions.

Specifically, 0.5 mL of a 10% by mass surfactant (preferably an alkylbenzene sulfonic acid salt, such as NEOGEN SC-A, available from DKS Co., Ltd.) is added to 100 mL of a glass beaker, and 0.5 g of the resin particles are added to the surfactant, followed by stirring with a micro-spatula. To the mixture, 80 mL of ion-exchanged water is added. The resulting dispersion liquid is subjected to ultrasonication for 10 minutes by an ultrasonic disperser (e.g., W-113MK-II, available from HONDA ELECTRONICS CO., LTD.). The dispersion liquid is measured by Multisizer III using ISOTON III (available from Beckman Coulter, Inc.) as a solution for a measurement. The measurement is carried out by dripping the resin particle sample dispersion liquid in a manner that the concentration indicated by the device is within the range of 8%+2%.

### [Average Circularity]

When the resin particles are used as a toner, the resin particles preferably have certain shapes in terms of an average circularity. The average circularity of the resin particles is preferably 0.940 or greater and less than 0.980. When the average circularity of the resin particles is 0.940 or greater, the resin particles have irregular shapes that are not exactly spheres so that desired transferring properties of the resin particles and formation of high quality images are achieved without toner scattering. When the average circularity of the resin particles is less than 0.980, a cleaning failure of a photoconductor or a transfer belt does not occur in a system using blade cleaning, so that an image is formed without any staining.

The average circularity of the resin particles can be determined by measuring the resin particles by a flow particle image analyzer (e.g., FPIA-3000, available from SYSMEX CORPORATION) with analysis software (FPIA-3000 FLOW PARTICLE IMAGE ANALYZER version 00-11) under the following conditions.

Specifically, 0.1 mL to 0.5 mL of a 10% by mass surfactant (preferably an alkylbenzene sulfonic acid salt, such as NEOGEN SC-A, available from DKS Co., Ltd.) is added to 100 mL of a glass beaker, and 0.1 g to 0.5 g of the resin particles are added to the surfactant, followed by stirring with a micro-spatula. To the mixture, 80 mL of ion-exchanged water is added. The resulting dispersion liquid is subjected to ultrasonication for 3 minutes by an ultrasonic disperser (e.g., W-113MK-II, available from HONDA ELECTRONICS CO., LTD.). The dispersion liquid is adjusted to the range of 5,000 particles/μL to 15, 000 particles/μL. The resulting dispersion liquid is measured by FPIA-3000 to determine shapes and distribution of the resin particles.

### [Low-Temperature Fixability]

The resin particles have excellent low-temperature fixability.

The cold offset temperature of the resin particles is not particularly limited, and may be appropriately selected depending on the intended purpose. The cold offset temperature is preferably 140° C. or lower, more preferably 135° C. or lower, and yet more preferably 130° C. or lower.

The low-temperature fixability of the resin particles can be evaluated in the following manner.

Specifically, a solid image of 2 cm×15 cm is uniformly placed on a surface of a sheet (PPC sheet 6000<70W>, A4, long grain, available from Ricoh Company Limited) so that a deposition amount of the resin particles is to be 0.40 mg/cm². To deposit resin particles on the surface of the sheet, a printer from which a thermal fixing device is removed (imagio MP C5503 (available from Ricoh Company Limited) from which a thermal fixing device is removed) was used. Another method may be used as long as the resin particles can be deposited at the above-mentioned mass density. When the sheet is passed under a press roller at a fixing speed (rim speed of a heating roller) of 213 mm/see and fixing pressure (surface pressure applied by the press roller) of 10 kg/cm², the cold offset temperature can be measured.

### [Adhesion]

The interparticle force (Fp [gf]) of the resin particles when the resin particles are compressed at 160 kN/m² is not particularly limited, and may be appropriately selected depending on the intended purpose. The interparticle force (Fp [gf]) is preferably 500 gf or less, more preferably 300 gf or less, and yet more preferably 200 gf or less. When the interparticle force (Fp [gf]) of the resin particles when the resin particles are compressed at 160 KN/m² is 500 gf or less, the resin particles are not aggregated to one another so that excellent flowability of the resin particles is achieved.

The interparticle force (Fp [gf]) of the resin particles as compressed at 160 kN/m² can be measured by a testing system for compression characteristics and tensile strength of powder beds, AGGROBOT® (available from HOSOKAWA MICRON CORPORATION)). A cylindrical cell that can be divided into an upper cell and a lower cell is charged with the predetermined amount of the resin particles. After compressing the resin particles at the pressure of 160 kN/m², the upper cell is lifted up to fracture the powder bed of the resin particles. The interparticle adhesion is calculated from the maximum tensile fracture force at the time of the fracture of the powder bed, the height of the powder bed at the time of the compression, the inner diameter of the cell, the average particle diameter of the resin particles, the true density of the resin particles, and the amount of the resin particles under the following conditions.

Specifically, the measurement of the interparticle force (Fp [gf]) is performed with the resin particles in an amount of 8.00 g±0.02 g, the temperature of 25° C. ±2° C., the humidity of 30% RH±5% RH, the cell inner diameter of 25 mm, the cell temperature of 25° C., the spring diameter of 1.0 mm, the compression speed of 0.1 mm/s, the compression load of 8 kg (pressing force of 160 kN/m²), the compression retention time of 60 seconds, the tensile speed of 0.6 mm/s, the tensile sampling onset time of 0 seconds, and the tensile sampling time of 25 seconds, and the installed application software calculates the interparticle force (Fp [gf]). The calculated interparticle force (Fp [gf]) is determined as the interparticle force (Fp) of the resin particles as compressed at 160 KN/m². Note that, the measurement is performed after conditioning the resin particles for 24 hours at 23° C. and 53% RH.

### [Heat-Resistant Storage Stability]

The resin particles have excellent heat-resistant storage stability. The heat-resistant storage stability of the resin particles can be determined by the following manner. A 50 mL glass container is charged with the resin particles, and the resin particles are left to stand in a constant temperature tank of 50° C. for 24 hours, followed by cooling to 24° C. A penetration degree [mm] is measured by the penetration test (JIS K 2235-1991) to evaluate the heat-resistant storage stability.

The penetration degree is not particularly limited, and may be appropriately selected depending on the intended purpose. The penetration degree is preferably 10 mm or greater, more preferably 15 mm or greater, and yet more preferably 20 mm or greater.

### [Charging Characteristics]

The resin particles have excellent negative-charge characteristics.

The level of the negative charge of the resin particles is not particularly limited, and may be appropriately selected depending on the intended purpose. The negative charge is preferably 30 [−μC/g] or greater, more preferably 33 [−μC/g] or greater, and yet more preferably 36 [−μC/g] or greater.

In the present specification, the unit of the quantity of the negative charge is “−μC/g.” The larger the absolute value is, the greater the charge is. For example, the absolute value of the charge “30 [−μC/g] or greater” means the same as “−30 μC/g or less.”

The charge of the resin particles can be measured in the following manner. The resin particles (5 g) and the carrier (95 g) are weighed, and the weighed resin particles and carrier are placed in a sealable metal cylinder. The mixture of the resin particles and the carrier is stirred at the stirring speed of 280 rpm, and the triboelectric charge of the mixture can be determined by the blow-off method. The triboelectric charge is measured after each of the stirring durations of 15 seconds (may be referred to as “TA15” hereinafter), 60 seconds (may be referred to as “TA60” hereinafter), and 600 seconds (may be referred to as “TA600” hereinafter). The negative charge is preferably within the above-mentioned preferred range after each of the stirring durations to achieve excellent charging characteristics.

The resin particles can be suitably produced by the below-described method for producing resin particles of the present disclosure.

The production method of the resin particles is not particularly limited. As well as the below-described method for producing resin particles of the present disclosure, a method where core particles are formed by pulverization and classification, followed by forming a shell layer on a surface of each of the core particles may be used.

A method for forming a shell layer on a surface of each of core particles after forming the core particles by pulverization and classification is, for example, as follows.

The amorphous polyester resin A, the crystalline polyester resin, and the release agent, and optional other components, such as a colorant, are mixed and kneaded together, and the obtained kneaded product is pulverized and classified to form core particles constituting core layers. Thereafter, constituent materials of a shell layer are dispersed or dissolved in a solvent, such as water and an organic solvent. To the dispersion or solution, the core particles are added, followed by stirring, to form a shell layer on each of the core layers to thereby produce resin particles each having a core-shell structure.

Thereafter, <Washing step>, <Drying step>, and <Annealing step> of the below-described method for producing resin particles of the present disclosure may be performed, as necessary.

### (Method for Producing Resin Particles)

The method for producing resin particles of the present disclosure is a production method for the resin particles of the present disclosure. The method for producing resin particles includes (a) dissolving or dispersing at least an amorphous polyester resin in an organic solvent to prepare a core layer-forming oil phase (may be referred to as a “core layer-forming oil phase forming step” hereinafter), (b) adding the core layer-forming oil phase to an aqueous phase to cause phase inversion from a water-in-oil dispersion liquid to a core layer-forming oil-in-water dispersion liquid (may be referred to as a “core layer-forming oil-in-water dispersion liquid forming step” hereinafter), (c) dissolving or dispersing at least an amorphous polyester resin including a sulfonic acid salt group-containing polyester resin in an organic solvent to prepare a shell layer-forming oil phase (may be referred to as a “shell layer-forming oil phase preparation step” hereinafter), (d) adding an aqueous phase to the shell layer-forming oil phase to cause phase inversion from a water-in-oil dispersion liquid to a shell layer-forming oil-in-water dispersion liquid (may be referred to as a “shell layer-forming oil-in-water dispersion liquid preparation step” hereinafter), (e) aggregating particles in the core layer-forming oil-in-water dispersion liquid obtained in (b) to form aggregated particles (may be referred to as an “aggregating step” hereinafter), and (f) adding the shell layer-forming oil-in-water dispersion liquid obtained in (d) to the aggregated particles obtained in (e) to obtain resin particles (may be referred to as a “shell forming step” hereinafter). The method may further include other steps, such as a core layer-forming aqueous phase preparation step, a shell layer-forming aqueous phase preparation step, a solvent removing step, a fusing step, a washing step, a drying step, an annealing step, and an external additive step, as necessary.

The method for producing the resin particles of the present disclosure may include adding either of or both a crystalline polyester resin and a release agent in (a) or in (e).

### <(a) Core Layer-Forming Oil Phase Preparation Step>

The (a) core layer-forming oil phase preparation step includes dissolving or dispersing at least an amorphous polyester resin in an organic solvent.

The core layer-forming oil phase preparation step may further include adding either of or both a crystalline polyester resin and a release agent.

The amorphous polyester resin and the crystalline polyester resin are as described in the sections of «Another amorphous polyester resin (amorphous polyester resin A)» and <Crystalline polyester resin> of (Resin particles).

The core layer-forming oil phase may further include other components, such as a colorant or master batch, and a charge control agent.

The above-mentioned other components are as described in the section of <Other components> of (Resin particles).

In the core layer-forming oil phase preparation step, first, the amorphous polyester resin A, and optionally a colorant or master batch, a release agent, and/or a crystalline polyester resin, are dissolved or dispersed in an organic solvent to prepare an oil phase. Moreover, the core layer-forming oil phase preparation step may further include adding, instead of the amorphous polyester resin A, a prepolymer and a curing agent to the oil phase to form the amorphous polyester resin A.

The organic solvent is not particularly limited, and may be appropriately selected depending on the intended purpose. In view of easiness of removal, the organic solvent is preferably a volatile organic solvent having a boiling point of lower than 100° C.

The volatile organic solvent having a boiling point of lower than 100° C. is not particularly limited, and may be appropriately selected depending on the intended purpose. Examples of the organic solvent include toluene, xylene, benzene, carbon tetrachloride, methylene chloride, 1,2-dichloroethane, 1, 1, 2-trichloroethane, trichloroethylene, chloroform, monochlorobenzene, dichloroethylidene, methyl acetate, ethyl acetate, methyl ethyl ketone, methanol, ethanol, and isopropyl alcohol. The above-listed examples may be used alone or in combination. Among the above-listed examples, the organic solvent is preferably an ester-based solvent (e.g., methyl acetate, ethyl acetate, and butyl acetate) or a ketone-based solvent (e.g., methyl ethyl ketone and methyl isobutyl ketone) is preferred in view of high dissolving power. The organic solvent is particularly preferably methyl acetate, ethyl acetate, or methyl ethyl ketone in view of easiness of removal.

An amount of the organic solvent is not particularly limited, and may be appropriately selected depending on the intended purpose. The amount of the organic solvent is preferably from 40 parts by mass to 300 parts by mass, more preferably from 60 parts by mass to 140 parts by mass, and yet more preferably from 80 parts by mass to 120 parts by mass, relative to 100 parts of the constituent materials of the resin particles.

A production method of the core layer-forming oil phase is not particularly limited, and may be appropriately selected according to the intended purpose. Examples of the production method include a method where constituent materials of a core layer, such as the amorphous polyester resin A and as necessary, a colorant, a release agent, and a crystalline polyester resin, are gradually added into an organic solvent, while stirring, to dissolve or disperse the constituent material in the organic solvent.

For the dispersing, any of devices available in the related art may be used. For example, a disperser, such as a bead mill and a disk mill, may be used.

When the release agent or the crystalline polyester resin is added in the core layer-forming oil phase preparation step, a dispersion liquid, in which the release agent is dispersed in an aqueous medium, or a dispersion liquid of the crystalline polyester resin is prepared, the resulting dispersion liquids are mixed, and the mixture is added to prepare a core layer-forming oil phase, in which the release agent and the crystalline polyester resin are homogeneously dispersed.

The diameter of the dispersed particles of the crystalline polyester resin in the dispersion liquid is not particularly limited, and may be appropriately selected depending on the intended purpose. The diameter is preferably 20 nm or greater and 500 nm or less.

In the present specification, the diameter of the dispersed particles of the crystalline polyester resin in the dispersion liquid is the volume average particle diameter.

The diameter of the dispersed particles of the release agent in the dispersion liquid is not particularly limited, and may be appropriately selected depending on the intended purpose. The diameter is preferably 50 nm or greater and 600 nm or less, more preferably 50 nm or greater and 400 nm or less.

In the present specification, the diameter of the dispersed particles of the release agent in the dispersion liquid is the volume average particle diameter.

The diameter of the dispersed particles of the crystalline polyester resin and the diameter of the dispersed particles of the release agent can be measured by a laser diffraction/scattering particle size distribution analyzer (LA-920, available from HORIBA, Ltd.).

### <Core Layer-Forming Aqueous Phase Preparation Step>

The core layer-forming aqueous phase preparation step includes preparation of an aqueous phase (aqueous medium).

The aqueous medium is not particularly limited, and may be appropriately selected depending on the intended purpose. Examples of the aqueous medium include water, solvents miscible with water, and mixtures of the foregoing media. The above-listed examples may be used alone or in combination. Among the above-listed examples, water is preferred. Examples of the water include ion-exchanged water.

Examples of the solvents miscible with water include organic solvents.

The organic solvents are not particularly limited, except that the organic solvents are miscible with water. The organic solvents may be appropriately selected from organic solvents available in the related art. Examples of the organic solvents include: ester-based solvents, such as methyl acetate, ethyl acetate, and butyl acetate; ketone-based solvents, such as acetone, methyl ethyl ketone, and methyl isobutyl ketone; alcohol-based solvents, such as methanol, isopropanol, and ethylene glycol; amide-based solvents, such as dimethylformamide; ether-based solvents, such as tetrahydrofuran; and cellosolve-based solvents. The above-listed examples may be used alone or in combination.

A concentration of the organic solvent in the aqueous medium is not particularly limited. The concentration of the organic solvent is preferably a saturation concentration or lower relative to ion-exchanged water in view of granularity of particles.

In order to suitably perform emulsification with the core layer-forming oil phase, a surfactant may be added to the core layer-forming aqueous phase. The surfactant is not particularly limited, and may be appropriately selected depending on the intended purpose. Examples of the surfactant include anionic surfactants, cationic surfactants, nonionic surfactants, and amphoteric surfactants. The above-listed examples may be used alone or in combination. Among the above-listed examples, an anionic surfactant is preferably added.

The anionic surfactant is not particularly limited, and may be appropriately selected according to the intended purpose. Examples of the anionic surfactant include alkyl sulfuric acid salts, alkyl sulfonic acid salts, alkylbenzene sulfonic acid salts, and α-olefin sulfonic acid salts. The above-listed examples may be used alone or in combination.

### <(b) Core Layer-Forming Oil-In-Water Dispersion Liquid Preparation Step>

The (b) core layer-forming oil-in-water dispersion liquid preparation step includes adding an aqueous phase, preferably the core layer-forming aqueous phase, to the core layer-forming oil phase to cause phase inversion from a water-in-oil dispersion liquid to a core layer-forming oil-in-water dispersion liquid. As a result, a particle dispersion liquid including dispersed particles (oil droplets) is obtained.

In the core layer-forming oil-in-water dispersion liquid preparation step, after neutralizing the core layer-forming oil phase with a neutralizing agent, the neutralized core layer-forming oil phase is preferably added to the core layer-forming aqueous phase to perform phase inversion emulsification inverting from a water-in-oil dispersion liquid (water-in-oil emulsion) to an oil-in-water dispersion liquid (oil-in-water emulsion) to obtain a dispersion liquid of particles (particle dispersion liquid).

The neutralizing agent is not particularly limited, and may be appropriately selected depending on the intended purpose. Examples of the neutralizing agent include basic inorganic compounds and basic organic compounds. The above-listed examples may be used alone or in combination.

Examples of the basic inorganic compounds include sodium hydroxide, potassium hydroxide, lithium hydroxide, ammonia, sodium carbonate, sodium bicarbonate, potassium carbonate, and potassium bicarbonate.

Examples of the basic organic compounds include N, N-dimethylethanolamine, N, N-diethylethanolamine, triethanolamine, tripropanolamine, tributanolamine, triethylamine, n-propylamine, n-butylamine, isopropylamine, monomethanolamine, morpholine, methoxypropylamine, pyridine, vinyl pyridine, and isophoronediamine.

The neutralization may be carried out while homogeneously mixing and dispersing using a typical stirrer or a disperser.

The stirrer or disperser is not particularly limited. Examples of the stirrer or disperser include ultrasonic dispersers, bead mills, ball mills, roll mills, homomixers, ultramixers, disperse mixers, penetration-type high-pressure dispersers, collision-type high-pressure dispersers, porous-type high-pressure dispersers, ultrahigh-pressure homogenizers, and ultrasonic homogenizers. A typical stirrer and a typical disperser may be used in combination.

An amount of the aqueous medium used for the phase inversion emulsification of the oil phase including the constituent materials of the core layer is not particularly limited, and may be appropriately selected according to the intended purpose. The amount of the aqueous medium is preferably 50 parts by mass or greater and 2, 000 parts by mass or less, more preferably 100 parts by mass or greater and 1,000 parts by mass or less, relative to 100 parts by mass of the constituent materials of the core layer. When the amount of the aqueous medium is 50 parts by mass or greater relative to 100 parts by mass of the constituent materials of the core layer, a desired dispersion state of the constituent materials of the core layer is achieved to obtain resin particles having the predetermined particle diameter. When the amount of the aqueous medium is 2,000 parts by mass or less relative to 100 parts by mass of the constituent materials of the core layer, the production cost remains the minimum.

When the core layer-forming aqueous phase is added to perform phase inversion emulsification, the phase inversion emulsification may be performed while homogeneously mixing and dispersing using a typical stirrer or a disperser.

The stirrer or disperser is not particularly limited. Examples of the stirrer or disperser include ultrasonic dispersers, bead mills, ball mills, roll mills, homomixers, ultramixers, disperse mixers, penetration-type high-pressure dispersers, collision-type high-pressure dispersers, porous-type high-pressure dispersers, ultrahigh-pressure homogenizers, and ultrasonic homogenizers. A typical stirrer and a typical disperser may be used in combination.

A particle diameter of the oil droplets dispersed in the core layer-forming oil-in-water dispersion liquid is not particularly limited, and may be appropriately selected depending on the intended purpose. The particle diameter of the oil droplets is preferably 50 nm or greater and 2,000 nm or less, more preferably 50 nm or greater and 500 nm or less.

In the present specification, the particle diameter of the oil droplets dispersed in the core layer-forming oil-in-water dispersion liquid is the volume average particle diameter.

The particle diameter of the oil droplets dispersed in the core layer-forming oil-in-water dispersion liquid can be measured by a particle size distribution analyzer, Nanotrac (UPA-EX150, available from NIKKISO CO., LTD., dynamic light scattering/laser doppler velocimetry).

### <(c) Shell Layer-Forming Oil Phase Preparation Step>

The (c) shell layer-forming oil phase preparation step includes dissolving or dispersing at least an amorphous polyester resin including a sulfonic acid salt group-containing polyester resin in an organic solvent to prepare a shell layer-forming oil phase. As a result, a particle dispersion liquid including dispersed particles (oil droplets) is obtained.

The sulfonic acid salt group-containing polyester resin and the amorphous polyester resin are as described in the section of «Sulfonic acid salt group-containing polyester resin» of <Amorphous polyester resins> of (Resin particles).

In the shell layer-forming oil phase preparation step, first, at least the amorphous polyester resin including the sulfonic acid salt group-containing polyester resin is dispersed or dissolved in an organic solvent to prepare an oil phase.

The organic solvent is not particularly limited, and the same organic solvent used in the core layer-forming oil phase preparation step may be used. An amount of the organic solvent may be the same as in the core layer-forming oil phase preparation step.

A method for producing the shell layer-forming oil phase is not particularly limited, and may be appropriately selected. Examples of the method include a method where constituent materials of the shell layer, such as the amorphous polyester resin including the sulfonic acid salt group-containing polyester resin, are gradually added to an organic solvent, while stirring, to dissolve or disperse the constituent materials in the organic solvent.

For the dispersing, any of dispersers available in the related art may be used. For example, a disperser, such as a bead mill and a disk mill, may be used.

### <Shell Layer-Forming Aqueous Phase Preparation Step>

The shell layer-forming aqueous phase preparation step includes preparation of an aqueous phase (aqueous medium).

The aqueous medium is not particularly limited, and may be appropriately selected depending on the intended purpose. Examples of the aqueous medium include water, solvents miscible with water, and mixtures of the foregoing media. The above-listed examples may be used alone or in combination. Among the above-listed examples, water is preferred.

As the aqueous medium, the same aqueous medium used in the core layer-forming aqueous phase may be used.

### <(d) Shell Layer-Forming Oil-In-Water Dispersion Liquid Preparation Step>

The (d) shell layer-forming oil-in-water dispersion liquid preparation step includes adding an aqueous phase to the shell layer-forming oil phase to cause phase inversion from a water-in-oil dispersion liquid to a shell layer-forming oil-in-water dispersion liquid. As a result, a particle dispersion liquid including dispersed particles (oil droplets) is obtained.

An amount of the aqueous medium used for the phase inversion emulsification of the oil phase including the constituent materials of the shell layer is not particularly limited, and may be appropriately selected according to the intended purpose. The amount of the aqueous medium is preferably 50 parts by mass or greater and 2,000 parts by mass or less, more preferably 100 parts by mass or greater and 1,000 parts by mass or less, relative to 100 parts by mass of the constituent materials of the shell layer. When the amount of the aqueous medium is 50 parts by mass or greater relative to 100 parts by mass of the constituent materials of the shell layer, a desired dispersion state of the constituent materials of the shell layer is achieved to obtain resin particles having the predetermined particle diameter. When the amount of the aqueous medium is 2, 000 parts by mass or less relative to 100 parts by mass of the constituent materials of the shell layer, the production cost remains the minimum.

When the shell layer-forming aqueous phase is added to perform phase inversion emulsification, the phase inversion emulsification is preferably performed while homogeneously mixing and dispersing using a typical stirrer or a disperser.

The stirrer or disperser is not particularly limited. Examples of the stirrer or disperser include ultrasonic dispersers, bead mills, ball mills, roll mills, homomixers, ultramixers, disperse mixers, penetration-type high-pressure dispersers, collision-type high-pressure dispersers, porous-type high-pressure dispersers, ultrahigh-pressure homogenizers, and ultrasonic homogenizers. A typical stirrer and a typical disperser may be used in combination.

A particle diameter of the oil droplets dispersed in the shell layer-forming oil-in-water dispersion liquid is not particularly limited, and may be appropriately selected depending on the intended purpose. The particle diameter is preferably 4 nm or greater and 1,000 nm or less, more preferably 4 nm or greater and 600 nm or less.

In the present specification, the particle diameter of the oil droplets dispersed in the shell layer-forming oil-in-water dispersion liquid is the volume average particle diameter.

### <Solvent Removing Step>

The solvent removing step includes removal of the organic solvent from the core layer-forming oil-in-water dispersion liquid obtained in the (b) or the shell layer-forming oil-in-water dispersion liquid obtained in the (d).

Examples of a method for removing the organic solvent from the core layer-forming oil-in-water dispersion liquid obtained in the (b) or the shell layer-forming oil-in-water dispersion liquid obtained in the (d) include the following four methods:
(1) a method where an entire reaction system is gradually heated, while stirring, to completely evaporate the organic solvent in the oil droplets;
(2) a method where the obtained particle dispersion liquid is sprayed in a dry atmosphere, while stirring, to completely remove the organic solvent in the oil droplets;
(3) a method where the pressure of the core layer-forming oil-in-water dispersion liquid or the shell layer-forming oil-in-water dispersion liquid is reduced to evaporate and remove the organic solvent; and
(4) a method where a gas is blown into the core layer-forming oil-in-water dispersion liquid or the shell layer-forming oil-in-water dispersion liquid, while stirring, to evaporate and remove the organic solvent.

The method of (2), (3), or (4) may be used in combination with the method of (1).

In the method of (2), the dry atmosphere into which the core layer-forming oil-in-water dispersion liquid or the shell layer-forming oil-in-water dispersion liquid is sprayed is not particularly limited. Examples of the dry atmosphere includes heated gases, such as air, nitrogen, carbon dioxide, and a combustion gas. Among the above-listed examples, any of various gas flows, which is heated to a temperature equal to or higher than the highest boiling point among boiling points of the solvents used, is preferred.

As a method for spraying, for example, use of a spray drier, a belt drier, or a rotary kiln can sufficiently achieve the desired quality within a short process time.

In the method of (4), the blowing gas is not particularly limited. Examples of the gas include heated gases, such as air, nitrogen, carbon dioxide, and a combustion gas.

### <(e) Aggregating Step>

The (e) aggregating step includes aggregation of particles in the core layer-forming oil-in-water dispersion liquid obtained in the (b) to form aggregated particles.

The aggregating step may further include addition of the crystalline polyester resin.

When the method for producing resin particles includes the solvent removing step, the aggregating step may include aggregation of base particles obtained in the solvent removing step to form aggregated particles. The base particles are formed by removing the organic solvent from the core layer-forming oil-in-water dispersion liquid obtained in the (b).

In the aggregating step, first, particles (oil droplets or base particles) are aggregated to the predetermined diameter, while stirring the core layer-forming oil-in-water dispersion liquid obtained in (b).

A method for aggregating the oil droplets or the base particles is not particularly limited, and may be appropriately selected from methods available in the related art according to the intended purpose. Examples of the method include a method of adding an aggregating agent and a method of adjusting pH.

The aggregating agent is not particularly limited and may be appropriately selected from aggregating agents available in the related art. Examples of the aggregating agent include: metal salts of monovalent metals, such as sodium and potassium; metal salts of divalent metals, such as calcium and magnesium; and metal salts of trivalent metals, such as iron and aluminum. The above-listed examples may be used alone or in combination.

When the aggregating agent is added, the aggregating agent may be added as it is, but the aggregating agent is preferably added as an aqueous solution of the aggregating agent because the aggregating agent can be distributed evenly without leaving highly concentrated areas. Moreover, the aggregating agent (e.g., the metal salt) is preferably added gradually while carefully monitoring the diameters of the aggregated color particles.

A temperature of the reaction system for carrying out the aggregating step (a temperature of the particle dispersion liquid during aggregating) is not particularly limited, and may be appropriately selected according to the intended purpose. The temperature is preferably a temperature close to a glass transition temperature (Tg) of the amorphous polyester resin. When the temperature is too low, aggregation progresses very slowly, which may lead to inadequate production efficiency. When the temperature is too high, the aggregation speed is too fast, which may cause formation of aggregated particles having an undesirable particle size distribution, such as formation of coarse particles.

The aggregating step includes termination of the aggregation after the aggregated particles reach the predetermined particle diameters.

A method for terminating the aggregation is not particularly limited, and may be appropriately selected according to the intended purpose. Examples of the method include: a method where a salt having an ionic valence lower than the ionic valence of the aggregating agent (e.g., the metal salt) or a chelating agent is added; a method where pH is adjusted; a method where a temperature of the reaction system (particle dispersion liquid) during the aggregation is reduced; and a method where a large amount of the aqueous medium is added to reduce a concentration of the reaction system (particle dispersion liquid) during the aggregation. The above-listed examples may be used alone or in combination.

A volume average particle diameter of the aggregated particles is not particularly limited, and may be appropriately selected depending on the intended purpose. The volume average particle diameter of the aggregated particles is preferably from 3.0 μm to 6.0 μm, more preferably from 4.0 μm to 5.5 μm.

In the aggregating step, the release agent may be added, or the crystalline polyester resin may be added for imparting low-temperature fixability.

When the release agent or the crystalline resin is added during the aggregating step, a dispersion liquid, in which the release agent is dispersed in an aqueous medium, or a dispersion liquid, in which the crystalline polyester resin is dispersed in an aqueous medium, is prepared, the prepared dispersion liquid of the release agent or the crystalline polyester resin is mixed with the particle (oil droplet) dispersion liquid, followed by aggregating the particles, to obtain aggregated particles in each of which the release agent or the crystalline polyester resin is homogeneously dispersed.

The diameter of dispersed particles of the release agent in the dispersion liquid and the diameter of the dispersed particles of the crystalline polyester resin in the dispersion liquid may be adjusted in a similar manner to the diameter of dispersed particles of the release agent and the particle of the dispersed particles of the crystalline polyester resin in the core layer-forming oil phase preparation step.

### <(f) Shell Forming Step>

The (f) shell forming step includes adding the shell layer-forming oil-in-water dispersion liquid obtained in the (d) to the aggregated particles obtained in the (e) to form resin particles. As a result, a shell layer that includes the amorphous polyester resin including the sulfonic acid salt group-containing polyester resin can be formed on a surface of each of the aggregated particles obtained in the (e), preferably on a surface of each of spherical particles obtained in the below-described fusing step.

A method for forming the shell layer is not particularly limited, and may be appropriately selected depending on the intended purpose. Examples of the method include, after forming the aggregated particles in the (e), preferably spherical particles in the below-described fusing step, the shell layer-forming oil-in-water dispersion liquid that includes the amorphous polyester resin including the sulfonic acid salt group-containing polyester resin obtained in the (d) is added, and the aggregating step and the fusing step are repeated to form a shell layer.

### <Fusing Step>

The fusing step includes a heat treatment performed on the aggregated particles obtained in the aggregating step to fuse and reduce surface irregularities of the aggregated particles. As a result, the aggregated particles are transformed into spherical particles having the predetermined circularity.

Examples of a method for performing the fusing step include a method where the dispersion liquid of the aggregated particles is heated while stirring the dispersion liquid.

The heating temperature is not particularly limited, except that each of the aggregated particles can be fused. The heating temperature may be appropriately selected depending on the intended purpose. The temperature of the system (liquid) including the aggregated particles is preferably close to a temperature greater than a glass transition temperature (Tg) of the amorphous polyester resin A. Specifically, the heating temperature is preferably equal to or higher than Tg of the amorphous polyester resin A and equal to or lower than Tg±20° C. or less, more preferably equal to or higher than Tg and equal to or lower than Tg±10° C.

A method for terminating the fusing is not particularly limited. The method is preferably a method where the temperature is reduced to a temperature at which the aggregated particles are not fused.

### <Washing Step>

The washing step includes washing of the resin particles obtained in the shell forming step, preferably the resin particles obtained in the fusing step or the annealing step.

The dispersion liquid of the resin particles obtained in the above-described manner may include subsidiary materials, such as the aggregating agent, in addition to the resin particles. Therefore, washing is preferably performed to collect only the resin particles from the dispersion liquid of the resin particles.

A method for washing the resin particles is not particularly limited. Examples of the method include centrifugation, filtration under reduced pressure (vacuum filtration), and filter pressing. A cake of the resin particles may be obtained by any of the above-mentioned washing methods. If washing cannot be adequately performed with one process, the obtained cake may be again dispersed in an aqueous solvent to prepare slurry, and the slurry may be washed by any of the washing methods to collect the resin particles. This series of the processes may be repeated. When the washing is performed by the vacuum filtration or the filter pressing, an aqueous solvent is passed through the cake to wash out subsidiary materials attached to the resin particles. The solvent used for washing the resin particles is not particularly limited, and may be appropriately selected depending on the intended purpose. The solvent is preferably an aqueous solvent.

Examples of the aqueous solvent include water, and a mixed solvent of water and an alcohol.

Examples of the alcohol include methanol and ethanol.

Among the above-listed examples, the aqueous solvent is preferably water in view of the production cost and reduction in adverse environmental impacts due to waste water processing.

### <Drying Step>

The drying step includes drying of the resin particles obtained in the washing step.

The resin particles washed in the washing step may include a large amount of the aqueous medium. As the drying is performed to remove the aqueous medium in the drying step, only the resin particles can be collected.

A method for drying is not particularly limited, and may be appropriately selected according to the intended purpose. Examples of the method include a method using a dryer, such as a spray dryer, a vacuum freeze dryer, a vacuum dryer, a static tray dryer, a movable tray dryer, a fluidized bed dryer, a rotary dryer, and a stirring dryer.

The final moisture content of the dried resin particles is not particularly limited, and may be appropriately selected according to the intended purpose. The moisture content is preferably less than 1% by mass.

The resin particles dried in the drying step are loosely aggregated. If the aggregation of the resin particles may cause a problem during use, the loosely aggregated resin particles may be crushed to release loose aggregation.

A method for crushing is not particularly limited, and may be appropriately selected according to the intended purpose. Examples of the method include a method using a device, such as a jet mill, HENSCHEL MIXER, a super mixer, a coffee mill, OSTER BLENDER, and a food processor.

### <Annealing Step>

The annealing step includes increasing of crystallinity of the crystalline polyester resin to cause phase separation between the crystalline polyester resin and the amorphous polyester resin A.

The annealing step is preferably performed after the drying step.

A method for performing the annealing is not particularly limited, and may be appropriately selected from methods available in the related art. Examples of the method include a method of heating. In the case where the crystalline polyester resin is added, as annealing is performed after the drying step, phase separation between the amorphous polyester resin A and the crystalline polyester resin occurs so that fixability of resulting resin particles is improved.

The heating temperature is not particularly limited, and may be appropriately selected according to a composition of the crystalline polyester resin. The heating is preferably performed by storing the resin particles at a temperature close to a glass transition temperature (Tg) of the crystalline polyester resin for 10 hours or longer.

When heating is performed at a temperature higher than glass transition temperatures (Tg) of the used resins in the fusing step, the crystalline polyester resin and the amorphous polyester resin A may be melted together to form a co-melted state (compatible state). As the annealing is performed, however, phase separation between the crystalline resin and the amorphous polyester resin A occurs to eliminate the co-melted state. Therefore, the annealing is preferably performed.

### (Toner)

The toner of the present disclosure includes the resin particles of the present disclosure, preferably further includes one or more external additives, and may further include other components, as necessary.

### <Resin Particles>

The resin particles are as described in the section of (Resin particles), thus the detailed description is omitted. In the toner, the resin particles function as toner base particles. An amount of the resin particles in the toner is not particularly limited, and may be appropriately selected according to the intended purpose. The toner may be composed of only the resin particles.

<External Additive (s)>

The one or more external additives are not particularly limited, and may be appropriately selected according to the intended purpose. Examples of the external additives include inorganic particles and polymer particles. The above-listed examples may be used alone or in combination.

Examples of the inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. The above-listed examples may be used alone or in combination.

A diameter of a primary particle of the inorganic particles is not particularly limited, and may be appropriately selected depending on the intended purpose. The primary particle diameter is preferably from 5 nm to 2 μm, more preferably from 5 nm to 500 nm.

A BET specific surface area of the inorganic particles is not particularly limited, and may be appropriately selected depending on the intended purpose. The BET specific surface area is preferably from 20 m²/g to 500 m²/g.

Examples of the polymer particles include: polymer particles of polystyrene, methacrylic acid ester copolymers or acrylic acid ester copolymers obtained by soap-free emulsion polymerization, suspension polymerization, or dispersion polymerization; polymer particles of polycondensation polymers, such as silicone, benzoguanamine, and nylon; and polymer particles of thermoset resins.

The external additives may be subjected to a surface treatment to increase hydrophobicity to achieve desired flowability and charging characteristics even in high humidity conditions

A surface treating agent used for the surface treatment is not particularly limited, and may be appropriately selected depending on the intended purpose. Examples of the surface treating agent include silane coupling agents, silylating agents, fluoroalkyl group-containing silane coupling agents, organic titanate-based coupling agents, aluminum-based coupling agents, silicone oil, and modified silicone oil.

An amount of the one or more external additives is not particularly limited, and may be appropriately selected depending on the intended purpose. The amount of the one or more external additives is preferably from 0.01% by mass to 5% by mass relative to a total amount of the resin particles.

### <Other Components>

The above-mentioned other components in the toner are not particularly limited, except that the components can be used for a toner. The above-mentioned other components may be appropriately selected depending on the intended purpose.

An amount of the above-mentioned other components is not particularly limited, and may be appropriately selected according to the intended purpose.

Since the toner includes the resin particles, the toner excels in all of low-temperature fixability, adhesion, charging characteristics, and heat-resistant storage stability.

A method for producing the toner is not particularly limited, and may be appropriately selected from methods available in the related art. Examples of the method include a method where the resin particles serving as toner base particles and the one or more external additives are mixed. During the mixing, mechanical impacts are preferably applied so that detachment of the one or more external additives from surfaces of the toner base particles can be minimized.

A method for applying the mechanical impacts is not particularly limited, and may be appropriately selected according to the intended purpose. Examples of the method include: a method where an impact force is applied to the mixture of the resin particles and the one or more external additives using a blade rotated at high speed; a method where the mixture of the resin particles and the one or more external additives is added to a high-speed air flow to accelerate the motion of the particles to make the particles collide with one another or to make the particles collide with a suitable impact board.

A device used for the mixing is not particularly limited, and may be appropriately selected depending on the intended purpose. Examples of the device include Angmill (available from HOSOKAWA MICRON CORPORATION), an I-type mill (available from Nippon Pneumatic Mfg. Co., Ltd.), devices obtained by modifying the foregoing devices to reduce pulverization air pressure, a hybridization system (available from NARA MACHINERY CO., LTD.), Kryptron System (available from Kawasaki Heavy Industries, Ltd.), and automatic mortars.

### (Developer)

The developer of the present disclosure includes at least the toner of the present disclosure, and may further include appropriately selected other components, such as a carrier, as necessary.

Since the toner included in the developer of the present disclosure includes the resin particles of the present disclosure, the developer excels in all of low-temperature fixability, adhesion, charging characteristics, and heat-resistant storage stability so that high quality images are stably formed using the developer of the present disclosure.

The developer may be a one-component developer or two-component developer. In a case where the developer is used for high-speed printers corresponding to information processing speed that has been improved in recent years, the developer is preferably a two-component developer considering improvement in a service life of the developer.

In a case where the developer is used as a one-component developer without including a carrier, diameters of the toner resin particles do not noticeably vary even after replenishing the toner. Therefore, filming of the toner to a developing roller is minimized, or fusion of the toner to a member used for leveling the toner into a thin layer, such as a blade, is minimized. As a result, excellent and stable developing performance and formation of excellent images are achieved even after stirring the developer in a developing device over a long period.

In a case where the developer is used as a two-component developer, diameters of the toner resin particles do not noticeably vary even after performing replenishment of the toner over a long period, and excellent and stable developing performance and formation of excellent images are achieved even after stirring the developer in a developing device over a long period.

### <Carrier>

The carrier is not particularly limited, and may be appropriately selected according to the intended purpose. The carrier preferably includes carrier particles, each including a core particle and a resin layer covering the core particle.

### «Core Particles»

A material of the core particles is not particularly limited, and may be appropriately selected according to the intended purpose. Examples of the material include manganese-strontium-based materials of from 50 emu/g to 90 emu/g and manganese-magnesium-based materials of from 50 emu/g to 90 emu/g. To achieve adequate image density, a hard-magnetic material, such as iron powder of 100 emu/g or greater and magnetite of from 75 emu/g to 120 emu/g, is preferably used. Moreover, a soft-magnetic material, such as a copper-zinc-based magnetic material of from 30 emu/g to 80 emu/g, is preferably used because an impact of the developer constituting a magnetic brush can be reduced against the photoconductor, and a high image quality can be achieved.

The above-listed examples may be used alone or in combination.

A volume average particle diameter of the core particles is not particularly limited, and may be appropriately selected according to the intended purpose. The volume average particle diameter of the core particles is preferably 10 μm or greater and 150 μm or less, more preferably 40 μm or greater and 100 μm or less. When the volume average particle diameter of the core particles is 10 μm or greater, a proportion of fine particles to the entire amount of the core particles decreases, and the decreased proportion of the fine particles leads to improvement in magnetization per particle, consequently minimizing carrier scattering. When the volume average particle diameter of the core particles is 150 μm or less, a resulting carrier has a sufficient specific surface area to securely carry a toner without causing toner scattering, so that excellent reproducibility of a solid image, especially a full-color solid image having a large solid image area, can be achieved.

When the toner is used for a two-component developer, the toner is mixed with the carrier. An amount of the carrier in the two-component developer is not particularly limited, and may be appropriately selected according to the intended purpose. The amount of the carrier is preferably 90 parts by mass or greater and 98 parts by mass or less, more preferably 93 parts by mass or greater and 97 parts by mass or less, relative to 100 parts by mass of the two-component developer.

The developer is suitably used for image formation according to various electrophotographic methods known in the art, such as a magnetic one-component developing method, a non-magnetic one-component developing method, and a two-component developing method.

(Image forming apparatus and image forming method) The image forming apparatus of the present disclosure includes an electrostatic latent image bearer, an electrostatic latent image forming mechanism configured to form an electrostatic latent image on the electrostatic latent image bearer, and a developing device configured to develop the electrostatic latent image formed on the electrostatic latent image bearer with the toner to form a visible image. The image forming apparatus may further include other devices or members, as necessary.

The image forming method of the present disclosure includes formation of an electrostatic latent image on an electrostatic latent image bearer (an electrostatic latent image forming step), and development of the electrostatic latent image formed on the electrostatic latent image bearer with the toner of the present disclosure to form a visible image (a developing step). The image forming method may further include other steps.

The image forming method is suitably performed by the image forming apparatus. The electrostatic latent image forming step is suitably performed by the electrostatic latent image forming mechanism. The developing step is suitably performed by the developing device. The above-mentioned other steps are suitably performed by the above-mentioned other devices or members.

### <Electrostatic Latent Image Bearer>

A material, structure, and size of the electrostatic latent image bearer (may be referred to as a “photoconductor” hereinafter) are not particularly limited, and may be appropriately selected from materials, structures, and sizes available in the related art.

Examples of the material of the electrostatic latent image bearer include inorganic photoconductors and organic photoconductors. Examples of the inorganic photoconductor include amorphous silicon and selenium.

Examples of the organic photoconductor include a laminate photoconductor having a laminate structure where a layer in which a charge-generating material (e.g., metal-free phthalocyanine and titanyl phthalocyanine) is dispersed in a binder resin (charge-generating layer) and a layer in which a charge-transporting material is dispersed in a binder resin (charge-transporting layer) are laminated on a support (e.g., aluminum drum), and a single-layer photoconductor including a support and a photoconductor layer on the support, where the photoconductor layer has a single layer structure in which both a charge-generating material and a charge-transporting material are dispersed in a binder resin. In the single-layer photoconductor, a hole-transporting material and an electron-transporting material may be added to the photoconductor layer as the charge-transporting material. Moreover, an undercoating layer may be disposed between the support and the charge-generating layer of the laminate photoconductor or the photoconductor layer of the single layer photoconductor.

A shape of the electrostatic latent image bearer is not particularly limited, and may be appropriately selected according to the intended purpose. The electrostatic latent image bearer preferably a cylindrical shape.

An outer diameter of the cylindrical electrostatic latent image bearer is not particularly limited, and may be appropriately selected according to the intended purpose. The outer diameter is preferably 3 mm or greater and 100 mm or less, more preferably 5 mm or greater and 50 mm or less, and particularly preferably 10 mm or greater and 30 mm or less.

### <Electrostatic Latent Image Forming Mechanism and Electrostatic Latent Image Forming Step>

The electrostatic latent image forming mechanism is a unit configured to form an electrostatic latent image on the electrostatic latent image bearer.

The electrostatic latent image forming step is a step including formation of an electrostatic latent image on the electrostatic latent image bearer.

The electrostatic latent image forming step is suitably performed by the electrostatic latent image forming mechanism.

The electrostatic latent image forming mechanism is not particularly limited, and may be appropriately selected according to the intended purpose. Examples of the electrostatic latent image forming mechanism include a unit including at least a charger configured to charge a surface of the electrostatic latent image bearer and an exposure device configured to expose the charged surface of the electrostatic latent image bearer to light corresponding to an image to be formed.

The electrostatic latent image forming step is not particularly limited, and may be appropriately selected according to the intended purpose. For example, the electrostatic latent image forming step includes charging of a surface of the electrostatic latent image bearer and exposure of the charged surface of the electrostatic latent image bearer with light corresponding to an image to be formed.

### «Charger and Charging»

The charger is not particularly limited, and may be appropriately selected from chargers available in the related art according to the intended purpose. Examples of the charger include: contact chargers; and non-contact chargers utilizing corona discharge, such as corotron, and scorotron.

The contact charger is preferably equipped with a conductor or semiconductor roller, brush, film, or rubber blade.

For example, the charging is performed by applying voltage to a surface of the electrostatic latent image bearer using the charger.

A shape of the charger may be any shape, such as a magnetic brush and a fur brush, as well as a roller. The form of the charger may be selected depending on specifications or an embodiment of the image forming apparatus.

The charger is not limited to the contact charger, but the contact charger is preferably used because an image forming apparatus using the contact charger discharges less ozone compared to an image forming apparatus using a non-contact charger.

### «Exposure Device and Exposure»

The exposure device is not particularly limited, as long as the exposure device can expose the surface of the electrostatic latent image bearer to light corresponding to an image to be formed. The exposure device may be appropriately selected according to the intended purpose. Examples of the exposure device include various exposure devices, such as copy optical exposure devices, rod lens array exposure devices, laser optical exposure devices, and liquid crystal shutter optical exposure devices.

A light source used in the exposure device is not particularly limited, and may be appropriately selected according to the intended purpose. Examples of the light source include general light emitters, such as fluorescent lamps, tungsten lamps, halogen lamps, mercury lamps, sodium vapor lamps, light emitting diodes (LED), semiconductor lasers (LD), and electroluminescent lights (EL).

For applying only light having a desired wavelength range, various filters, such as sharp-cut filters, band-pass filters, near infrared ray-cut filters, dichroic filters, interference filters, and color temperature conversion filters, may be used.

For example, the exposure can be performed by exposing the charged surface of the electrostatic latent image bearer to light corresponding to an image to be formed using the exposure device.

In the present disclosure, a back-exposure system may be employed. The back-exposure system is a system where the back side of the electrostatic latent image bearer is exposed to light corresponding to an image to be formed.

### <Developing Device and Developing Step>

The developing device is configured to develop the electrostatic latent image formed on the electrostatic latent image bearer with the toner to form a visible image.

The developing step includes developing the electrostatic latent image formed on the electrostatic latent image bearer with the toner to form a visible image.

The developing step is suitably performed by the developing device.

The developing device is not particularly limited, and may be appropriately selected according to the intended purpose. The developing device may employ a dry developing system or a wet developing system. Moreover, the developing device may be a developing device for a single color or a developing device for multiple colors. Among the above-listed examples, the developing device is preferably a developing device including a stirrer and a rotatable developer bearer, where the stirrer is configured to stir the toner to charge the toner with friction, and the developer bearer includes a magnetic field generator inside of the developer bearer and is configured to bear the toner on a surface of the developer bearer.

In the developing device, the toner and the carrier are mixed and stirred to charge the toner with friction, the charged toner is held on the rotating magnetic roller in the form of a brush to form a magnetic brush. The magnetic roller is disposed close to the electrostatic latent image bearer, thus part of the toner constituting the magnetic brush formed on the surface of the magnetic roller is moved onto a surface of the electrostatic latent image bearer by an electric suction force. As a result, the electrostatic latent image is developed with the toner to form a visible image formed of the toner on the surface of the electrostatic latent image bearer.

The carrier is not particularly limited, and may be appropriately selected according to the intended purpose. For example, the carrier described in the section of (Developer) may be used.

### <Other Devices or Members and Other Steps>

The above-mentioned other devices or members are not particularly limited, and may be appropriately selected according to the intended purpose. Examples of the above-mentioned other devices or members include a transferring member, a fixing device, a cleaner, a static charge eliminator, a recycling member, and a controller.

The above-mentioned other steps are not particularly limited, and may be appropriately selected according to the intended purpose. Examples of the above-mentioned other steps include a transferring step, a fixing step, a cleaning step, a static charge eliminating step, a recycling step, and a controlling step.

### «Transferring Member and Transferring Step»

The transferring member is configured to transfer the visible image formed by the developing device onto a recording medium.

The transferring step is a step including transfer of the visible image formed in the developing step onto a recording medium.

The transferring step is suitably performed by the transferring member.

The transferring member is not particularly limited, and may be appropriately selected according to the intended purpose. A preferred embodiment of the transferring member includes a primary transferring member and a secondary transferring member. The primary transferring member is configured to transfer the visible images onto an intermediate transfer member to form a composite transfer image. The secondary transferring member is configured to transfer the composite transfer image to a recording medium.

The transferring step is not particularly limited, and may be appropriately selected according to the intended purpose. A preferred embodiment of the transferring includes primary transfer of a visible image on an intermediate transfer member, followed by secondary transfer of the visible image onto a recording medium. Specifically, the transferring step may be performed, for example, by charging the photoconductor using a transfer charger to transfer the visible image, where the transferring step may be performed by the transferring member.

In a case where an image secondarily transferred onto the recording medium is a color image made up of two or more color-toners, single-color toners of different colors are sequentially superimposed on the intermediate transfer member by the transferring member to form images on the intermediate transfer member, and the images formed on the intermediate transfer member are collectively secondarily transferred onto the recording medium.

The intermediate transfer member is not particularly limited, and may be appropriately selected from transfer members know in the art according to the intended purpose. Suitable examples of the intermediate transfer member include a transfer belt.

The transferring member (the primary transferring member and the secondary transferring member) preferably includes at least a transfer member configured to charge and release the visible image formed on the photoconductor to the side of the recording medium.

The transfer member is not particularly limited, and may be appropriately selected according to the intended purpose. Examples of the transfer member include corona transfer chargers using corona discharge, transfer belts, transfer rollers, pressure transfer rollers, and adhesion transfer members.

The recording medium is typically plain paper. The recording medium is not particularly limited, except that an unfixed image before fixing can be transferred onto the recording medium. The recording medium may be appropriately selected according to the intended purpose. A PET base for an overhead projector (OHP) may be used also used as the recording medium.

### «Fixing Device and Fixing Step»

The fixing device is configured to fix the transferred toner image (visible image) on the recording medium.

The fixing step is a step including fixing of the transferred toner image (visible image) on the recording medium.

The fixing step is suitably performed by the fixing device.

The fixing device is not particularly limited, and may be appropriately selected according to the intended purpose. The fixing device is preferably any of heat-press members available in the related art.

The heat-press members are not particularly limited, and may be appropriately selected according to the intended purpose. Examples of the heat-press members include a combination of a heat roller and a press roller, and a combination of a heat roller, a press roller, and an endless belt.

In the present disclosure, for example, any of optical fixing devices available in the related art may be used in combination with or instead of the fixing device according to the intended purpose.

The fixing step is not particularly limited, and may be appropriately selected according to the intended purpose. For example, the fixing step may be performed every time an image of each color toner is transferred to the recording medium, or may be performed once after all images of color toners are superimposed on the recording medium.

A heating temperature of the heat-press member is not particularly limited, and may be appropriately selected according to the intended purpose. The heating temperature is preferably 80° C. or higher and 200° C. or lower.

A surface pressure applied during the fixing step is not particularly limited, and may be appropriately selected according to the intended purpose. The surface pressure is preferably 10 N/cm² or greater and 80 N/cm² or less.

### «Cleaner and Cleaning Step»

The cleaner is configured to remove the toner remaining on the photoconductor.

The cleaning step is a step including removal of the toner remaining on the photoconductor.

The cleaning step is suitably performed by the cleaner.

The cleaner is not particularly limited, and may be appropriately selected according to the intended purpose. Examples of the cleaner include magnetic brush cleaners, electrostatic brush cleaners, magnetic roller cleaners, blade cleaners, brush cleaners, and web cleaners.

### «Static Charge Eliminator and Static Charge Eliminating Step»

The static charge eliminator is a member configured to apply a static charge eliminating bias to the photoconductor to eliminate the charge of the photoconductor.

The static charge eliminating step includes application of a static charge eliminating bias to the photoconductor to eliminate the charge of the photoconductor.

The static charge eliminating step is suitably performed by the static charge eliminator.

The static charge eliminator is not particularly limited, and may be appropriately selected depending on the intended purpose. Examples of the static charge eliminator include static charge eliminating lamps.

### «Recycling Member and Recycle Step»

The recycling member is configured to transport the toner removed by the cleaner to the developing device to recycle the toner.

The recycling step is a step including transportation of the toner removed in the cleaning step to the developing device to recycle the toner.

The recycling step is suitably performed by the recycling member.

The recycling member is not particularly limited, and may be appropriately selected according to the intended purpose. Examples of the recycling member include transporting members available in the related art.

### «Controller and Controlling Step»

The controller is configured to control operation of each device or member.

The controlling step is a step including control of operation of each device or member in each step.

The controlling step is suitably performed by the controller.

The controller is not particularly limited, and may be appropriately selected according to the intended purpose. Examples of the controller include devices, such as sequencers and computers.

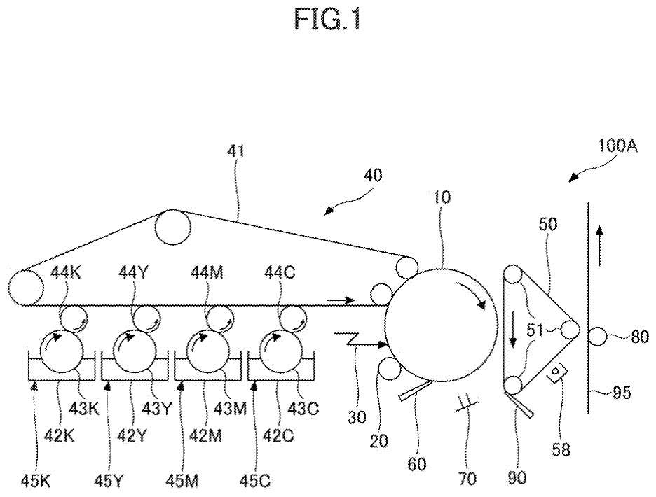

Next, embodiments of the image forming apparatus of the present disclosure and image forming method associated with the present disclosure will be described with reference to FIGS. 1 to 4.

The color image forming apparatus 100A illustrated in FIG. 1 includes a photoconductor drum 10 (may be referred to as a “photoconductor 10” hereinafter) serving as the electrostatic latent image bearer, a charging roller 20 serving as the charger, an exposure device 30 serving as the exposure device, a developing device 40 serving as the developing device, an intermediate transfer member 50, a cleaning device 60 serving as the cleaner having a cleaning blade, and a static charge eliminating lamp 70 serving as the static charge eliminator.

The intermediate transfer member 50 is an endless belt. The intermediate transfer member 50 in the form of the endless belt is supported and driven in a direction indicated with the arrow in FIG. 1 by three rollers 51 disposed inside the loop of the endless belt. Part of the three rollers 51 may also function as a transfer bias roller capable of applying predetermined transfer bias (or primary transfer bias) to the intermediate transfer member 50. The cleaning device 90 including the cleaning blade is disposed closely to the intermediate transfer member 50. Moreover, the transfer roller 80 is disposed closely to the intermediate transfer member 50 in a manner that the transfer roller 80 faces the intermediate transfer member 50. The transfer roller 80 serves as the transferring member capable of applying transfer bias for transferring (or secondary transferring) the developed image (also referred to as the visible image or the toner image) to transfer paper 95 serving as the recording medium. The corona charger 58 configured to apply charge to the toner image on the intermediate transfer member 50 is disposed in a position at the periphery of the intermediate transfer member 50, where the position is located between a contact area between the photoconductor 10 and the intermediate transfer member 50, and the contact area between the intermediate transfer member 50 and the transfer paper 95 relative to the rotational direction of the intermediate transfer member 50.

The developing device 40 includes a developing belt 41 serving as the developer bearing member, and a black developing device 45K, a yellow developing device 45Y, a magenta developing device 45M, and a cyan developing device 45C, which are disposed in series at the periphery of the developing belt 41. The black developing device 45K includes a developer storage 42K, a developer supply roller 43K, and a developing roller 44K. The yellow developing device 45Y includes a developer storage 42Y, a developer supply roller 43Y, and a developing roller 44Y. The magenta developing device 45M includes a developer storage 42M, a developer supply roller 43M, and a developing roller 44M. The cyan developing device 45C includes a developer storage 42C, a developer supply roller 43C, and a developing roller 44C. Moreover, the developing belt 41 is an endless belt rotatably supported by two or more belt rollers. Part of the developing belt 41 comes into contact with the electrostatic latent image bearer 10.

In the color image forming apparatus 100A of FIG. 1, for example, the charging roller 20 uniformly charges a surface of the photoconductor drum 10. The exposure device 30 exposes the charged surface of the photoconductor drum 10 to light to correspond to an image to be formed, thus, forming an electrostatic latent image. The toner is supplied from the developing device 40 to develop the electrostatic latent image formed on the photoconductor drum 10, thus, forming a toner image. Voltage is applied from the roller 51 to the toner image to transfer (primary transfer) the toner image onto the intermediate transfer member 50, followed by transferring (secondary transferring) onto transfer paper 95. As a result, the transferred image is formed on the transfer paper 95. The residual toner on the photoconductor 10 is removed by the cleaning device 60. The residual charge of the photoconductor 10 is temporarily removed by the static charge eliminating lamp 70.

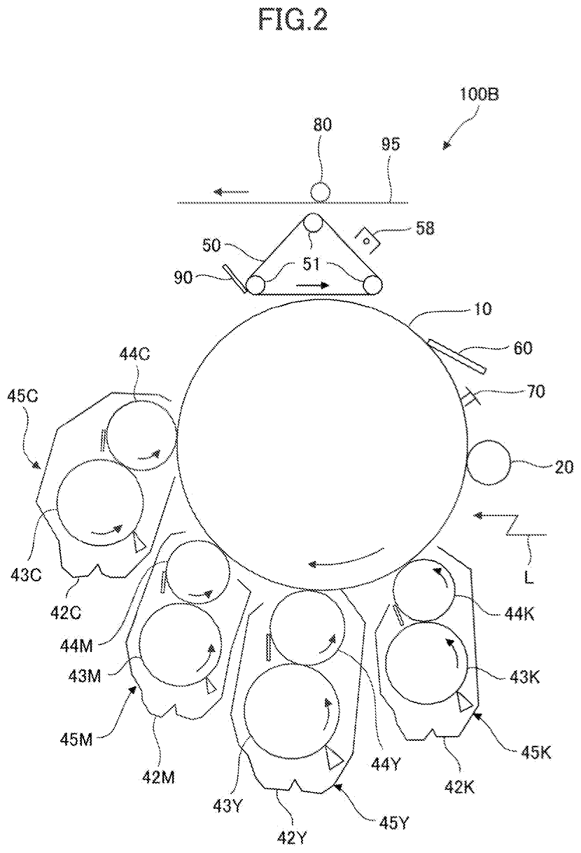

FIG. 2 illustrates another example of the image forming apparatus of the present disclosure. The image forming apparatus 100B has the structure identical to the structure of the image forming apparatus 100A of FIG. 1, except that the black developing device 45K, the yellow developing device 45Y, the magenta developing device 45M, and the cyan developing device 45C are disposed at the periphery of the photoconductor drum 10 to directly face the photoconductor drum 10 without disposing the developing belt 41.

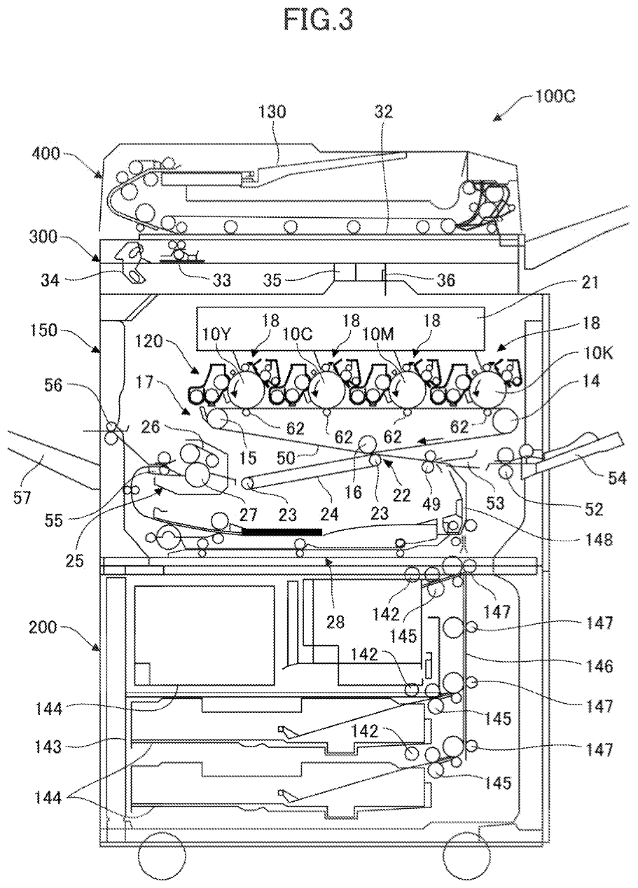

FIG. 3 illustrates yet another example of the image forming apparatus of the present disclosure. The image forming apparatus 100C of FIG. 3 includes a photocopier main body 150, a paper feeding table 200, a scanner 300, and an automatic document feeder (ADF) 400.

The photocopier main body 150 includes an intermediate transfer member 50 that is an endless belt. The intermediate transfer member 50 is disposed at a central part of the photocopier main body 150. The intermediate transfer member is rotatably supported by support rollers 14, 15, and 16 in the clockwise direction in FIG. 3. An intermediate transfer member cleaning device 17 is disposed closely to the support roller 15. The intermediate transfer member cleaning device 17 is configured to remove the residual toner on the intermediate transfer member 50. A tandem developing device 120 is disposed to face the section of the intermediate transfer member 50 supported by the support rollers 14 and 15. In the tandem developing device 120, four image forming mechanisms 18, i.e., a yellow image forming mechanism, a cyan image forming mechanism, a magenta image forming mechanism, and a black image forming mechanism, are arranged in series along the traveling direction of the intermediate transfer member 50. An exposure device 21 serving as the exposing device is disposed closely to the tandem developing device 120. A secondary transfer device 22 is disposed at the opposite side of the intermediate transfer member 50 to the side where the tandem developing device 120 is disposed. The secondary transfer device 22 includes a secondary transfer belt 24. The secondary transfer belt 24 is an endless belt and is supported by a pair of rollers 23. Transfer paper borne on and transported by the secondary transfer belt 24 comes into contact with the intermediate transfer member 50. A fixing device 25 serving as the fixing device is disposed closely to the secondary transfer device 22. The fixing device 25 includes a fixing belt 26, which is an endless belt, and a press roller 27 disposed to press against the fixing belt 26.

The tandem image forming apparatus includes a sheet reverser 28 disposed closely to the secondary transfer device 22 and to the fixing device 25. The sheet reverser 28 is configured to reverse transfer paper to perform image formation on both sides of the transfer paper.

Next, formation of a full-color image (a color copy) using the tandem developing device 120 will be described. First, a document is set on a document table 130 of the automatic document feeder (ADF) 400. Alternatively, a document is set on contact glass 32 of a scanner 300 by opening the automatic document feeder 400. Once the document is set, the automatic document feeder 400 is closed.

Once a start switch is pressed, if the document is set on the automatic document feeder 400, the document is transported onto the contact glass 32, and then the scanner 300 is driven. If the document is initially set on the contact glass 32, the scanner 300 is immediately driven once the start switch is pressed. Then, a first carriage 33 and a second carriage 34 are driven to scan the document. During the scanning, the first carriage 33 irradiates a surface of the document with light emitted from a light source, and the light reflected from the surface of the document is again reflected by a mirror of the second carriage 34 to pass the light through an imaging forming lens 35. The light is then received by a reading sensor 36 to read the color document (e.g., the color image) to acquire image information of black, yellow, magenta, and cyan.

The image information of each of black, yellow, magenta, and cyan is transmitted to the corresponding image forming mechanism 18 (the black image forming mechanism, the yellow image forming mechanism, the magenta image forming mechanism, or the cyan image forming mechanism) of the tandem developing device 120. By each image forming mechanism, a toner image of each color (black, yellow, magenta, or cyan) is formed.

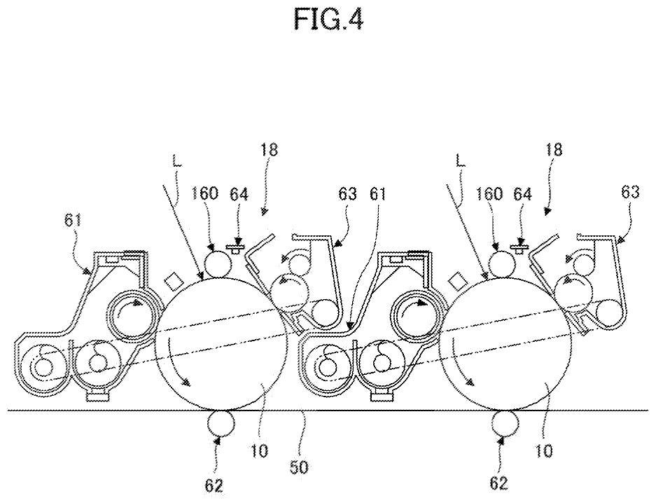

Specifically, as illustrated in FIG. 4, each image forming mechanism 18 (the black image forming mechanism, the yellow image forming mechanism, the magenta image forming mechanism, or the cyan image forming mechanism) of the tandem developing device 120 includes an electrostatic latent image bearer 10 (a black electrostatic latent image bearer 10K, a yellow electrostatic latent image bearer 10Y, a magenta electrostatic latent image bearer 10M, and a cyan electrostatic latent image bearer 10C), a charging device 160 that is the charger configured to uniformly charge a surface of the electrostatic latent image bearer 10, an exposing device configured to expose the electrostatic latent image bearer to light (L in FIG. 4) to correspond to each color image based on the corresponding color image information, to thereby form an electrostatic latent image on the electrostatic latent image bearer to correspond to each color image to be formed, a developing device 61 that is the developing device configured to develop the electrostatic latent image with the corresponding color toner (the black toner, the yellow toner, the magenta toner, or the cyan toner), to thereby form a toner image of the corresponding color toner, a transfer charger 62 configured to transfer the toner images onto an intermediate transfer member 50, a cleaning device 63, and a static charge eliminator 64.

Each image forming mechanism 18 can form an image of a single color (e.g., a black image, a yellow image, a magenta image, and a cyan image) based on the corresponding color image information. The black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C in the above-described manner are sequentially transferred (or primary transferred) onto the intermediate transfer member 50 that is rotatably supported by the support rollers 14, 15, and 16. The black image, the yellow image, the magenta image, and the cyan image are superimposed on the intermediate transfer member 50 to form a composite color image (a transferred color image).

While the toner images are formed in the above-described manner, in the paper feeding table 200, one of paper feeding rollers 142 is selectively driven to rotate to feed sheets (recording paper or recording media) from one of paper feeding cassettes 144 stacked in a paper bank 143. The sheets are separated one by one by a separation roller 145 to feed each sheet into a paper feeding path 146, and the fed sheet is transported by a transport roller 147 to guide the sheet into a paper feeding path 148 inside the photocopier main body 150. The sheet is then caused to collide with a registration roller 49 to stop. Alternatively, a paper feeding roller 142 is driven to rotate to feed sheets (recording paper or recording media) on a manual feed tray 54, and the sheets are separated and fed into a manual paper feeding path 53 one by one with a separation roller 52. Similarly, the fed sheet is caused to collide with a registration roller 49 to stop. The registration roller 49 is typically grounded during use, but the registration roller 49 may be used in the state where bias is applied to the registration roller 49 to remove paper dust from sheets. Synchronizing with the timing of the composite color image (the transferred color image) formed on the intermediate transfer member 50, the registration roller 49 is driven to rotate to feed the sheet (the recording paper or recording medium) between the intermediate transfer member 50 and the secondary transfer device 22. The composite color image (the transferred color image) is then transferred (or secondarily transferred) onto the sheet (the recording paper or recording medium) by the secondary transfer device 22. In the manner as described above, the color image is transferred and formed onto the sheet (the recording paper or recording medium). After transferring the image, the residual toner on the intermediate transfer member 50 is cleaned by the intermediate transfer member cleaning device 17.

The sheet (the recording paper or recording medium) on which the color image has been transferred is transported by the secondary transfer device 22 to send the sheet to the fixing device 25. Heat and pressure are applied to the composite color image (the transferred color image) by the fixing device 25 to fix the composite color image onto the sheet (the recording paper or recording medium). Thereafter, the traveling direction of the sheet (the recording paper) is switched by the switching claw 55 to eject the sheet (the recording paper or recording medium) with an ejection roller 56 to stack the sheet (the recording paper or recording medium) on the paper ejection tray 57. Alternatively, the traveling direction of the sheet (the recording paper or recording medium) is switched by the switching claw 55, and the sheet is flipped by the sheet reverser 28 and is returned to the transfer position. After forming an image also on the back side of the sheet, the sheet is ejected by the ejection roller 56 to stack on the paper ejection tray 57.

### (Toner Storage)

The toner storage of the present disclosure includes a storage configured to store a toner, and the toner stored in the storage.

The toner stored in the toner storage is the toner of the present disclosure. Moreover, the toner storage is mounted in the image forming apparatus of the present disclosure and image formation is performed by the image forming apparatus using the toner of the present disclosure. Therefore, low-temperature fixability, adhesion, charging characteristics, and heat-resistant storage stability are all achieved.

An embodiment of the toner storage is not particularly limited, as long as the toner storage can store the toner inside. The embodiment of the toner storage may be appropriately selected according to the intended purpose. Examples of the embodiment include toner storage containers, developing devices, and process cartridges.

### <Toner Storage Container>

The toner storage container is a container in which the toner is stored.

The toner storage container is not particularly limited, and may be appropriately selected from toner storage containers available in the related art. Examples of the toner storage container include a combination of a container main body and a cap.

A size of the container main body is not particularly limited, and may be appropriately adjusted.

A shape of the container main body is not particularly limited, and may be appropriately selected. The shape of the container main body is preferably a cylinder.

A structure of the container main body is not particularly limited, and may be appropriately selected. The container main body preferably has a structure where a groove is spirally formed along an inner circumferential surface of the container main body, and part of or the whole of the groove is pleated like a bellows. As the container main body having the above-described structure is rotated, the toner, which is the content of the container, moves towards an outlet of the container main body.

A material of the container main body is not particularly limited, and may be appropriately selected. The material of the container main body is preferably a material capable of achieving great precision in size. Examples of the material of the container main body include resin materials, such as polyester resins, polyethylene resins, polypropylene resins, polystyrene resins, polyvinyl chloride resins, polyacrylic acids, polycarbonate resins, ABS resins, and polyacetal resins. The above-listed examples may be used alone or in combination.

Since the toner storage container facilitates easy storage and transportation of the toner, and allows effortless handling, the toner storage container is detachably mounted in a process cartridge or an image forming apparatus, and is used for replenishing the toner.

### <Developing Device>

The developing device includes a developing device in which the toner is stored.

The developing device is not particularly limited, and may be appropriately selected according to the intended purpose. For example, the developing device includes at least the toner storage container, and a toner bearer configured to bear and transport the toner stored in the toner storage container.

The developing device may further include a regulating member configured to regulate a thickness of a layer of the toner borne on the toner bearer.

### <Process Cartridge>

The process cartridge includes an electrostatic latent image bearer and a developing device as an integrated unit, stores the toner inside, and is detachably mounted in an image forming apparatus. The process cartridge may further include at least one selected from the group consisting of a charger, an exposure device, a cleaner, and a static charge eliminator, as necessary.

As an example of the process cartridge, suitably used is a process cartridge that is configured such that the process cartridge is detachably mounted in various image forming apparatuses, and includes at least an electrostatic latent image bearer and a developing device, where the electrostatic latent image bearer is configured to bear an electrostatic latent image thereon, and the developing device is configured to develop the electrostatic latent image borne on the electrostatic latent image bearer with the toner to form a toner image. The process cartridge may further include other units, as necessary.

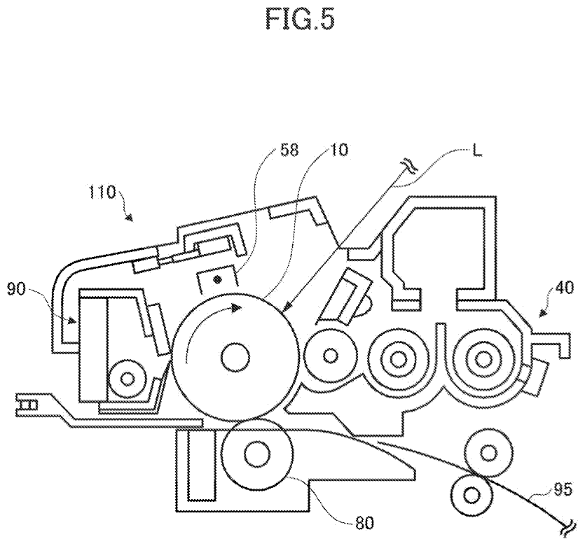

Next, an embodiment of the process cartridge is illustrated in FIG. 5. As illustrated in FIG. 5, the process cartridge 110 of the present disclosure includes an electrostatic latent image bearer 10, which is mounted inside the process cartridge 110. The process cartridge 110 further includes a charger 58 serving as the charger, a developing device 40 serving as the developing device, and a cleaning device 90 serving as the cleaner, and may further include other units, as necessary. In FIG. 5, the reference L denotes exposure light emitted from an exposing device (not illustrated) and the numerical reference 95 denotes recording paper (a recording medium).

As the electrostatic latent image bearer 10, an electrostatic latent image bearer identical to the electrostatic latent image bearer in the above-described image forming apparatus may be used. Moreover, an appropriately selected charger may be used as the charger 58.

According to an image forming process performed by the process cartridge illustrated in FIG. 5, an image is formed in the following manner. The electrostatic latent image bearer 10 is charged by the charger 58 while rotating the electrostatic latent image bearer 10 in the direction indicated with the arrow, and the charged surface of the electrostatic latent image bearer 10 is exposed to exposure light L emitted by the exposure device to form an electrostatic latent image corresponding to the exposure image formed of the exposure light L.

The electrostatic latent image is developed with the toner by the developing device 40 to form a toner image, the toner image is transferred to recording paper 95 by the transfer roller 80, and the recording paper 95 on which the toner image is printed is discharged. After transferring the image, the surface of the electrostatic latent image bearer 10 is cleaned by the cleaning device 90, and the residual charge of the electrostatic latent image bearer 10 is eliminated by a static charge eliminator (not illustrated). Then, the above-described processes are repeated again.

### EXAMPLES

In Production Examples, Examples, and Comparative Examples, “%” denotes “% by mass” and “part (s)” denotes “part (s) by mass” unless otherwise stated. Moreover, each amount in Examples and Comparative Examples denotes an amount of each starting material on solid basis.

The present disclosure will be concretely described below by way of Production Examples, Synthesis Examples, Preparation Examples, Examples, and Comparative Examples. The present disclosure should not be construed as being limited to these Production Examples, Synthesis Examples, Preparation Examples, and Examples. In Production Examples, Synthesis Examples, Preparation Examples, Examples, and Comparative Examples, “g” denotes “% by mass” and “part (s)” denotes “part (s) by mass,” unless otherwise stated. Moreover, each amount in Examples and Comparative Examples denotes an amount of each constituent material on solid basis.

### Production Example 1: Synthesis of Sulfonic Acid Salt Group-Containing Polyester Resin S1

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 133 parts of terephthalic acid, 22 parts of adipic acid, 12.3 parts of 5-sulfoisophthalic acid sodium salt, and 4.7 parts of trimethylolpropane. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting the mixture for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180ºC for one hour at ambient pressure, followed by further reacting for three hours under the reduced pressure of from 5 mmHg to 20 mmHg, to thereby yield [Sulfonic Acid Salt Group-Containing Polyester Resin S1]. The solubility parameter (SP) of [Sulfonic Acid Salt Group-Containing Polyester Resin S1] measured by the below-described method was 11.1.

### Production Example 2: Synthesis of Sulfonic Acid Salt Group-Containing Polyester Resin S2

A 5 L four-necked flask equipped with a nitrogen-inlet tube, a dehydration tube, a stirrer, and a thermocouple was charged with 16 parts of a bisphenol A ethylene oxide (2 mol) adduct, 34 parts of a bisphenol A propylene oxide (2 mol) adduct, 47 parts of ethylene glycol, 7.6 parts of 1,3-propyleneglycol, 141 parts of terephthalic acid, 12 parts of succinic acid, and 12.3 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S2]. The SP of [Sulfonic Acid Salt Group-Containing Polyester Resin S2] measured by the below-described method was 12.0.

### Production Example 3: Synthesis of Sulfonic Acid Salt Group-Containing Polyester Resin S3

A 5 L four-necked flask equipped with a nitrogen-inlet tube, a dehydration tube, a stirrer, and a thermocouple was charged with 22 parts of a bisphenol A ethylene oxide (5 mol) adduct, 492 parts of a bisphenol A propylene oxide (5 mol) adduct, 17 parts of terephthalic acid, 124 parts of adipic acid, and 12.3 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S3]. The SP of [Sulfonic Acid Salt Group-Containing Polyester Resin S3] measured by the below-described method was 10.0.

### Production Example 4: Synthesis of Sulfonic Acid Salt Group-Containing Polyester Resin S4

A 5 L four-necked flask equipped with a nitrogen-inlet tube, a dehydration tube, a stirrer, and a thermocouple was charged with 50 parts of ethylene glycol, 18 parts of glycerol, 96 parts of terephthalic acid, 12 parts of fumaric acid, 57 parts of trimellitic anhydride, and 12.3 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., [Sulfonic Acid Salt Group-Containing Polyester Resin S4] was yielded. The SP of [Sulfonic Acid Salt Group-Containing Polyester Resin S4] measured by the below-described method was 13.0.

### Production Example 5: Synthesis of Sulfonic Acid Salt Group-Containing Polyester Resin S5

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 136 parts of terephthalic acid, 22 parts of adipic acid, 4.9 parts of 5-sulfoisophthalic acid sodium salt, and 4.7 parts of trimethylolpropane. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S5]. The SP of [Sulfonic Acid Salt Group-Containing Polyester Resin S5] measured by the below-described method was 11.1.

### Production Example 6: Synthesis of Sulfonic Acid Salt Group-Containing Polyester Resin S6

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 136 parts of terephthalic acid, 22 parts of adipic acid, 9.8 parts of 5-sulfoisophthalic acid sodium salt, and 4.7 parts of trimethylolpropane. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S6]. The SP of [Sulfonic Acid Salt Group-Containing Polyester Resin S6] measured by the below-described method was 11.1.

### Production Example 7: Synthesis of Sulfonic Acid salt group-containing polyester resin S7

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 133 parts of terephthalic acid, 22 parts of adipic acid, 19.6 parts of 5-sulfoisophthalic acid sodium salt, and 4.7 parts of trimethylolpropane. To the resulting mixture, 1, 000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S7]. The SP of [Sulfonic Acid Salt Group-Containing Polyester Resin S7] measured by the below-described method was 11.1.

### Production Example 8: Synthesis of Sulfonic Acid Salt Group-Containing Polyester Resin S8

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 133 parts of terephthalic acid, 22 parts of adipic acid, 24.5 parts of 5-sulfoisophthalic acid sodium salt, and 4.7 parts of trimethylolpropane. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S8]. The SP of [Sulfonic Acid Salt Group-Containing Polyester Resin S8] measured by the below-described method was 11.1.

### Production Example 9: Synthesis of Sulfonic Acid Salt Group-Containing Polyester Resin S9

A 5 L four-necked flask equipped with a nitrogen-inlet tube, a dehydration tube, a stirrer, and a thermocouple was charged with 22 parts of a bisphenol A ethylene oxide (5 mol) adduct, 492 parts of a bisphenol A propylene oxide (5 mol) adduct, 17 parts of terephthalic acid, 129 parts of adipic acid, and 4.9 parts of 5-sulfoisophthalic acid sodium salt. To the resulting mixture, 1, 000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S9]. The SP of [Sulfonic Acid Salt Group-Containing Polyester Resin S9] measured by the below-described method was 10.0.

### Production Example 10: Synthesis of Sulfonic Acid Salt Group-Containing Polyester Resin S10

A 5 L four-necked flask equipped with a nitrogen-inlet tube, a dehydration tube, a stirrer, and a thermocouple was charged with 22 parts of a bisphenol A ethylene oxide (5 mol) adduct, 492 parts of a bisphenol A propylene oxide (5 mol) adduct, 17 parts of terephthalic acid, 130 parts of adipic acid, and 2.5 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S10]. The SP of [Sulfonic Acid Salt Group-Containing Polyester Resin S10] measured by the below-described method was 10.0.

### Production Example 11: Synthesis of Sulfonic Acid Salt Group-Containing Polyester Resin S11

A 5 L four-necked flask equipped with a nitrogen-inlet tube, a dehydration tube, a stirrer, and a thermocouple was charged with 50 parts of ethylene glycol, 18 parts of glycerol, 95 parts of terephthalic acid, 12 parts of fumaric acid, 48 parts of trimellitic anhydride, and 24.5 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling to 180° C., [Sulfonic Acid Salt Group-Containing Polyester Resin S11] was yielded. The SP of [Sulfonic Acid Salt Group-Containing Polyester Resin S11] measured by the below-described method was 13.0.

### Production Example 12: Synthesis of Sulfonic Acid Salt Group-Containing Polyester Resin S12

A 5 L four-necked flask equipped with a nitrogen-inlet tube, a dehydration tube, a stirrer, and a thermocouple was charged with 50 parts of ethylene glycol, 18 parts of glycerol, 95 parts of terephthalic acid, 12 parts of fumaric acid, 48 parts of trimellitic anhydride, and 27 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling to 180° C., [Sulfonic Acid Salt Group-Containing Polyester Resin S12] was yielded. The SP of [Sulfonic Acid Salt Group-Containing Polyester Resin S12] measured by the below-described method was 13.0.

### Production Example 13: Synthesis of Sulfonic Acid Salt Group-Containing Polyester Resin S13

A 5 L four-necked flask equipped with a nitrogen-inlet tube, a dehydration tube, a stirrer, and a thermocouple was charged with 22 parts of a bisphenol A ethylene oxide (5 mol) adduct, 492 parts of a bisphenol A propylene oxide (5 mol) adduct, 88 parts of adipic acid, 81 parts of dodecanedioic acid, and 12.3 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Sulfonic Acid Salt Group-Containing Polyester Resin S13]. The SP of [Sulfonic Acid Salt Group-Containing Polyester Resin S13] measured by the below-described method was 9.9.

### Production Example 14: Synthesis of Sulfonic Acid Salt Group-Containing Polyester Resin S14

A 5 L four-necked flask equipped with a nitrogen-inlet tube, a dehydration tube, a stirrer, and a thermocouple was charged with 22 parts of ethylene glycol, 18 parts of glycerol, 80 parts of terephthalic acid, 99 parts of trimellitic anhydride, and 12.3 parts of 5-sulfoisophthalic acid sodium salt. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling to 180° C., [Sulfonic Acid Salt Group-Containing Polyester Resin S14] was yielded. The SP of [Sulfonic Acid Salt Group-Containing Polyester Resin S14] measured by the below-described method was 13.5.

### Production Example 15: Synthesis of Shell Resin SL1

A 5 L four-necked flask equipped with a nitrogen-inlet tube, a dehydration tube, a stirrer, and a thermocouple was charged with 122 parts of a bisphenol A ethylene oxide (2 mol) adduct, 199 parts of a bisphenol A propylene oxide (2 mol) adduct, 133 parts of terephthalic acid, 22 parts of adipic acid, and 4.7 parts of trimethylolpropane. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 0.21 parts of trimellitic anhydride and 200 ppm of tetrabutyl orthotitanate relative to a total amount of the monomers were added. The resulting mixture was allowed to react at 180° C. for one hour at ambient pressure, followed by further reacting for three hours under the reduced pressure of from 5 mmHg to 20 mmHg, to thereby yield [Shell Resin SL1]. The SP of [Shell Resin SL1] measured by the below-described method was 11.0.

The SP, sulfonic acid salt group amount, and acid value of each of [Sulfonic Acid Salt Group-Containing Polyester Resin S1] to [Sulfonic Acid Salt Group-Containing Polyester Resin S14] and [Shell Resin SL1] were measured in the following manner. The results are presented in Table 1.

### «SP of Sulfonic Acid Salt Group-Containing Polyester Resin or Shell Resin SL1»

The SP of each of [Sulfonic Acid Salt Group-Containing Polyester Resin S1] to [Sulfonic Acid Salt Group-Containing Polyester Resin S14] obtained in Production Examples 1 to 14 and [Shell Resin SL1] obtained in Production Example 15 was calculated from the amounts of the monomers used for the production according to the Fedors' method.

### «Sulfonic Acid Salt Group Amount of Sulfonic Acid Salt Group-Containing Polyester Resin or Shell Resin SL1»

The amount of the sulfonic acid salt group in each of [Sulfonic Acid Salt Group-Containing Polyester Resin S1] to [Sulfonic Acid Salt Group-Containing Polyester Resin S14] obtained in Production Examples 1 to 14 and [Shell Resin SL1] obtained in Production Example 15 was calculated by inserting an area derived from the sulfonic acid salt group-containing monomer in the chromatograph obtained by pyrolysis gas chromatography (py-GC) into a calibration curve equation of the sulfonic acid salt group-containing monomer.

### «Acid Value of Sulfonic Acid Salt Group-Containing Polyester Resin or Shell Resin SL1»

An acid value of each of [Sulfonic Acid Salt Group-Containing Polyester Resin S1] to [Sulfonic Acid Salt Group-Containing Polyester Resin S14] obtained in Production Examples 1 to 14 and [Shell Resin SL1] obtained in Production Example 15 was measured according to the measuring method specified in JIS K0070-1992.

To 120 mL of toluene, 0.5 g of each resin (0.3 g of an ethyl acetate-soluble component) was added. The resulting mixture was stirred for approximately 10 hours at room temperature (23° C.) to dissolve the resin. To the resulting solution, 30 mL of ethanol was further added to prepare a sample solution.

An acid value of the sample solution was measured at 23° C. by an automatic potentiometric titrator (DL-53 Titrator, available from METTLER TOLEDO) and an electrode DG113-SC (available from METTLER TOLEDO), and the result was analyzed using analysis software LabX Light Version 1.00.000. The mixed solvent made up of 120 mL of toluene and 30 mL of ethanol was used for the titrator.

The acid value was measured in accordance with the above-described measuring method. Specifically, an acid value was calculated in the following manner. The titration was performed with a 0.1 N potassium hydroxide/alcohol solution, where the concentration of the solution had been adjusted in advance, and an acid value was determined from the titration volume according to the following formula.

$$Acid value [ mgKOH / g ] = titration volume [ mL ] \times N \times 56.1 [ mg / mL ] / mass of sample [ g ]$$

(In the equation above, “N” is a factor of the 0.1 N potassium hydroxide/alcohol solution.)

TABLE 1

| | | | Sulfonic | |
|---|---|---|---|---|
| | | | acid salt | Acid |
| | | | group amount | value |
| | | SP | [mol %] | [mgKOH/g] |
| Pro. | Sulfonic acid salt group- | 11.1 | 5 | 27.1 |
| Ex. 1 | containing polyester resin S1 | | | |
| Pro. | Sulfonic acid salt group- | 12.0 | 5 | 27.3 |
| Ex. 2 | containing polyester resin S2 | | | |
| Pro. | Sulfonic acid salt group- | 10.0 | 5 | 27.2 |
| Ex. 3 | containing polyester resin S3 | | | |
| Pro. | Sulfonic acid salt group- | 13.0 | 5 | 30.3 |
| Ex. 4 | containing polyester resin S4 | | | |
| Pro. | Sulfonic acid salt group- | 11.1 | 2 | 27.3 |
| Ex. 5 | containing polyester resin S5 | | | |
| Pro. | Sulfonic acid salt group- | 11.1 | 4 | 27.4 |
| Ex. 6 | containing polyester resin S6 | | | |
| Pro. | Sulfonic acid salt group- | 11.1 | 8 | 27.1 |
| Ex. 7 | containing polyester resin S7 | | | |
| Pro. | Sulfonic acid salt group- | 11.1 | 10 | 27.5 |
| Ex. 8 | containing polyester resin S8 | | | |
| Pro. | Sulfonic acid salt group- | 10.0 | 2 | 26.8 |
| Ex. 9 | containing polyester resin S9 | | | |
| Pro. | Sulfonic acid salt group- | 10.0 | 1 | 26.7 |
| Ex. 10 | containing polyester resin S10 | | | |
| Pro. | Sulfonic acid salt group- | 13.0 | 10 | 29.5 |
| Ex. 11 | containing polyester resin S11 | | | |
| Pro. | Sulfonic acid salt group- | 13.0 | 11 | 29.4 |
| Ex. 12 | containing polyester resin S12 | | | |
| Pro. | Sulfonic acid salt group- | 9.9 | 5 | 26.9 |
| Ex. 13 | containing polyester resin S13 | | | |
| Pro. | Sulfonic acid salt group- | 13.5 | 5 | 33.2 |
| Ex. 14 | containing polyester resin S14 | | | |
| Pro. | Shell Resin SL1 | 11.0 | 0 | 26.7 |
| Ex. 15 | | | | |

### Production Example 16: Synthesis of Amorphous Polyester Resin A1

A reaction tank equipped with a cooling tube, a stirrer, and a nitrogen-inlet tube was charged with a diol component including a bisphenol A ethylene oxide (2 mol) adduct and a bisphenol A propylene oxide (3 mol) adduct (molar ratio of 40/60), a dicarboxylic acid component including terephthalic acid and adipic acid (molar ratio of 85/15), and 3.5 mol % of trimethylolpropane relative to a total amount of the monomers in a manner that a molar ratio (OH/COOH) of a hydroxyl group to a carboxylic acid group was to be 1.2. To the resulting mixture, 1,000 ppm of tetrabutyl orthotitanate serving as a condensation catalyst was added relative to a total amount of the monomers. The resulting mixture was heated to 230° C. over the period of two hours under nitrogen flow, and the mixture was allowed to react for 5 hours while removing generated water, followed by further reacting for four hours under the reduced pressure of from 5 mmHg to 15 mmHg. After cooling the reaction system to 180° C., 1.0 mol % of trimellitic anhydride relative to a total amount of the monomers, and 200 ppm of tetrabutyl orthotitanate relative to the total amount of monomers were added. The resulting mixture was allowed to react at 180° C. for one hour at ambient pressure, followed by further reacting for three hours under the reduced pressure of from 5 mmHg to 20 mmHg, to thereby yield [Amorphous Polyester Resin A1] having a glass transition temperature (Tg) of 57° C., a weight average molecular weight of 7,700, and an acid value of 18 mgKOH/g. The glass transition temperature (Tg) of [Amorphous Polyester Resin A1] was a glass transition temperature (Tg) determined from a differential scanning calorimetry (DSC) curve of the first heating measured by DSC.

### «Measurement of Glass Transition Temperature of Amorphous Polyester Resin A1»

A glass transition temperature (Tg) of [Amorphous Polyester Resin A1] obtained in Production Example 16 was measured by a differential scanning calorimetry (DSC) system (Q-200, available from TA Instruments Japan Inc.) in the following manner.

First, approximately 5.0 mg of [Amorphous Polyester Resin A1] was placed in a sample container formed of aluminum, the sample container was placed on a holder unit, and the holder unit was set in an electric furnace. Subsequently, the sample was heated from −80° C. to 150° C. in a nitrogen atmosphere at a heating rate of 10° C./min (first heating). Then, the sample was cooled from 150° C. to −80° C. at a cooling rate of 10° C./min, followed by heating up to 150° C. at a heating rate of 10° C./min (second heating). DSC curves of the first heating and the second heating were each measured by a differential scanning calorimeter (Q-200, available from TA Instruments Japan Inc.).

The DSC curve of the second heating was selected from the obtained DSC curves, and a glass transition temperature of [Amorphous Polyester Resin A1] from the second heating was determined using the analysis program installed in the Q-200 system. The obtained glass transition temperature (Tg) was determined as a glass transition temperature (Tg) of [Amorphous Polyester Resin A1].

### «Measurement of Molecular Weight of Amorphous Polyester Resin A1»

A molecular weight of [Amorphous Polyester Resin A1] obtained in Production Example 16 was measured in the following manner. [Amorphous Polyester Resin A1] was dissolved in tetrahydrofuran (THF) (including a stabilizer, available from FUJIFILM Wako Pure Chemical Corporation) or chloroform to prepare a solution having a concentration of 0.15% by mass. The resulting solution was filtered with a 0.2 μm-filter. The resulting filtrate was provided as a sample. The sample was measured by a gel permeation chromatography (GPC) system under the following conditions.

### [Analysis Conditions]

Gel permeation chromatography (GPC) system: GPC-8220GPC (available from Tosoh Corporation)
Columns: 3 columns connected, TSKgel® SuperHZM-H 15 cm (available from Tosoh Corporation)
Temperature: 40° C.
Detector: refractive index (RI) detector
Solvent: tetrahydrofuran (THF) or chloroform
Feeding rate: 0.35 mL/min
Sample: injecting 100 μL of a 0.15% by mass sample

To measure a molecular weight of the sample, a molecular weight distribution of the sample was calculated from a relationship between logarithmic values and count numbers of calibration curves prepared using several monodisperse polystyrene standard samples. As standard polystyrene samples for preparing calibration curves, Showdex® STANDARD (available from SHOWA DENKO K. K.) Std. Nos. S-6550, S-1700, S-740, S-321, S-129, S-10, S-2.9, and S-0.6 were used.

### «Measurement of Acid Value of Amorphous Polyester Resin A1»

An acid value of [Amorphous Polyester Resin A1] obtained in Production Example 16 was measured in the same manner as the measurement of the acid value of the sulfonic acid salt group-containing polyester or shell resin SL1 according to the measuring method specified in JIS K0070-1992.

### Synthesis Example 17: Synthesis of Crystalline Polyester Resin C-1

A 5 L four-necked flask equipped with a nitrogen-inlet tube, a dehydration tube, a stirrer, and a thermocouple was charged with 1, 6-hexanediol and sebacic acid in a manner that a ratio (OH/COOH) of a OH group to a COOH group was to be 1.1. The resulting mixture was allowed to react in the presence of 500 ppm of titanium tetraisopropoxide relative to a total mass of the constituent monomers, while extracting water, and the temperature was elevated to 235° C. to react for one hour, followed by further reacting for six hours under the reduced pressure of 10 mmHg or less. Thereafter, the temperature was set at 185° C., and trimellitic anhydride was added in a manner that a molar ratio of the trimellitic anhydride relative to a COOH group was to be 0.053. The resulting mixture was allowed to react for two hours while stirring, to thereby yield [Crystalline Polyester Resin C-1].

A four-necked flask was charged with [Crystalline Polyester Resin C-1] (55 parts), methyl ethyl ketone (35 parts), and 2-propanol (10 parts). The resulting mixture was heated at a temperature equal to the melting point of [Crystalline Polyester

Resin C-1], while stirring, to dissolve the crystalline polyester resin to thereby prepare a solution.

### Preparation Example 1: Preparation of Crystalline Polyester Resin Dispersion Liquid C-1a

A container to which a stirring rod and a thermometer were set was charged with 45 parts of [Crystalline Polyester Resin C-1] and 450 parts of ethyl acetate. The resulting mixture was heated to 80° C., while stirring, and the temperature was retained at 80° C. for five hours, followed by cooling to 30° C. over the period of one hour. The resulting mixture was dispersed by passing three times through a bead mill (ULTRA VISCOMILL, available from AIMEX CO., LTD.), which was filled with zirconia beads having diameters of 0.5 mm by 80% by volume, at a feeding rate of 1 kg/h and a circumferential disk speed of 6 m/s, to thereby prepare [Crystalline Polyester Resin Dispersion Liquid C-1a]. A volume average particle diameter of the crystalline polyester resin particles in [Crystalline Polyester Resin Dispersion Liquid C-1a] was 450 nm, and a solid content of [Crystalline Polyester Resin Dispersion Liquid C-1a] was 10%.

### «Calculation Method of Solid Content of Resin Particle Dispersion Liquid»

The solid content of [Crystalline Polyester Resin Dispersion Liquid C-1a] obtained in Preparation Example 1, i.e., the amount of the crystalline polyester resin particles in [Crystalline Polyester Resin Dispersion Liquid C-1a], was calculated in the following manner. [Crystalline Polyester Resin Dispersion Liquid C-1a] was weighed and collected in an aluminum container by 0.9000 g to 1.0000 g, followed by leaving to stand for 1 hour in a constant temperature chamber whose internal temperature was set at 150° C. Then, the aluminum container was taken out from the constant temperature chamber. The solid content was calculated from the residues in the aluminum container according to the following equation.

$$Solid content [ \% ] = ( amount [ g ] of residues after leaving to stand for 1 hour at 150 ° C . ) \text{} / ( amount of weighed [ Crystalline Polyester Resin Dispersion Liquid C - 1 a ] ) \times 100$$

### Preparation Example 2: Preparation of Wax Dispersion Liquid 1

A container to which a stirring rod and a thermometer were set was charged with 50 parts of ester wax (WE-11, available from NOF CORPORATION, synthesis wax of plant-derived monomer, melting point of 67° C.) serving as a release agent and 120 parts of ethyl acetate. The resulting mixture was heated at 80° C. while stirring, and the temperature was retained at 80° C. for 5 hours, followed by cooling to 30° C. over the period of 1 hour. The cooled mixture was dispersed by passing three times through a bead mill (ULTRA VISCOMILL, available from AIMEX CO., LTD.), which was filled with zirconia beads having diameters of 0.5 mm by 80% by volume, at a feeding rate of 1 kg/h and a circumferential disk speed of 6 m/s, to thereby prepare [Wax Dispersion Liquid 1]. A median diameter of the dispersed particles in [Wax Dispersion Liquid 1] was 400 nm, and a solid content of [Wax Dispersion Liquid 1] was 25%.

### «Calculation Method of Solid Content of Wax Dispersion Liquid»

A solid content of [Wax Dispersion Liquid 1] obtained in Preparation Example 2, i.e., an amount of the wax in [Wax Dispersion Liquid 1], was calculated in the following manner. [Wax Dispersion Liquid 1] was weighed and collected in an aluminum container by 0.9000 g to 1.0000 g, followed by leaving to stand for 1 hour in a constant temperature chamber whose internal temperature was set at 150° C. Then, the aluminum container was taken out from the constant temperature chamber. The solid content was calculated from the residues in the aluminum container according to the following equation.

$$Solid content [ \% ] = ( amount [ g ] of residues after leaving to stand for 1 hour at 150 ° C . ) \text{} / ( amount of weighed [ Wax Dispersion Liquid 1 ] ) \times 100$$

### «Measurement of Median Diameters of Particles in Crystalline Polyester Resin Dispersion Liquid and Wax Dispersion Liquid»

A median diameter of the dispersed particles in [Crystalline Polyester Resin Dispersion Liquid C-1a] obtained in Preparation Example 1 and a median diameter of the dispersed particles in [Wax Dispersion Liquid 1] obtained in Preparation Example 2 were each measured by charging a laser diffraction/scattering particle size distribution analyzer (LA-920, available from HORIBA, Ltd.) with [Crystalline Polyester Resin Dispersion Liquid C-1a] or [Wax Dispersion Liquid 1] in a state of a dispersion liquid under the following measuring conditions.

### [Measuring Conditions]

Solvent: ethyl acetate
Measuring cell: 10 mL batch-type cell
Circulation: ultrasonic probe of 30 W, 22.5 kHz
Sample amount: transmittance of 75% to 90%
Measuring time: 20 seconds

### (Preparation Example 3: Preparation of Master Batch (MB))

By HENSCHEL MIXER (available from NIPPON COKE & ENGINEERING CO., LTD.), 1,200 parts of water, 400 parts of carbon black (Printex 35, available from Degussa) [DBP oil absorption of 42 mL/100 mg and pH of 9.5], and 600 parts of [Amorphous Polyester Resin A1] were mixed. The resulting mixture was kneaded for 30 minutes at 150° C. by a two-roll kneader. The resulting kneaded product was rolled and cooled, followed by pulverizing by a pulverizer to thereby prepare [Master Batch 1].

### Preparation Example 4: Preparation of Core Emulsion 1

### <Preparation of Core Oil Phase>

A container was charged with 51.1 parts of [Amorphous Polyester Resin A1], 64 parts of [Crystalline Polyester Resin Dispersion Liquid C-1a], 20 parts of [Wax Dispersion Liquid 1], 22.5 parts of [Master Batch 1], and 14.4 parts of ethyl acetate, and the resulting mixture was mixed by TK Homomixer (PRIMIX Corporation) for 60 minutes at 5,000 rpm, to thereby obtain [Core Oil Phase 1]. [Core Oil Phase 1] had a solid content of 50%. Note that, each amount presented above is the solid content of each constituent components.

### «Calculation Method of Solid Content of Core Oil Phase»

A solid content of [Core Oil Phase 1] obtained in preparation Example 4 was calculated in the following manner. [Core Oil Phase 1] was weighed and collected in an aluminum container by 0.9000 g to 1.0000 g, followed by leaving to stand for 1 hour in a constant temperature chamber whose internal temperature was set at 150° C. Then, the aluminum container was taken out from the constant temperature chamber. The solid content was calculated from the residues in the aluminum container according to the following equation.

$$Solid content [ \% ] = ( amount [ g ] of residues after leaving to stand for 1 hour at 150 ° C . ) \text{} / ( amount of weighed [ Core Oil Phase 1 ] ) \times 100$$

### <Preparation of Core Aqueous Phase>

Water (990 parts) 20 parts of sodium dodecylsulfate, and 90 part of ethyl acetate were mixed and stirred, to thereby obtain a milky white fluid. The obtained fluid was provided as [Core Aqueous Phase 1].

### <Preparation of Core Emulsion>

While stirring 703 parts of [Core Oil Phase 1] by a TK Homomixer at 8,000 rpm, 5.1 parts of 28% ammonia water was added so that a neutralization rate of [Amorphous Polyester Resin A1] having the acid value of 18 mgKOH/g became 100%, followed by mixing the mixture for 10 minutes. To the resulting mixture, 1,197 parts of [Core Aqueous Phase 1] was gradually added by dripping to perform phase inversion emulsification of [Core Oil Phase 1]. The resulting emulsion obtained by the phase inversion emulsification of [Core Oil Phase 1] was desolventized by an evaporate to thereby obtain [Core Emulsion 1].

A volume average particle diameter of the dispersed particles in [Core Emulsion 1] was measured, and the result was 210 nm. Moreover, a solid content of the dispersed particles in [Core Emulsion 1] was measured, and the result was 25.0%.

### Preparation Example 5: Preparation of Core Emulsion 2

[Core Oil Phase 2] was prepared in the same manner as in <Preparation of core oil phase> in the production of [Core Emulsion 1] of Preparation Example 4, except that [Amorphous Polyester Resin A1] was replaced with [Sulfonic Acid Salt Group-Containing Polyester Resin S1]. Moreover, [Core Emulsion 2] was obtained in the same manner as in <Preparation of core emulsion> in the preparation of [Core Emulsion 1] of Preparation Example 4, except that the amount of the 28% ammonia water was changed from 5.1 parts to 7.7 parts.

A volume average particle diameter of the dispersed particles in [Core Emulsion 2] was measured, and the result was 310 nm. Moreover, solid content of [Core Emulsion 2] was measured, and the result was 25%.

### «Measurement of Volume Average Particle Diameter of Particles in Core Emulsion»

The volume average particle diameter of the particles in [Core Emulsion 1] obtained in Preparation Example 4 and the volume average particle diameter of the particles in [Core Emulsion 2] obtained in Preparation Example 5 were each measured by a particle size distribution analyzer, Nanotrac (UPA-EX150, available from NIKKISO CO., LTD., dynamic light scattering/laser doppler velocimetry) under the following conditions.

### [Measuring Conditions]

Measuring time: 30 seconds
Feeding rate of sample: Loading Index 1.0
Conditions for particles
Transparency: transparent
Particle refractive index: 1.59
Temperature: 25° C.
Particle shape: sphere

### Conditions for Solvent

Solvent: water
Solvent refractive index: 1.333
Viscosity at high temperature: 0.797 mPa·s at 30° C.
Viscosity at low temperature: 1.002 mPa·s at 20° C.

### «Calculation Method of Solid Content of Core Emulsion»

A solid content of [Core Emulsion 1] obtained in Preparation Example 4 and a solid content of [Core Emulsion 2] obtained in Preparation Example 5 were each calculated in the following manner. [Core Emulsion 1] or [Core Emulsion 2] was weighed and collected in an aluminum container by 0.9000 g to 1.0000 g, followed by leaving to stand for 1 hour in a constant temperature chamber whose internal temperature was set at 150° C. Then, the aluminum container was taken out from the constant temperature chamber. The solid content was calculated from the residues in the aluminum container according to the following equation.

$$Solid content [ \% ] = ( amount [ g ] of residues after leaving to stand for 1 hour at 150 ° C . ) \text{} / ( amount of weighed [ Core Emulsion ] ) \times 100$$

### Preparation Example 6: Preparation of Shell Emulsion 1

### <Preparation of Shell Resin Solution 1>

A container was charged with 200 parts of [Sulfonic Acid Salt Group-Containing Polyester Resin S1] and 200 parts of methyl ethyl ketone, and the resulting mixture was mixed by a TK Homomixer (available from PRIMIX Corporation) for 60 minutes at 5,000 rpm, to thereby obtain [Shell Resin Solution 1]. [Shell Resin Solution 1] had a solid content of 50%.

«Calculation Method of Solid Content of Shell Resin solution»

A solid content of [Shell Resin Solution 1] obtained in Preparation Example 6 was calculated in the following manner. [Shell Resin Solution 1] was weighed and collected in an aluminum container by 0.9000 g to 1.0000 g, followed by leaving to stand for 1 hour in a constant temperature chamber whose internal temperature was set at 150° C. Then, the aluminum container was taken out from the constant temperature chamber. The solid content was calculated from the residues in the aluminum container according to the following equation.

$$Solid content [ \% ] = ( amount [ g ] of residues after leaving to stand for 1 hour at 150 ° C . ) \text{} / ( amount of weighed [ Shell Resin Solution 1 ) \times 100$$

### <Preparation of Shell Aqueous Phase 1>

Water (468 parts) and 132 parts of methyl ethyl ketone were mixed and stirred to thereby prepare a clear white fluid. The obtained fluid was provided as [Shell Aqueous Phase 1].

### <Preparation of Shell Emulsion 1>

While stirring 400 parts of [Shell Resin Solution 1] by a TK Homomixer (available from PRIMIX Corporation) at 8,000 rpm, 5.9 parts of 28% ammonia water was added so that a neutralization rate of [Sulfonic Acid Salt Group-Containing Polyester Resin S1] having the acid value of 27.1 mgKOH/g became 100%, followed by mixing the mixture for 10 minutes. To the resulting mixture, 600 parts of [Shell Aqueous Phase 1] was gradually added by dripping to perform phase inversion emulsification of [Shell Resin Solution 1]. The resulting emulsion obtained by the phase inversion emulsification of [Shell Resin Solution 1] desolventized by an evaporator to thereby obtain [Shell Emulsion 1].

### Preparation Example 7: Preparation of Shell Emulsion 2

[Shell Resin Solution 2] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S2]. Moreover, [Shell Emulsion 2] was obtained in the same manner as in <Preparation of shell emulsion 1> in the preparation of [Shell Emulsion 1] of Preparation Example 6, except that [Shell Resin Solution 1] was replaced with [Shell Resin Solution 2].

### Preparation Example 8: Preparation of Shell Emulsion 3

[Shell Resin Solution 3] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S3]. Moreover, [Shell Emulsion 3] was obtained in the same manner as in <Preparation of shell emulsion 1> in the preparation of [Shell Emulsion 1] of Preparation Example 6, except that [Shell Resin Solution 1] was replaced with [Shell Resin Solution 3].

### Preparation Example 9: Preparation of Shell Emulsion 4

[Shell Resin Solution 4] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S4]. Moreover, [Shell Emulsion 4] was obtained in the same manner as in <Preparation of shell emulsion 1> in the preparation of [Shell Emulsion 1] of Preparation Example 6, except that [Shell Resin Solution 1] was replaced with [Shell Resin Solution 4], and the amount of the 28% ammonia water was changed from 5.9 parts to 6.6 parts.

### Preparation Example 10: Preparation of Shell Emulsion 5

[Shell Resin Solution 5] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S5]. Moreover, [Shell Emulsion 5] was obtained in the same manner as in <Preparation of shell emulsion 1> in the preparation of [Shell Emulsion 1] of Preparation Example 6, except that [Shell Resin Solution 1] was replaced with [Shell Resin Solution 5].

### Preparation Example 11: Preparation of Shell Emulsion 6

[Shell Resin Solution 6] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S6]. Moreover, [Shell Emulsion 6] was obtained in the same manner as in <Preparation of shell emulsion 1> in the preparation of [Shell Emulsion 1] of Preparation Example 6, except that [Shell Resin Solution 1] was replaced with [Shell Resin Solution 6].

### Preparation Example 12: Preparation of Shell Emulsion 7

[Shell Resin Solution 7] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S7]. Moreover, [Shell Emulsion 7] was obtained in the same manner as in <Preparation of shell emulsion 1> in the preparation of [Shell Emulsion 1] of Preparation Example 6, except that [Shell Resin Solution 1] was replaced with [Shell Resin Solution 7], and the amount of the 28% ammonia water was changed from 5.9 parts to 6.0 parts.

### Preparation Example 13: Preparation of Shell Emulsion 8

[Shell Resin Solution 8] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S8]. Moreover, [Shell Emulsion 8] was obtained in the same manner as in <Preparation of shell emulsion 1> in the preparation of [Shell Emulsion 1] of Preparation Example 6, except that [Shell Resin Solution 1] was replaced with [Shell Resin Solution 8], and the amount of the 28% ammonia water was changed from 5.9 parts to 6.0 parts.

### Preparation Example 14: Preparation of Shell Emulsion 9

[Shell Resin Solution 9] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S9]. Moreover, [Shell Emulsion 9] was obtained in the same manner as in <Preparation of shell emulsion 1> in the preparation of [Shell Emulsion 1] of Preparation Example 6, except that [Shell Resin Solution 1] was replaced with [Shell Resin Solution 9], and the amount of the 28% ammonia water was changed from 5.9 parts to 5.8 parts.

### Preparation Example 15: Preparation of Shell Emulsion 10

[Shell Resin Solution 10] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S10]. Moreover, [Shell Emulsion 10] was obtained in the same manner as in <Preparation of shell emulsion 1> in the preparation of [Shell Emulsion 1] of Preparation Example 6, except that [Shell Resin Solution 1] was replaced with [Shell Resin Solution 10], and the amount of the 28% ammonia water was changed from 5.9 parts to 5.8 parts.

### Preparation Example 16: Preparation of Shell Emulsion 11

[Shell Resin Solution 11] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S11]. Moreover, [Shell Emulsion 11] was obtained in the same manner as in <Preparation of shell emulsion 1> in the preparation of [Shell Emulsion 1] of Preparation Example 6, except that [Shell Resin Solution 1] was replaced with [Shell Resin Solution 11], and the amount of the 28% ammonia water was changed from 5.9 parts to 6.4 parts.

### Preparation Example 17: Preparation of Shell Emulsion 12

[Shell Resin Solution 12] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S12]. Moreover, [Shell Emulsion 12] was obtained in the same manner as in <Preparation of shell emulsion 1> in the preparation of [Shell Emulsion 1] of Preparation Example 6, except that [Shell Resin Solution 1] was replaced with [Shell Resin Solution 12], and the amount of the 28% ammonia water was changed from 5.9 parts to 6.4 parts.

### Preparation Example 18: Preparation of Shell Emulsion 13

[Shell Resin Solution 13] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S13]. Moreover, [Shell Emulsion 13] was obtained in the same manner as in <Preparation of shell emulsion 1> in the preparation of [Shell Emulsion 1] of Preparation Example 6, except that [Shell Resin Solution 1] was replaced with [Shell Resin Solution 13], and the amount of the 28% ammonia water was changed from 5.9 parts to 5.8 parts.

### Preparation Example 19: Preparation of Shell Emulsion 14

[Shell Resin Solution 14] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Sulfonic Acid Salt Group-Containing Polyester Resin S14]. Moreover, [Shell Emulsion 14] was obtained in the same manner as in <Preparation of shell emulsion 1> in the preparation of [Shell Emulsion 1] of Preparation Example 6, except that [Shell Resin Solution 1] was replaced with [Shell Resin Solution 14], and the amount of the 28% ammonia water was changed from 5.9 parts to 7.2 parts.

### Preparation Example 20: Preparation of Shell Emulsion 15

[Shell Resin Solution 15] was prepared in the same manner as in <Preparation of shell resin solution 1> of the preparation of [Shell Emulsion 1] of Preparation Example 6, except that [Sulfonic Acid Salt Group-Containing Polyester Resin S1] was replaced with [Shell Resin SL1]. Moreover, [Shell Emulsion 15] was obtained in the same manner as in <Preparation of shell emulsion 1> in the preparation of [Shell Emulsion 1] of Preparation Example 6, except that [Shell Resin Solution 1] was replaced with [Shell Resin Solution 15], and the amount of the 28% ammonia water was changed from 5.9 parts to 5.8 parts.

The properties of [Shell Emulsion 1] to [Shell Emulsion 14] produced in Preparation Examples 6 to 19 and [Shell Emulsion 15] produced in Preparation Example 20 are presented in Table 2 below.

TABLE 2

| | | | | Solid |
|---|---|---|---|---|
| | | | | content |
| | | | | of |
| | | | Dv | emulsion |
| | | Shell resin | [nm] | [%] |
| Pre. | Shell | Sulfuric acid salt group- | 50 | 30 |
| Ex. 6 | Emulsion 1 | containing polyester resin S1 | | |
| Pre. | Shell | Sulfuric acid salt group- | 51 | 30 |
| Ex. 7 | Emulsion 2 | containing polyester resin S2 | | |
| Pre. | Shell | Sulfuric acid salt group- | 52 | 30 |
| Ex. 8 | Emulsion 3 | containing polyester resin S3 | | |
| Pre. | Shell | Sulfuric acid salt group- | 51 | 30 |
| Ex. 9 | Emulsion 4 | containing polyester resin S4 | | |
| Pre. | Shell | Sulfuric acid salt group- | 62 | 30 |
| Ex. 10 | Emulsion 5 | containing polyester resin S5 | | |
| Pre. | Shell | Sulfuric acid salt group- | 55 | 30 |
| Ex. 11 | Emulsion 6 | containing polyester resin S6 | | |
| Pre. | Shell | Sulfuric acid salt group- | 48 | 30 |
| Ex. 12 | Emulsion 7 | containing polyester resin S7 | | |
| Pre. | Shell | Sulfuric acid salt group- | 45 | 30 |
| Ex. 13 | Emulsion 8 | containing polyester resin S8 | | |
| Pre. | Shell | Sulfuric acid salt group- | 63 | 30 |
| Ex. 14 | Emulsion 9 | containing polyester resin S9 | | |
| Pre. | Shell | Sulfuric acid salt group- | 64 | 30 |
| Ex. 15 | Emulsion 10 | containing polyester resin S10 | | |
| Pre. | Shell | Sulfuric acid salt group- | 64 | 30 |
| Ex. 16 | Emulsion 11 | containing polyester resin S11 | | |
| Pre. | Shell | Sulfuric acid salt group- | 60 | 30 |
| Ex. 17 | Emulsion 12 | containing polyester resin S12 | | |
| Pre. | Shell | Sulfuric acid salt group- | 64 | 30 |
| Ex. 18 | Emulsion 13 | containing polyester resin S13 | | |
| Pre. | Shell | Sulfuric acid salt group- | 63 | 30 |
| Ex. 19 | Emulsion 14 | containing polyester resin S14 | | |
| Pre. | Shell | Shell Resin SL1 | 52 | 30 |
| Ex. 20 | Emulsion 15 | | | |

### Example 1

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 18.3 parts of [Shell Emulsion 1] with 30 parts of water was added. To the mixture, 15 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 29 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 1].

### <Annealing Step, Washing Step, and Drying Step>

After storing [Toner Dispersion Liquid 1] for 10 hours at 45° C., filtration of [Toner Dispersion Liquid 1] was performed under reduced pressure, and washing and drying were performed in the following manner.
(1): To the filtration cake, 100 parts of ion-exchanged water was added, and the resulting mixture was mixed by a TK Homomixer (for 10 minutes at the rotational speed of 12,000 rpm), followed by performing filtration under reduced pressure.
(2): To the filtration cake of (1), 900 parts of ion exchanged water was added, the resulting mixture was mixed by a TK Homomixer (for 30 minutes at the rotational speed of 12,000 rpm) with ultrasonification, followed by performing filtration under reduced pressure, and the above-described process was repeated until the electrical conductivity of the filtrate obtained by the filtration under reduced pressure became 10 μC/cm or less, followed by performing filtration, to thereby obtain [Filtration Cake 1]

[Filtration Cake 1] obtained was dried by an air circulation dryer for 48 hours at 45° C., followed by sieving with a 75 μm-mesh, to thereby obtain [Color Resin Particles 1].

### <External Additive Processing>

To 100 parts of [Color Resin Particles 1], 2.5 parts of inorganic particles (CAB-O-SIL® TS-530 fumed silica, available from Cabot Corporation) were added. The resulting mixture was mixed by HENSCHEL MIXER for 10 minutes at 40 m/s, to thereby obtain [Toner 1].

### Example 2

[Toner 2] was obtained in the same manner as in Example 1, except that, in <Aggregating step and shell forming step>, [Shell Emulsion 1] was replaced with [Shell Emulsion 2].

### Example 3

[Toner 3] was obtained in the same manner as in Example 1, except that, in <Aggregating step and shell forming step>, [Shell Emulsion 1] was replaced with [Shell Emulsion 3].

### Example 4

[Toner 4] was obtained in the same manner as in Example 1, except that, in <Aggregating step and shell forming step>, [Shell Emulsion 1] was replaced with [Shell Emulsion 4].

### Example 5

[Toner 5] was obtained in the same manner as in Example 1, except that, in <Aggregating step and shell forming step>, [Shell Emulsion 1] was replaced with [Shell Emulsion 5].

### Example 6

[Toner 6] was obtained in the same manner as in Example 1, except that, in <Aggregating step and shell forming step>, [Shell Emulsion 1] was replaced with [Shell Emulsion 6].

### Example 7

[Toner 7] was obtained in the same manner as in Example 1, except that, in <Aggregating step and shell forming step>, [Shell Emulsion 1] was replaced with [Shell Emulsion 7].

### Example 8

[Toner 8] was obtained in the same manner as in Example 1, except that, in <Aggregating step and shell forming step>, [Shell Emulsion 1] was replaced with [Shell Emulsion 8].

### Example 9

[Toner 9] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 4.1 parts of [Shell Emulsion 1] with 6.6 parts of water was added. To the mixture, 12 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 25 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 9].

### Example 10

[Toner 10] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 9.2 parts of [Shell Emulsion 1] with 15 parts of water was added. To the mixture, 13 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 26 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 10].

### Example 11

[Toner 11] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 33.8 parts of [Shell Emulsion 1] with 55 parts of water was added. To the mixture, 17 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 34 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 11].

### Example 12

[Toner 12] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 52.5 parts of [Shell Emulsion 1] with 86 parts of water was added. To the mixture, 20 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 39 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 12].

### Example 13

[Toner 13] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 4.1 parts of [Shell Emulsion 9] with 6.6 parts of water was added. To the mixture, 12 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 25 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 13].

### Example 14

[Toner 14] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 34.1 parts of [Shell Emulsion 10] with 6.6 parts of water was added. To the mixture, 12 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 25 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 14].

### Example 15

[Toner 15] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 3.3 parts of [Shell Emulsion 9] with 5.4 parts of water was added. To the mixture, 12 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 25 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 15].

### Example 16

[Toner 16] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 3.3 parts of [Shell Emulsion 10] with 5.4 parts of water was added. To the mixture, 12 parts of a 20% magnesium sulfate aqueous solution was further added by dripping, followed by stirring the mixture for 10 minutes. The temperature of the resulting mixture was elevated to 65° C., followed by stirring the mixture for 30 minutes.

The diameters of the particles in the mixture before adding [Shell Emulsion 10] in <Aggregating step and shell forming step>were determined by measuring with a particle size analyzer (Multisizer III, available from Beckman Coulter, Inc.) using a 100 μm-aperture as an aperture, and analyzing with an analysis software (Beckman Coulter Multisizer 3 Version 3.51).

### <Fusing and Terminating Step>

To the resulting mixture obtained in <Aggregating step and shell forming step>, 25 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 16].

### Example 17

[Toner 17] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 52.5 parts of [Shell Emulsion 11] with 86 parts of water was added. To the mixture, 20 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 39 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 17].

### Example 18

[Toner 18] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 52.5 parts of [Shell Emulsion 12] with 86 parts of water was added. To the mixture, 20 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 39 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 18].

### Example 19

[Toner 19] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 52.8 parts of [Shell Emulsion 11] with 86 parts of water was added. To the mixture, 20 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 40 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 19].

### Example 20

[Toner 20] was obtained in the same manner as in Example 1, except that <Aggregating step and shell forming step> and <Fusing and terminating step>were changed as follows.

### <Aggregating Step and Shell Forming Step>

A container was charged with 100 parts of [Core Emulsion 1] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C. When the diameters of the particles in the mixture reached 5.0 μm, a dilution prepared by diluting 54.8 parts of [Shell Emulsion 12] with 89 parts of water was added. To the mixture, 20 parts of a 20% magnesium sulfate aqueous solution was further added by dripping, followed by stirring the mixture for 10 minutes. The temperature of the resulting mixture was elevated to 65° C., followed by stirring the mixture for 30 minutes.

### <Fusing and Terminating Step>

To the resulting mixture obtained in <Aggregating step and shell forming step>, 40 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 20].

### Comparative Example 1

[Toner 21] was obtained in the same manner as in Example 1, except that, in <Aggregating step and shell forming step>, [Shell Emulsion 1] was replaced with [Shell Emulsion 13].

### Comparative Example 2

[Toner 22] was obtained in the same manner as in Example 1, except that, in <Aggregating step and shell forming step>, [Shell Emulsion 1] was replaced with [Shell Emulsion 14].

### Comparative Example 3

[Toner 23] was obtained in the same manner as in Example 1, except that, in <Aggregating step and shell forming step>, [Shell Emulsion 1] was replaced with [Shell Emulsion 15].

### Comparative Example 4

[Toner 24] was obtained in the same manner as in Example 1, except that <Aggregating step and shell forming step>was replaced with <Aggregating step>, and <Fusing and terminating step>was changed as follows.

### <Aggregating Step>

A container was charged with 100 parts of [Core Emulsion 2] and 300 parts of ion exchanged water, and the resulting mixture was stirred for one minute. To the mixture, 6.3 parts of a 20% magnesium sulfate aqueous solution was added by dripping, followed by stirring the mixture for five minutes. The temperature of the resulting mixture was elevated to 55° C.

### <Fusing and Terminating Step>

When the diameters of the particles in the mixture obtained in <Aggregating step>reached 5.0 μm, 24 parts of sodium sulfate was added. The mixture was heated to 70° C. When the circularity of the particles in the mixture reached the desired circularity, i.e., in the range of 0.957 to 0.962, the mixture was cooled to thereby obtain [Toner Dispersion Liquid 24].

The diameters of the particles in the mixture before adding the sodium sulfate in <Fusing and terminating step>were determined by measuring with a particle size analyzer (Multisizer III, available from Beckman Coulter, Inc.) using a 100 μm-aperture as an aperture, and analyzing with an analysis software (Beckman Coulter Multisizer 3 Version 3.51).

The properties of [Toner 1] to [Toner 24] obtained in Examples 1 to 20 and Comparative Examples 1 to 4 are presented in Table 3.

TABLE 3

| | | | | Amount of sulfonic | | |
|---|---|---|---|---|---|---|
| | | | | acid salt group- | | |
| | | | | containing | | |
| | | Core | Shell | polyester resin | Dv | |
| | | Emulsion | Emulsion | [mass %] | [μm] | Circularity |
| Ex. 1 | Toner 1 | Core Emulsion 1 | Shell Emulsion 1 | 20 | 5.3 | 0.960 |
| Ex. 2 | Toner 2 | Core Emulsion 1 | Shell Emulsion 2 | 20 | 5.4 | 0.961 |
| Ex. 3 | Toner 3 | Core Emulsion 1 | Shell Emulsion 3 | 20 | 5.5 | 0.960 |
| Ex. 4 | Toner 4 | Core Emulsion 1 | Shell Emulsion 4 | 20 | 5.6 | 0.962 |
| Ex. 5 | Toner 5 | Core Emulsion 1 | Shell Emulsion 5 | 20 | 5.5 | 0.961 |
| Ex. 6 | Toner 6 | Core Emulsion 1 | Shell Emulsion 6 | 20 | 5.6 | 0.962 |
| Ex. 7 | Toner 7 | Core Emulsion 1 | Shell Emulsion 7 | 20 | 5.2 | 0.960 |
| Ex. 8 | Toner 8 | Core Emulsion 1 | Shell Emulsion 8 | 20 | 5.1 | 0.961 |
| Ex. 9 | Toner 9 | Core Emulsion 1 | Shell Emulsion 1 | 5 | 5.7 | 0.957 |
| Ex. 10 | Toner 10 | Core Emulsion 1 | Shell Emulsion 1 | 10 | 5.5 | 0.958 |
| Ex. 11 | Toner 11 | Core Emulsion 1 | Shell Emulsion 1 | 30 | 5.1 | 0.961 |
| Ex. 12 | Toner 12 | Core Emulsion 1 | Shell Emulsion 1 | 40 | 5.0 | 0.962 |
| Ex. 13 | Toner 13 | Core Emulsion 1 | Shell Emulsion 9 | 5 | 5.8 | 0.958 |
| Ex. 14 | Toner 14 | Core Emulsion 1 | Shell Emulsion 10 | 5 | 5.9 | 0.958 |
| Ex. 15 | Toner 15 | Core Emulsion 1 | Shell Emulsion 9 | 4 | 5.9 | 0.957 |
| Ex. 16 | Toner 16 | Core Emulsion 1 | Shell Emulsion 10 | 4 | 6.0 | 0.957 |
| Ex. 17 | Toner 17 | Core Emulsion 1 | Shell Emulsion 11 | 40 | 5.8 | 0.957 |
| Ex. 18 | Toner 18 | Core Emulsion 1 | Shell Emulsion 12 | 40 | 5.8 | 0.958 |
| Ex. 19 | Toner 19 | Core Emulsion 1 | Shell Emulsion 11 | 41 | 5.8 | 0.959 |
| Ex. 20 | Toner 20 | Core Emulsion 1 | Shell Emulsion 12 | 41 | 6.0 | 0.957 |
| Comp. | Toner 21 | Core Emulsion 1 | Shell Emulsion 13 | 20 | 6.7 | 0.959 |
| Ex. 1 | | | | | | |
| Comp. | Toner 22 | Core Emulsion 1 | Shell Emulsion 14 | 20 | 6.8 | 0.957 |
| Ex. 2 | | | | | | |
| Comp. | Toner 23 | Core Emulsion 1 | Shell Emulsion 15 | 20 | 5.5 | 0.961 |
| Ex. 3 | | | | | | |
| Comp. | Toner 24 | Core Emulsion 2 | NA | NA | 5.0 | 0.962 |
| Ex. 4 | | | | | | |

### <Production of Developer>

### «Production of Carrier»

To 100 parts of toluene, 100 parts of a silicone resin (organo straight-silicone), 5 parts of γ-(2-aminoethyl) aminopropyltrimethoxysilane, and 10 parts of carbon black were added. The resulting mixture was dispersed by a homomixer for 20 minutes, to thereby prepare a resin layer coating liquid.

The resin layer coating liquid was applied to surfaces of spherical magnetite particles (1,000 parts by mass) having a volume average particle diameter of 50 μm by a fluidized bed coater to produce [Carrier].

### «Production of Developers 1 to 24»

By a ball mill, 5 parts of each of [Toner 1] to [Toner 24] and 95 parts of [Carrier] were mixed to produce each of two-component [Developer 1] to [Developer 24] of Examples 1 to 20 and Comparative Examples 1 to 4.

### <Evaluations>

Various properties of each of the obtained toners and developers were evaluated in the following manner. The results are presented in Table 4.

### «Low-Temperature Fixability»

A solid image of 2 cm×15 cm was developed on a surface of a sheet (PPC sheet 6000<70w>, A4, long grain, available from Ricoh Company Limited) with the developer so that a deposition of the toner was 0.40 mg/cm². To deposit the developer on the paper, a printer from which a thermal fixing device was removed (imagio MP C5503 (available from Ricoh Company Limited) from which a thermal fixing device was removed) was used. When the sheet was passed under a press roller at a fixing speed (rim speed of a heating roller) of 213 mm/see and fixing pressure (surface pressure applied by the press roller) of 10 kg/cm², the cold offset temperature was measured, and low-temperature fixability was measured based on the following evaluation criteria. The lower the cold offset temperature is, the better the low-temperature fixability is. The results of “Very good,” “Good,” and “Fair” are acceptable levels at which there was no problem on practical use.

### —Evaluation Criteria of Low-Temperature Fixability—

Very good: The cold offset temperature was 130° C. or lower.
Good: The cold offset temperature was higher than 130° C. and 135° C. or lower.
Fair: The cold offset temperature was higher than 135° C. and 140° C. or lower.
Not good: The cold offset temperature was higher than 140° C.

### «Adhesion of Toner»

The interparticle force (Fp) of each of the toners as compressed at 160 kN/m² was measured by a testing system for compression characteristics and tensile strength of powder beds, AGGROBOT® (available from HOSOKAWA MICRON CORPORATION).

A cylindrical cell that was divided into an upper cell and a lower cell was charged with the predetermined amount of each of the toners. After compressing the toner at the pressure of 160 kN/m², the upper cell was lifted up to fracture the toner powder bed. The interparticle adhesion was calculated from the maximum tensile fracture force at the time of the fracture of the toner powder bed, the height of the powder bed at the time of the compression, the inner diameter of the cell, the average particle diameter of the toner, the true density of the toner, and the amount of the toner under the following conditions.

Specifically, the measurement of the interparticle force (Fp [gf]) was performed with the toner amount of 8.00 g±0.02 g, the temperature of 25° C. ±2° C., the humidity of 30% RH+5% RH, the cell inner diameter of 25 mm, the cell temperature of 25° C., the spring diameter of 1.0 mm, the compression speed of 0.1 mm/s, the compression load of 8 kg (pressing force of 160 kN/m²), the compression retention time of 60 seconds, the tensile speed of 0.6 mm/s, the tensile sampling onset time of 0 seconds, and the tensile sampling time of 25 seconds, and the installed application software calculated the interparticle force (Fp [gf]). The calculated interparticle force (Fp [gf]) was determined as the interparticle force (Fp) of the toner as compressed at 160 kN/m², and the adhesion of the toner was evaluated based on the following evaluation criteria. Note that, the measurement was performed after conditioning the toner for 24 hours at 23° C. and 53% RH. The results of “Very good,” “Good,” and

“Fair” are acceptable levels at which there was no problem on practical use.

### —Evaluation Criteria of Adhesion of Toner—

Very good: Fp≤200 gf, which was very good.
Good: 200 gf<Fp≤300 gf, which was good.
Fair: 300 gf<Fp <500 gf, which was acceptable.
Not good: 500 gf<Fp, at which fracture failures occurred.

### «Heat-Resistant Storage Stability»

A 50 mL glass container was charged with the toner, and the toner was left to stand in a constant temperature tank of 50° C. for 24 hours, followed by cooling to 24° C. A penetration degree [mm] was measured by the penetration test (JIS K 2235-1991), and the heat-resistant storage stability was evaluated based on the following evaluation criteria. The results of “Very good,” “Good,” and “Fair” are acceptable levels at which there was no problem on practical use.

### —Evaluation Criteria of Heat-Resistant Storage Stability—

Very good: The penetration degree was 20 mm or greater.
Good: The penetration degree was 15 mm or greater and less than 20 mm.
Fair: The penetration degree was 10 mm or greater and less than 15 mm.
Not good: The penetration degree was less than 10 mm.

### «Charging Characteristics»

The two-component developer was weighed by 6 g, and the weighed developer was placed in a sealable metal cylinder. The developer was stirred at the stirring speed of 280 rpm, and the triboelectric charge of the developer was determined by the blow-off method. The triboelectric charge was measured after each of the stirring durations of 15 seconds (TA15), 60 seconds (TA60), and 600 seconds (TA600). The charging characteristics were evaluated based on the following evaluation criteria. As the carrier, [Carrier] produced by the above-described method was used. The results of “Very good,” “Good,” and “Fair” are acceptable levels at which there was no problem on practical use.

### —Evaluation Criteria of Charging Characteristics—

Very good: The charge was 36 [−μC/g] or greater.
Good: The charge was 33 [−μC/g] or greater and less than 36 [−μC/g].
Fair: The charge was 30 [−μC/g] or greater and less than 33 [−μC/g].
Not good: The charge was less than 30 [−μC/g].

TABLE 4

| | Low | | | | | |
|---|---|---|---|---|---|---|
| | temperature | Toner | Heat resistant | Charging characteristics | | |
| | fixability | adhesion | storage stability | TA15 | TA60 | TA600 |
| Ex. 1 | Very good | Very good | Very good | Very good | Very good | Very good |
| Ex. 2 | Very good | Very good | Very good | Very good | Very good | Very good |
| Ex. 3 | Very good | Good | Good | Good | Good | Good |
| Ex. 4 | Very good | Good | Good | Good | Good | Good |
| Ex. 5 | Very good | Very good | Very good | Good | Good | Good |
| Ex. 6 | Very good | Very good | Very good | Very good | Very good | Very good |
| Ex. 7 | Very good | Very good | Very good | Very good | Very good | Very good |
| Ex. 8 | Very good | Good | Good | Very good | Very good | Very good |
| Ex. 9 | Very good | Good | Good | Good | Good | Good |
| Ex. 10 | Very good | Very good | Very good | Very good | Very good | Very good |
| Ex. 11 | Good | Very good | Very good | Very good | Very good | Very good |
| Ex. 12 | Good | Very good | Very good | Very good | Very good | Very good |
| Ex. 13 | Very good | Good | Good | Good | Good | Good |
| Ex. 14 | Very good | Good | Good | Fair | Fair | Good |
| Ex. 15 | Very good | Good | Fair | Fair | Good | Good |
| Ex. 16 | Very good | Good | Fair | Fair | Fair | Good |
| Ex. 17 | Good | Good | Good | Good | Good | Good |
| Ex. 18 | Good | Good | Fair | Fair | Good | Good |
| Ex. 19 | Fair | Good | Good | Good | Good | Good |
| Ex. 20 | Fair | Good | Fair | Fair | Good | Good |
| Comp. | Very good | Not good | Fair | Not good | Not good | Fair |
| Ex. 1 | | | | | | |
| Comp. | Very good | Not good | Not good | Not good | Not good | Fair |
| Ex. 2 | | | | | | |
| Comp. | Very good | Good | Good | Not good | Not good | Not good |
| Ex. 3 | | | | | | |
| Comp. | Not good | Not good | Not good | Very good | Very good | Very good |
| Ex. 4 | | | | | | |

It was found from the results of Table 4 that desired low-temperature fixability, toner adhesion, heat-resistant storage stability, and charging characteristics were all achieved in Examples 1 to 20. In Comparative Examples 1 and 2, conversely, shell layers were not desirably formed on surfaces of toner base particles, thus heat-resistant storage stability and charging characteristics were impaired. In Comparative Example 3, the shell layers did not include a sulfonic acid salt group, and charging characteristics were significantly impaired.

In Comparative Example 4, the resin particles each included only the sulfonic acid salt group-containing polyester resin as an amorphous polyester resin and did not have a core-shell structure, thus the crystalline polyester resin and wax were not appropriately controlled at the surfaces of the toner base particles so that low-temperature fixability, toner adhesion, and heat-resistant storage stability were impaired.

For example, embodiments of the present disclosure are as follows.
<1>Resin Particles, Each Including:
   amorphous polyester resins that include
      (i) an amorphous polyester resin including a sulfonic acid salt group-containing polyester resin, the sulfonic acid salt group-containing polyester resin having a solubility parameter of from 10 to 13, and
      (ii) an amorphous polyester resin different from the amorphous polyester resin including the sulfonic acid salt group-containing polyester resin;
   a crystalline polyester resin; and
   a release agent,
   wherein each of the resin particles has a core-shell structure including a core layer and a shell layer, where the shell layer includes the (i) amorphous polyester resin including the sulfonic acid salt group-containing polyester resin.
<2> The resin particles according to <1>, wherein a molar ratio of a monomer unit including a sulfonic acid salt group in the sulfonic acid salt group-containing polyester resin is from 2 mol % to 10 mol % relative to a total amount of one or more carboxylic acid monomers constituting the sulfonic acid salt group-containing polyester resin.
<3> The resin particles according to <1>or <2>, wherein an amount of the sulfonic acid salt group-containing polyester resin is from 5% by mass to 40% by mass.
<4> The resin particles according to any one of <1> to <3>,

wherein the core layer includes the (ii) amorphous polyester resin different from the amorphous polyester resin including the sulfonic acid salt group-containing polyester resin, the crystalline polyester resin, and the release agent.
<5>A method for producing resin particles, the method including:
   (a) dissolving or dispersing at least an amorphous polyester resin in an organic solvent to prepare a core layer-forming oil phase;
   (b) adding an aqueous phase to the core layer-forming oil phase to cause phase inversion from a water-in-oil dispersion liquid to a core layer-forming oil-in-water dispersion liquid;
   (c) dissolving or dispersing at least an amorphous polyester resin including a sulfonic acid salt group-containing polyester resin in an organic solvent to prepare a shell layer-forming oil phase;
   (d) adding an aqueous phase to the shell layer-forming oil phase to cause phase inversion from a water-in-oil dispersion liquid to a shell layer-forming oil-in-water dispersion liquid;
   (e) aggregating particles in the core layer-forming oil-in-water dispersion liquid obtained in the (b) to form aggregated particles; and
   (f) adding the shell layer-forming oil-in-water dispersion liquid obtained in the (d) to the aggregated particles obtained in the (e) to obtain the resin particles according to any one of <1> to <4>,
wherein the polyester resin and the release agent are added in the (a) or the (e).
<6>A toner, including:
   the resin particles according to any one of <1> to <4>; and
   one or more external additives.
<7>A developer, including:
   the resin particles according to any one of <1> to <4> or the toner according to <6>; and
   a carrier.
<8>A toner storage, including:
   a storage configured to store a toner; and
   the resin particles according to any one of <1> to <4> or the toner according to <6>stored in the storage.
<9> An image forming apparatus, including:
   the resin particles according to any one of <1> to <4> or the toner according to <6>;
   an electrostatic latent image bearer;
   an electrostatic latent image forming mechanism configured to form an electrostatic latent image on the electrostatic latent image bearer; and
   a developing device configured to develop the electrostatic latent image formed on the electrostatic latent image bearer with the resin particles or the toner to form a visible image.

The resin particles according to any one of <1> to <4>, the method for producing the resin particles according to <5>, the toner according to <6>, the developer according to <7>, the toner storage according to <8>, and the image forming apparatus according to <9>can solve the above-described various problems existing in the related art, and can achieve the object of the present disclosure.

What is claimed is:

1. Resin particles, each comprising:
amorphous polyester resins that include
(i) an amorphous polyester resin including a sulfonic acid salt group-containing polyester resin, the sulfonic acid salt group-containing polyester resin having a solubility parameter of from 10 to 13, and
(ii) an amorphous polyester resin different from the amorphous polyester resin including the sulfonic acid salt group-containing polyester resin;
a crystalline polyester resin; and
a release agent,
wherein each of the resin particles has a core-shell structure including a core layer and a shell layer, where the shell layer includes the (i) amorphous polyester resin including the sulfonic acid salt group-containing polyester resin.

2. The resin particles according to claim 1,
wherein a molar ratio of a monomer unit including a sulfonic acid salt group in the sulfonic acid salt group-containing polyester resin is from 2 mol % to 10 mol % relative to a total amount of one or more carboxylic acid monomers constituting the sulfonic acid salt group-containing polyester resin.

3. The resin particles according to claim 1,
wherein an amount of the sulfonic acid salt group-containing polyester resin is from 5% by mass to 40% by mass.

4. The resin particles according to claim 1,
wherein the core layer includes the (ii) amorphous polyester resin different from the amorphous polyester resin including the sulfonic acid salt group-containing polyester resin, the crystalline polyester resin, and the release agent.

5. A method for producing resin particles, the method comprising:
(a) dissolving or dispersing at least an amorphous polyester resin in an organic solvent to prepare a core layer-forming oil phase;
(b) adding an aqueous phase to the core layer-forming oil phase to cause phase inversion from a water-in-oil dispersion liquid to a core layer-forming oil-in-water dispersion liquid;
(c) dissolving or dispersing at least an amorphous polyester resin including a sulfonic acid salt group-containing polyester resin in an organic solvent to prepare a shell layer-forming oil phase;
(d) adding an aqueous phase to the shell layer-forming oil phase to cause phase inversion from a water-in-oil dispersion liquid to a shell layer-forming oil-in-water dispersion liquid;
(e) aggregating particles in the core layer-forming oil-in-water dispersion liquid obtained in the (b) to form aggregated particles; and
(f) adding the shell layer-forming oil-in-water dispersion liquid obtained in the (d) to the aggregated particles obtained in the (e) to obtain the resin particles according to claim 1,
wherein the crystalline polyester resin and the release agent are added in the (a) or the (e).

6. A toner, comprising:
the resin particles according to claim 1; and
one or more external additives.

7. A developer, comprising:
the toner according to claim 6; and
a carrier.

8. A toner storage, comprising:
a storage configured to store a toner; and
the toner according to claim 6 stored in the storage.

9. An image forming apparatus, comprising:
the toner according to claim 6;
an electrostatic latent image bearer;
an electrostatic latent image forming mechanism configured to form an electrostatic latent image on the electrostatic latent image bearer; and
a developing device configured to develop the electrostatic latent image formed on the electrostatic latent image bearer with the toner to form a visible image.
